(19) United States
(12) Patent Application Publication
(10) Pub. No.: US 2022/0371052 A1
(43) Pub. Date: Nov. 24, 2022

(54) APPARATUS

(71) Applicant: LG Display Co., Ltd., Seoul (KR)

(72) Inventors: Taehyung KIM, Paju-si (KR); GyungBo HA, Paju-si (KR); SeulKi NAM, Paju-si (KR); Saseong MOON, Paju-si (KR)

(73) Assignee: LG Display Co., Ltd., Seoul (KR)

(21) Appl. No.: 17/737,411

(22) Filed: May 5, 2022

(30) Foreign Application Priority Data
May 6, 2021 (KR) 10-2021-0058426
Jan. 1, 2022 (KR) 10-2022-0000008

(51) Int. Cl. B06B 1/06; H04R 1/28

(52) U.S. Cl. CPC B06B 1/06; H04R 1/2811; H04R 2499/15

(57) ABSTRACT

An apparatus may include a vibration member, a rear cover at a rear surface of the vibration member, a first vibration device at a first rear region of the rear cover, and a second vibration device at a second rear region of the rear cover. The first vibration device may overlap at least one of a horizontal region and a middle region of the rear cover. The second vibration device may overlap a periphery region or a middle region of the rear cover.

### CROSS-REFERENCE TO RELATED APPLICATIONS

This application claims the benefit of and priority to Korean Patent Application No. 10-2021-0058426 filed on May 6, 2021 and No. 10-2022-0000008 filed on Jan. 1, 2022, the entirety of each of which is incorporated herein by reference for all purposes as if fully set forth herein.

### BACKGROUND

### 1. Technical Field

The present disclosure relates to an apparatus, including, without limitation, an apparatus for outputting a sound.

### 2. Discussion of the Related Art

Apparatuses include a separate speaker or sound apparatus for providing a sound. In a case where a speaker is disposed in an apparatus, the design and spatial disposition of the apparatus are limited due to a space occupied by the speaker.

A speaker applied to apparatuses may be, for example, an actuator including a magnet and a coil. However, in a case where the actuator is applied to an apparatus, a thickness thereof is thick. Therefore, piezoelectric devices which enable a thin thickness to be implemented are attracting much attention.

However, because the piezoelectric devices have a brittle or fragile characteristic, the piezoelectric devices are easily damaged by an external impact, and as a result, the reliability of sound reproduction is low. Furthermore, in a case where a speaker such as a piezoelectric device is applied to a flexible apparatus, the piezoelectric device might be easily damaged due to a brittle or fragile characteristic.

The description provided in the background section should not be assumed to be prior art merely because it is mentioned in or associated with the background section. The background section may include information that describes one or more aspects of the subject technology.

### SUMMARY

The inventors have recognized problems described above and have performed various experiments for implementing an apparatus and a vibration device where the quality of a sound is enhanced and a sound pressure level characteristic is enhanced. Through the various experiments and inventive efforts, the inventors have invented a new vibration device, an apparatus including the same, and a vehicular apparatus including the same, in which the quality of a sound may be enhanced and a sound pressure level characteristic may be enhanced.

One or more aspects of the present disclosure are directed to provide an apparatus that substantially obviates one or more problems due to limitations and disadvantages of the related art.

One or more aspects of the present disclosure are directed to provide a vibration device and an apparatus including the same, which may vibrate an apparatus or a vibration object (or a vibration member) to generate a vibration or a sound, thereby enhancing a sound characteristic and/or a sound pressure level characteristic.

One or more aspects of the present disclosure are directed to provide a vibration device having a simplified structure and an apparatus including the same.

Furthermore, one or more aspects of the present disclosure are to provide a vibration device and an apparatus including the same being robust against external impacts.

To achieve these and other one or more aspects and advantages of the present disclosure, as embodied and broadly described herein, an apparatus may include a vibration member, a rear cover at a rear surface of the vibration member, a first vibration device at a first rear region of the rear cover, and a second vibration device at a second rear region of the rear cover.

In one or more aspects of the present disclosure, an apparatus may include a vibration member, a rear cover at a rear surface of the vibration member, a first vibration device at a first rear region of the rear cover, the first vibration device overlapping at least one of a horizontal region and a middle region of the rear cover, and a second vibration device at a second rear region of the rear cover, the second vibration device overlapping a periphery region or the middle region of the rear cover.

In one or more aspects of the present disclosure, an apparatus may include a vibration member, and a rear cover at a rear surface of the vibration member, the rear cover comprising a left region and a right region, the left region comprises first to sixteenth regions from a left uppermost end to a right lowermost end divided in a matrix sequence, the right region includes first to sixteenth regions from a right uppermost end to a left lowermost end divided in a matrix sequence, and the apparatus may further comprise a first vibration device disposed at one or more regions in the first to sixteenth regions close to a center of the rear cover and a second vibration device disposed at one or more regions in the first to sixteenth regions close to outside of the rear cover.

According to one or more example embodiments of the present disclosure, an apparatus enabling the transfer of a sound may be provided, and an apparatus for improving sound quality and increasing the immersion experience of a viewer may be provided.

According to one or more example embodiments of the present disclosure, an apparatus for outputting a sound in a forward direction of a display panel or a display member may be provided.

According to one or more example embodiments of the present disclosure, an apparatus for outputting a sound in a forward direction of a display panel or a display member using a display panel or a display member as a vibration plate may be provided.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate aspects and embodiments of the disclosure and together with the description serve to explain the principle of the disclosure.

FIG. 1 illustrates an apparatus according to an example embodiment of the present disclosure.

FIG. 2A illustrates an example of a vibration device at a rear cover of the apparatus illustrated in FIG. 1.

FIG. 2B illustrates an example where a high pitched sound is output from a vibration device at a rear cover of the apparatus illustrated in FIG. 1.

FIG. 2C illustrates an example where an apparatus according to an example embodiment of the present disclosure includes first to sixteenth regions.

FIG. 3 is an example of a cross-sectional view taken along line I-I′ of FIG. 2A.

FIG. 4 illustrates an example of a region A of FIG. 3.

FIG. 5A illustrates an example embodiment of a region B of FIG. 3.

FIG. 5B illustrates another example embodiment of a region B of FIG. 3.

FIG. 6A is a cross-sectional view of a second vibration device according to an example embodiment of the present disclosure.

FIGS. 6B and 6C are example plan views of the second vibration device of FIG. 6A

FIG. 6D is a cross-sectional view of a second vibration device according to another example embodiment of the present disclosure.

FIG. 6E is a cross-sectional view of a second vibration device according to an example embodiment of the present disclosure.

FIGS. 6F and 6G are example plan views of the second vibration device of FIG. 6E

FIG. 6H is a cross-sectional view of a second vibration device according to another example embodiment of the present disclosure.

FIG. 7 is a perspective view of a vibration device according to an example embodiment of the present disclosure.

FIG. 8 is an example of a cross-sectional view taken along line II-II′ of FIG. 7.

FIGS. 9 to 12 are perspective views of a vibration portion of a vibration device according to one or more example embodiments of the present disclosure.

FIG. 13A and FIG. 13B are plan views of a vibration device according to an example embodiment of the present disclosure.

FIG. 14 is an example of a cross-sectional view taken along line of FIG. 13.

FIG. 15 is a perspective view of a vibration portion of a vibration device according to an example embodiment of the present disclosure.

FIG. 16 is an example of a cross-sectional view taken along line IV-IV′ of FIG. 15.

FIGS. 17 to 20 are perspective views of a vibration portion of a vibration device according to one or more example embodiments of the present disclosure.

FIG. 21 illustrates a graph showing a sound pressure level characteristic of an apparatus according to an example embodiment of the present disclosure.

FIG. 22 is an example of a graph showing a sound pressure level characteristic of a first vibration device, a second vibration device, and an apparatus of FIG. 2A.

FIG. 23A is a photograph of an apparatus according to an example embodiment of the present disclosure.

FIG. 23B illustrates a vibration device at a rear cover of an apparatus according to an example embodiment of the present disclosure.

FIG. 24 illustrates an example where a resonance mode of a light guide plate according to a resonance frequency of a first vibration device of the present disclosure is construed.

FIG. 25A is a schematic diagram of an example of a first vibration device, a rear cover, and a light guide plate of the present disclosure.

FIG. 25B illustrates an example of a position change of a first vibration device at a rear cover of the present disclosure.

FIG. 26 is an example of a graph showing a sound pressure level characteristic measured under a condition of FIG. 25B.

FIGS. 27A to 27D illustrate a vibration device at a rear cover of an apparatus according to one or more example embodiments of the present disclosure.

FIG. 28 is an example of a graph showing a sound pressure level characteristic of the apparatus of FIGS. 27A to 27D.

FIG. 29 illustrates an example of a vibration portion of a second vibration device.

FIGS. 30A and 30B are examples of cross-sectional views taken along line V-V′ of FIG. 29.

FIG. 31 is a graph showing a sound pressure level characteristic of a second vibration device according to an example embodiment of the present disclosure.

FIG. 32 is an example of a graph showing a sound pressure level characteristic of the apparatus illustrated in FIGS. 2A and 27B.

FIG. 33 is an example of a graph showing a sound pressure level characteristic of the apparatus illustrated in FIGS. 2A and 27B.

FIG. 34 is an example of a graph showing a sound pressure level characteristic of a vibration device of an experimental example and the apparatus of FIG. 2B.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Reference will now be made in detail to embodiments of the present disclosure, examples of which may be illustrated in the accompanying drawings. In the following description, when a detailed description of well-known functions or configurations may unnecessarily obscure aspects of the present disclosure, the detailed description thereof may be omitted. The progression of processing steps and/or operations described is an example; however, the sequence of steps and/or operations is not limited to that set forth herein and may be changed as is known in the art, with the exception of steps and/or operations necessarily occurring in a particular order. Like reference numerals refer to like elements throughout unless stated otherwise. Names of the respective elements used in the following explanations are selected only for convenience of writing the specification and may be thus different from those used in actual products.

Advantages and features of the present disclosure, and implementation methods thereof, will be clarified through following embodiments described with reference to the accompanying drawings. The present disclosure may, however, be embodied in different forms and should not be construed as limited to the embodiments set forth herein. Rather, these embodiments are provided so that this disclosure is thorough and complete and fully conveys the scope of the present disclosure to those skilled in the art. Furthermore, the present disclosure is only defined by claims and their equivalents.

The shapes, sizes, ratios, angles, numbers, and the like disclosed in the drawings for describing embodiments of the present disclosure are merely examples, and thus, the present disclosure is not limited to the illustrated details. Where the terms “comprise,” “have,” “include,” “contain,” “constitute,” “make up of,” “formed of,” and the like are used, one or more other elements may be added unless the term, such as “only” is used. The terms of a singular form may include plural forms unless the context clearly indicates otherwise.

In construing an element, the element is construed as including an error or tolerance range even where no explicit description of such an error or tolerance range is provided.

Where positional relationships are described, for example, where the positional relationship between two parts is described using “on,” “over,” “under,” “above,” “below,” “beneath,” “near,” “close to,” or “adjacent to,” “beside,” “next to,” or the like, one or more other parts may be located between the two parts unless a more limiting term, such as “immediate(ly),” “direct(ly),” or “close(ly)” is used. For example, when a structure is described as being positioned “on,” “over,” “under,” “above,” “below,” “beneath,” “near,” “close to,” or “adjacent to,” “beside,” or “next to” another structure, this description should be construed as including a case in which the structures contact each other as well as a case in which a third structure is disposed or interposed therebetween. Furthermore, the terms “front,” “rear,” “left,” “right,” “top,” “bottom, “downward,” “upward,” “upper,” “lower,” and the like refer to an arbitrary frame of reference.

In describing a temporal relationship, for example, when the temporal order is described as “after,” “subsequent,” “next,” “before,” “prior to,” or the like, a case that is not continuous may be included unless a more limiting term, such as “just,” “immediate(ly),” or “direct(ly)” is used.

It will be understood that, although the term “first,” “second,” or the like may be used herein to describe various elements, these elements should not be limited by these terms. These terms are only used to distinguish one element from another. For example, a first element could be a second element, and, similarly, a second element could be a first element, without departing from the scope of the present disclosure.

In describing elements of the present disclosure, the terms “first,” “second,” “A,” “B,” “(a),” “(b),” or the like may be used. These terms are intended to identify the corresponding elements from the other elements, and the basis, order, or number of the corresponding elements should not be limited by these terms.

For the expression that an element or layer is “connected,” “coupled,” or “adhered” to another element or layer, the element or layer can not only be directly connected or adhered to another element or layer, but also be indirectly connected or adhered to another element or layer with one or more intervening elements or layers disposed or interposed between the elements or layers, unless otherwise specified.

For the expression that an element or layer “contacts,” “overlaps,” or the like with another element or layer, the element or layer can not only directly contact, overlap, or the like with another element or layer, but also indirectly contact, overlap, or the like with another element or layer with one or more intervening elements or layers disposed or interposed between the elements or layers, unless otherwise specified.

The term “at least one” should be understood as including any and all combinations of one or more of the associated listed items. For example, the meaning of “at least one of a first item, a second item, and a third item” denotes the combination of items proposed from two or more of the first item, the second item, and the third item as well as only one of the first item, the second item, or the third item.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

Features of various embodiments of the present disclosure may be partially or wholly coupled to or combined with each other and may be variously inter-operated, linked or driven together. The embodiments of the present disclosure may be carried out independently from each other or may be carried out together in a co-dependent or related relationship.

Hereinafter, an apparatus, a vibration apparatus and a vehicle including the same according to example embodiments of the present disclosure will be described in detail with reference to the accompanying drawings. In adding reference numerals to elements of each of the drawings, although the same elements may be illustrated in other drawings, like reference numerals may refer to like elements. In addition, for convenience of description, a scale, size and thickness of each of elements illustrated in the accompanying drawings may differ from an actual scale, size and thickness, and thus, embodiments of the present disclosure are not limited to a scale, size and thickness illustrated in the drawings.

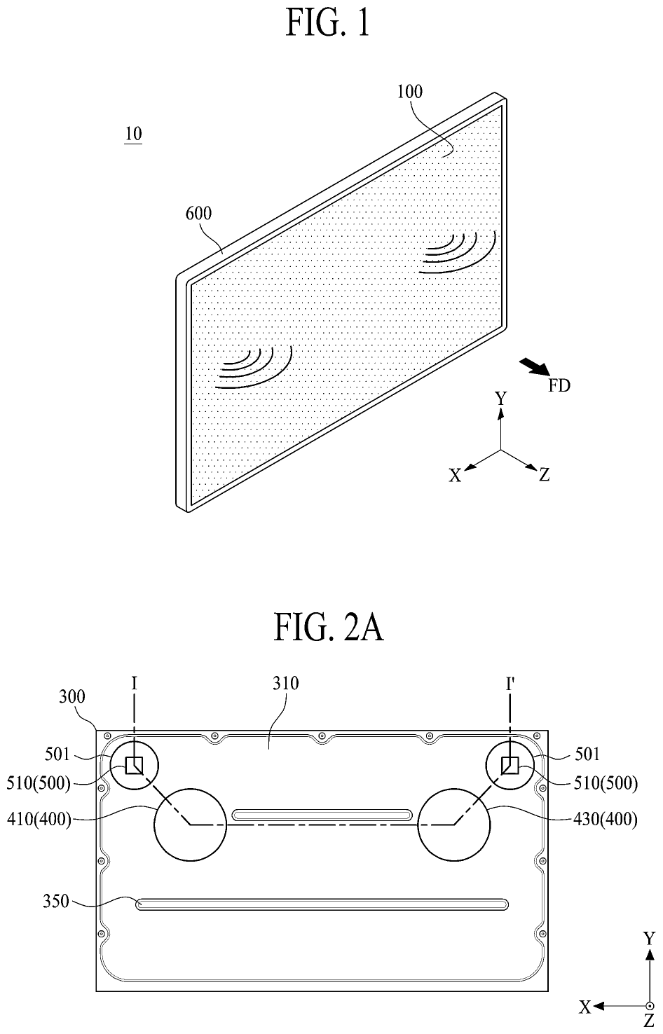

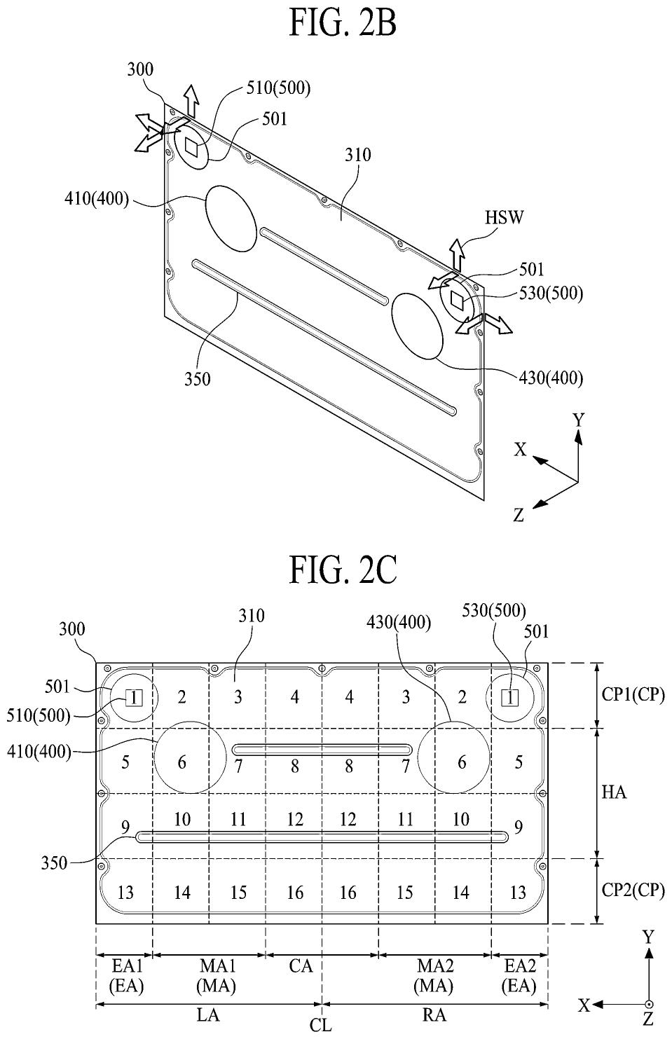

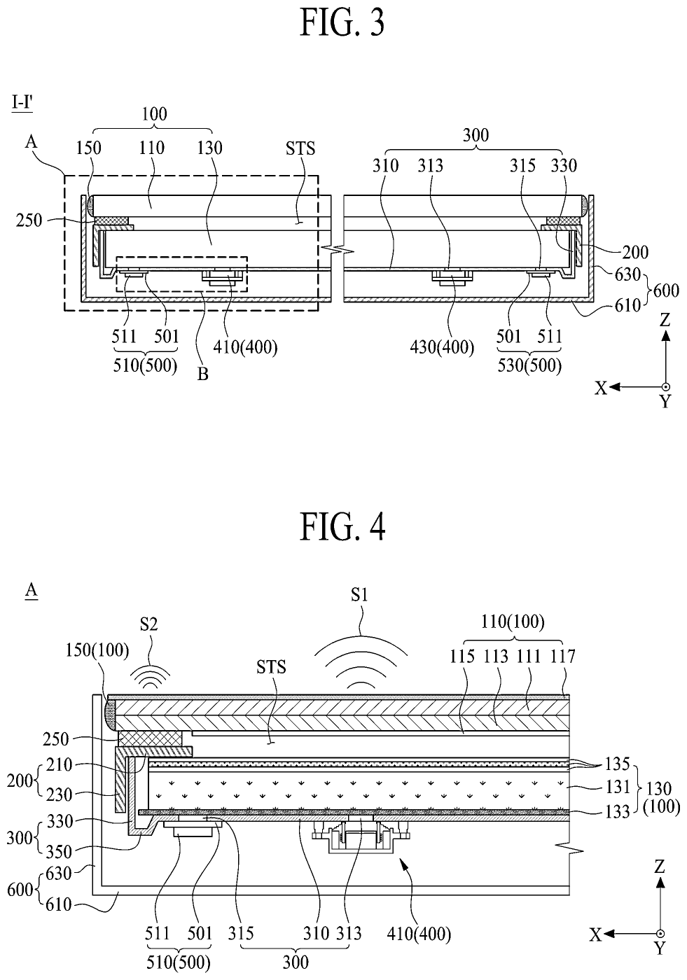

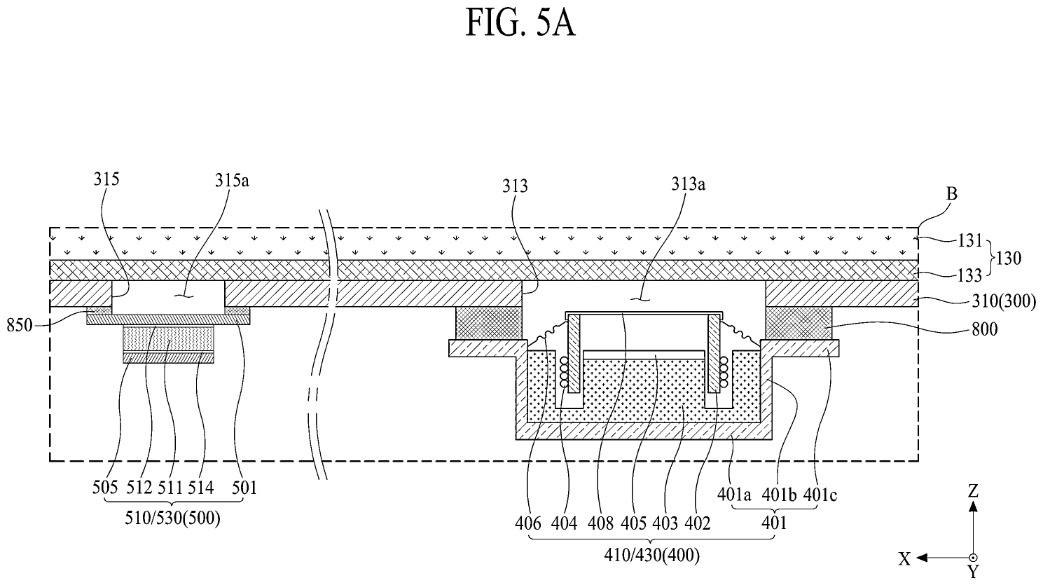

FIG. 1 illustrates an apparatus according to an example embodiment of the present disclosure. FIG. 2A illustrates an example of a vibration device at a rear cover of the apparatus illustrated in FIG. 1. FIG. 2B illustrates an example where a high pitched sound is output from a vibration device at a rear cover of the apparatus illustrated in FIG. 1, FIG. 2C illustrates an example where an apparatus according to an example embodiment of the present disclosure includes first to sixteenth regions. FIG. 3 is an example of a cross-sectional view taken along line I-I′ of FIG. 2A. FIG. 4 illustrates an example of a region A of FIG. 3.

Referring to FIGS. 1, 2A to 2C, 3, and 4, an apparatus 10 according to an example embodiment of the present disclosure may include a display member 100, a guide member 200, a rear cover 300, a first vibration device 400, and a second vibration device 500.

The display member 100 according to an example embodiment of the present disclosure may include a display panel 110 configured to display an image. For example, an image may include an electronic image, a digital image, a still image, or a video image. The display member 100 may be a liquid crystal display panel, but embodiments of the present disclosure are not limited thereto. For example, the display member 100 may be a display panel such as a light emitting display panel, an electrophoretic display panel, a micro light emitting diode display panel, an electro-wetting display panel, or a quantum dot light emitting display panel.

The display member 100 according to an example embodiment of the present disclosure may include a display panel 110 and a backlight part 130.

The display panel 110 may display an image by light irradiated from the backlight part 130. The display panel 110 may act as a vibration plate which vibrates based on a vibration (or driving) of each of the first and second vibration devices 400 and 500 to output a sound in a forward direction of the apparatus. For example, the display panel 110 may simultaneously or sequentially output a first sound S1 of a first pitched sound band based on a vibration of the first vibration device 400 and a second sound S2 of a second pitched sound band, which is based on a vibration of the second vibration device 500 and differs from the first pitched sound band, in a forward direction. In an example embodiment of the present disclosure, the first sound S1 of the first pitched sound band may be output in the forward direction at a center portion of the display panel 110, and the second sound S2 of the second pitched sound band which is higher than the first sound S1 of the first pitched sound band may be output in a rearward direction and/or a lateral direction of the apparatus at an edge portion (or a periphery portion) of the display panel 110 as illustrated in FIGS. 2B and 4.

The first vibration device 400 may be a coil type vibration generating device, and the second vibration device 500 may be a piezoelectric type generating device. The second vibration device 500 may vibrate by a piezoelectric effect.

The apparatus according to an example embodiment of the present disclosure includes a vibration member, the first vibration device 400 disposed at a first rear region of the vibration member, the second vibration device 500 disposed at a second rear region of the vibration member. In this example, the vibration member may be the display member 100 or a display module.

The vibration member may include one or more of a metal, a plastic, a paper, a fiber, a fabric, and a leather.

The apparatus according to an example embodiment of the present disclosure may generate or output a sound to a front direction of the vibration member or the display panel by using the vibration member or the display panel as a vibration plate.

The second vibration device 500 may be between the first vibration devices 400. In addition, according to another example embodiment of the present disclosure, the first vibration device 400 may be between the second vibration devices 500.

In addition, the apparatus according to another example embodiment of the present disclosure includes a vibration member, a rear cover 300 disposed at a rear surface of the vibration member, the first vibration device 400 disposed at a first rear region of the rear cover 300, the second vibration device 500 disposed at a second rear region of the rear cover 300. In this example, the vibration member may be the display member 100 or a display module.

The display panel 110 according to an example embodiment of the present disclosure may include an upper substrate 111, a lower substrate 113, a lower polarization member 115, and an upper polarization member 117.

The upper substrate 111 may be a first substrate or a thin film transistor (TFT) array substrate and may include a pixel array (or a display portion) including a plurality of pixels respectively in a plurality of pixel areas defined by intersections between a plurality of gate lines and a plurality of data lines. Each of the plurality of pixels may include a TFT connected to a gate line and a data line, a pixel electrode connected to the TFT, and a common electrode which is formed adjacent to the pixel electrode and is supplied with a common voltage.

The upper substrate 111 may further include a pad portion which is provided at a first edge (or a first non-display portion or a first periphery) thereof and a gate driving circuit which is provided at a second edge (or a second non-display portion or a second periphery).

The pad portion may supply a signal, supplied from the outside, to the pixel array and the gate driving circuit. For example, the pad portion may include a plurality of data pads, which are connected to the plurality of data lines through a plurality of data link lines, and a plurality of gate input pads which are connected to the gate driving circuit through a gate control signal line. In an example embodiment of the present disclosure, the first edge of the upper substrate 111 including the pad portion may protrude from a lateral surface corresponding to the first edge of the lower substrate 113, and the pad portion may be exposed in a rear-surface direction toward the rear cover 300. For example, a size of the upper substrate 111 may be greater than that of the lower substrate 113, but example embodiments of the present disclosure are not limited thereto.

The gate driving circuit according to an example embodiment of the present disclosure may be embedded (or integrated) into a second edge (or a second periphery) of the upper substrate 111 so as to be connected to a plurality of gate lines in a one-to-one relationship. For example, the gate driving circuit may be implemented with a shift register including a transistor formed by the same process as a TFT in the pixel area.

According to another example embodiment of the present disclosure, the gate driving circuit may be implemented as an integrated circuit (IC) type without being embedded into the upper substrate 111 and may be included in the panel driving circuit.

The lower substrate 113 may be a second substrate or a color filter array substrate and may include a pixel definition pattern, which defines an opening region overlapping each pixel area in the upper substrate 111, and a color filter layer formed in the opening region. The lower substrate 113 according to an example embodiment of the present disclosure may have a size which is less than that of the upper substrate 111, but embodiments of the present disclosure are not limited thereto. For example, the lower substrate 113 may overlap the other portion, except the first edge, of the upper substrate 111. The lower substrate 113 may be bonded or attached to the other portion, except the first edge, of the upper substrate 111 with a liquid crystal layer therebetween by a sealant.

The liquid crystal layer may be disposed between the upper substrate 111 and the lower substrate 113 and may include liquid crystal where an alignment direction of liquid crystal molecules is changed based on an electrical field generated by the common voltage and a data voltage applied to the pixel electrode in each pixel.

The lower polarization member 115 may be attached on a lower surface of the lower substrate 113 and may polarize light which is incident from the backlight part 130 and travels to the liquid crystal layer.

The upper polarization member 117 may be attached on an upper surface of the upper substrate 111 and may polarize light which passes through the upper substrate 111 and is discharged or radiated to the outside.

The display panel 110 according to an example embodiment of the present disclosure may drive the liquid crystal layer based on an electrical field which is generated in each pixel based on the common voltage and a data voltage applied to each pixel, and thus, may display an image based on light passing through the liquid crystal layer.

In the display panel 110 according to an example embodiment of the present disclosure, the upper substrate 111 including the TFT array substrate may configure an image display surface, and thus, a whole front surface thereof may be exposed at the outside without a portion covered by a separate mechanism or a separate structure.

According to another example embodiment of the present disclosure, in the display panel 110, the upper substrate 111 may be implemented as the color filter array substrate, and the lower substrate 113 may be implemented as the TFT array substrate. For example, the display panel 110 according to another example embodiment of the present disclosure may have a structure where the display panel 110 according to an example embodiment of the present disclosure is reversed upward and downward. In this case, the pad portion of the display panel 110 according to another example embodiment of the present disclosure may be covered by a separate mechanism or a separate structure.

The apparatus 10 according to an example embodiment of the present disclosure may further include a buffering member 150.

The buffering member 150 may be formed to surround at least one of a lateral surface of the display panel 110. The buffering member 150 may be formed to cover each lateral surface and each corner of the display panel 110. The buffering member 150 may protect the at least one of the lateral surface of the display panel 110 from an external impact, or may prevent light leakage through the lateral surfaces of the display panel 110. The buffering member 150 according to an example embodiment of the present disclosure may include a silicone-based or ultraviolet (UV) curing-based sealant (or resin). Considering a process tact time, the buffering member 150 may include the UV curing-based sealant. In addition, the buffering member 150 according to an example embodiment of the present disclosure may have a color, and for example, may be blue, red, bluish green, or black, but embodiments of the present disclosure are not limited thereto. For example, the buffering member 150 may include a colored resin or a light blocking resin for preventing lateral light leakage.

A portion of an upper surface of the buffering member 150 according to an example embodiment of the present disclosure may be covered by the upper polarization member 117. In this case, the upper polarization member 117 may include an extension portion which extends long from a lateral surface corresponding to an outer surface of the upper substrate 111 to cover a portion of a front surface of the buffering member 150 and is attached on the portion of the front surface of the buffering member 150. An attachment surface between the buffering member 150 and the upper substrate 111 (or a boundary portion between the buffering member 150 and the upper substrate 111) may be concealed by the extension portion of the upper polarization member 117, and thus, may not be exposed in a forward direction FD of the display apparatus. When the buffering member 150 is not provided, the front surface of the display panel 110 may not be covered by a separate mechanism or a separate structure and may be exposed in the forward direction FD of the display apparatus, and as a result, the side light leakage of the display panel 110 may occur. Therefore, in a display apparatus having a structure where the whole front surface of the display panel 110 is exposed in the forward direction FD so as to remove or minimize a bezel width of the display apparatus, the buffering member 150 may be configured to prevent the lateral light leakage of the display panel 110 and to protect the lateral surfaces of the display panel 110. However, embodiments of the present disclosure are not limited thereto, and the buffering member 150 may be omitted.

The backlight part 130 may be disposed at a rear surface of the display panel 110 and may irradiate light onto the rear surface of the display panel 110.

The backlight part 130 according to an example embodiment of the present disclosure may include a light guide plate 131, a light source part, a reflective sheet 133, and an optical sheet part 135.

The light guide plate 131 may include a light input surface which is disposed on the rear cover 300 to overlap the display panel 110 and is provided on at least one sidewall thereof. The light guide plate 131 may include a light-transmitting plastic or glass material, but embodiments of the present disclosure are not limited thereto. The light guide plate 131 may transfer (output) light, which is incident through the light input surface from the light source part, to the display panel 110. For example, the light guide plate 131 may be referred to as a light guide member or a flat light source, but the terms are not limited thereto.

The light source part may irradiate light onto the light input surface provided in the light guide plate 131. The light source part may be disposed at the rear cover 300 to overlap the first edge (or the first periphery) of the display panel 110. The light source part according to an example embodiment of the present disclosure may include a plurality of light emitting diodes which are mounted on a light-source printed circuit board (PCB) and irradiate lights onto the light input surface of the light guide plate 131.

The reflective sheet 133 may be disposed at the rear cover 300 (which may be sometimes referred to as a supporting member) and configured to cover a rear surface of the light guide plate 131. The reflective sheet 133 may reflect light, which is incident from the light guide plate 131, to the light guide plate 131 to minimize the loss of the light.

The optical sheet part 135 may be disposed on a front surface of the light guide plate 131 and may enhance a luminance characteristic of light output from the light guide plate 131. The optical sheet part 135 according to an example embodiment of the present disclosure may include a lower diffusive sheet, a lower prism sheet, and an upper prism sheet. For example, the optical sheet part 135 may be configured as one layer including the lower diffusion sheet, the lower prism sheet, and the upper prism sheet. However, embodiments of the present disclosure are not limited thereto, and the optical sheet part 135 may be provided as a stacked combination of one or more of a diffusion sheet, a prism sheet, a dual brightness enhancement film, and a lenticular sheet, or may be implemented as one composite sheet having a function of diffusing and collecting light.

The guide member 200 may support a rear edge region (or a rear periphery region) of the display panel 110. The guide member 200 may be supported by, accommodated into or incorporated into the rear cover 300 to overlap the rear edge region of the display panel 110. The guide member 200 may be disposed under the rear edge region of the display panel 110 not to protrude to the outside of each lateral surface of the display panel 110.

The guide member 200 according to an example embodiment of the present disclosure may include a panel supporting part 210 and a guide sidewall 230. For example, the guide member 200 may have a cross-sectional structure having a ¬-shape or a [symbol] -shape based on a coupling structure (or a connection structure) of the panel supporting part 210 and the guide sidewall 230.

The panel supporting part 210 may be coupled or connected to the rear edge portion (or rear periphery portion) of the display panel 110 and may be supported by the rear cover 300. For example, the panel supporting part 210 may have a quadrilateral band shape including an opening portion overlapping a center portion, other than the rear edge portion, of the display panel 110, but a shape is not limited thereto. The panel supporting part 210 may have a size equal to or less than that of the display panel 110 not to protrude to the outside of each lateral surface of the display panel 110. For example, the opening portion of the panel supporting part 210 may have a size which is equal to or greater than that of the pixel array (or the display portion) provided in the display panel 110.

The panel supporting part 210 may directly contact an uppermost surface of the backlight part 130 (for example, an uppermost surface of the optical sheet part 135), or may be spaced apart from the uppermost surface of the optical sheet part 135 by a certain distance.

The guide sidewall 230 may be connected to the panel supporting part 210 and may surround lateral surfaces of the rear cover 300. For example, the guide sidewall 230 may be bent from the panel supporting part 210 to the lateral surfaces of the rear cover 300 and may surround the lateral surfaces of the rear cover 300 or may be surrounded by the lateral surfaces of the rear cover 300.

The guide member 200 according to an example embodiment of the present disclosure may include a plastic material, a metal material, or a mixed material of a plastic material and a metal material. For example, the guide member 200 may act as a vibration transfer member which transfers a sound vibration, generated by the second vibration device 500, to the rear edge portion of the display panel 110. Therefore, the guide member 200 may transfer the sound vibration, generated by the second vibration device 500, to the display panel 110 without being lost while maintaining stiffness of the display panel 110. For example, the guide member 200 may include a metal material for transferring the sound vibration, generated by the second vibration device 500, to the display panel 110 while maintaining stiffness of the display panel 110, but embodiments of the present disclosure are not limited thereto.

The guide member 200 according to an example embodiment of the present disclosure may be coupled to the rear edge portion of the display panel 110 by a first coupling member 250.

The first coupling member 250 (or a panel coupling member or a first connection member) may be disposed between the rear edge portion of the display panel 110 and the panel supporting part 210 of the guide member 200 and may place or couple the display panel 110 at or to the guide member 200. The first coupling member 250 may include an acrylic-based adhesive member or a urethane-based adhesive member, but embodiments of the present disclosure are not limited thereto. For example, the first coupling member 250 may include the urethane-based adhesive member which is relatively greater in adhesive force and hardness than the acrylic-based adhesive member and which can thus enhance the transferability of a vibration of the guide member 200 to the display panel 110. In one or more examples, the first coupling member 250 may include an acrylic-based adhesive layer, a double-sided foam adhesive pad, or an acrylic-based adhesive resin curing layer.

A front surface of the first coupling member 250 according to an example embodiment of the present disclosure may be coupled or connected to the lower substrate 113 or the lower polarization member 115 of the display panel 110. The first coupling member 250 may be directly coupled or connected to the rear edge portion of the lower substrate 113 so as to enhance an adhesive force between the first coupling member 250 and the display panel 110. In this case, the first coupling member 250 may be attached on the rear edge portion of the lower substrate 113 and may surround a lateral surface of the lower polarization member 115, thereby preventing side light leakage from occurring in the lower polarization member 115.

The first coupling member 250 may provide a sound transfer space STS between the display panel 110 and the guide member 200 to have a certain thickness (or height). The sound transfer space STS represents a gap between the backlight 130 and the display panel 110. The first coupling member 250 according to an example embodiment may be provided in a four-side-closed shape or a closed loop shape in the panel supporting part 210 of the guide member 200. In this case, the first coupling member 250 may provide the closed sound transfer space STS between a rearmost surface of the display panel 110 and an uppermost surface of the backlight part 130 which face each other with the opening portion of the guide member 200 therebetween, thereby preventing or minimizing the leakage (or loss) of a sound pressure transferred to the sound transfer space STS. The sound transfer space STS may also act as a sound generating space where a sound pressure is generated based on a vibration of the backlight part 130 or a panel vibration space which enables a vibration of the display panel 110 to be smoothly performed.

The rear cover 300 may support the guide member 200 and may cover the rear surface of the display member 100. In addition, the rear cover 300 may support the first and second vibration devices 400 and 500. The rear cover 300 according to an example embodiment of the present disclosure may act as a vibration plate and may include a metal material or a metal alloy material, but embodiments of the present disclosure are not limited thereto. For example, the rear cover 300 may include at least one material among an aluminum (Al) material, magnesium (Mg) material, a magnesium (Mg) alloy material, a magnesium-lithium (Mg—Li) alloy material, and an Al alloy material, but embodiments of the present disclosure are not limited thereto.

The rear cover 300 according to an example embodiment of the present disclosure may include a rear cover part 310 which supports the rear surface of the display member 100 and a lateral cover part 330 which supports the guide member 200.

The rear cover part 310 may be disposed to cover the rear surface of the display member 100 and may support the display member 100. The rear cover part 310 may be formed in a plate structure and may support the backlight part 130 of the display member 100 and each of the first vibration device 400 and the second vibration device 500. For example, the rear cover part 310 may directly contact a rear surface of the reflective sheet 133, and thus, may transfer a sound vibration, generated based on a vibration of each of the first vibration device 400 and the second vibration device 500, to the reflective sheet 133 of the backlight part 130.

In FIG. 4, it is illustrated that the rear cover part 310 is closely adhered to the backlight part 130, but embodiments of the present disclosure are not limited thereto and the rear cover part 310 may be spaced apart from the backlight part 130 by a certain space and an air layer may be formed in a separation space or a space. According to an example embodiment of the present disclosure, a separation space or a space between the rear cover part 310 and the backlight part 130 may be disposed at a center portion of the display member 100.

According to an example embodiment of the present disclosure, the rear cover 300 may further include a first hole 313 and a second hole 315.

The first hole 313 (or a first through hole or a first rear cover hole) may be disposed at a first rear region of the rear cover 300 overlapping the first vibration device 400 and may be covered by the reflective sheet 133 of the backlight part 130. For example, the first hole 313 may be provided at a middle region MA of the rear cover part 310. The first hole 313 may be formed to pass through the rear cover part 310 in the middle region MA of the rear cover part 310 in a thickness direction Z of the rear cover part 310. According to an example embodiment of the present disclosure, the vibration device 400 may have a circular shape, an ellipse or oval shape, or a quadrilateral shape, but embodiments of the present disclosure are not limited thereto.

The first hole 313 may provide a first gap space between the backlight part 130 and the first vibration device 400. For example, the first gap space may be referred to as a vibration space based on driving of the first vibration device 400, a sound pressure level space (or a sound portion or a soundbox or a resonator) where a sound pressure level is generated based on a vibration of the first vibration device 400, or a sound wave propagation path (or a sound energy incident portion or a sound wave transfer path) through which a sound wave generated based on the vibration of the first vibration device 400 is directly propagated (or transferred) to the display member 100, but embodiments of the present disclosure are not limited thereto.

A size (or a width) of the first hole 313 according to an example embodiment of the present disclosure may be less than that of the first vibration device 400. When a total size (or a total width) of the first hole 313 is greater than a total size of the first vibration device 400, the first vibration device 400 may be inserted (or pass through or accommodated) into the first hole 313, and thus, the first vibration device 400 may not be disposed at the first hole 313 without a separate mechanism or a separate structure. Accordingly, when a total size of the first hole 313 is less than a total size of the first vibration device 400, the first vibration device 400 may be disposed in the first hole 313 without a separate mechanism or a separate structure. For example, the first hole 313 according to an example embodiment of the present disclosure may have the same shape as that of the first vibration device 400 or may have a quadrilateral shape or a circular shape, but embodiments of the present disclosure are not limited thereto.

The second hole 315 (or a second through hole or a second rear cover hole) may be disposed at a second rear region of the rear cover 300 overlapping the second vibration device 500 and may be covered by the reflective sheet 133 of the backlight part 130. For example, the second hole 315 may be provided in a periphery region (or an edge region) EA of the rear cover part 310. The second hole 315 may be formed to pass through the rear cover part 310 in the periphery region EA of the rear cover part 310 in the thickness direction Z of the rear cover part 310. According to an example embodiment of the present disclosure, the second hole 315 may have a circular shape, an ellipse or oval shape, a quadrilateral shape, or a polygonal shape, but embodiments of the present disclosure are not limited thereto.

The second hole 315 may provide a second gap space between the backlight part 130 and the second vibration device 500. For example, the second gap space may be referred to as a vibration space based on driving of the second vibration device 500, a sound pressure level space (or a sound portion or a soundbox or a resonator) where a sound pressure level is generated based on a vibration of the second vibration device 500, or a sound wave propagation path (or a sound energy incident portion or a sound wave transfer path) through which a sound wave generated based on the vibration of the second vibration device 500 is directly propagated or transferred to the display member 100, but embodiments of the present disclosure are not limited thereto.

A size (or a width) of the second hole 315 according to an example embodiment of the present disclosure may be less than that of the second vibration device 500. When a total size (or a total width) of the second hole 315 is greater than a total size of the second vibration device 500, the second vibration device 500 may be inserted (or pass through or accommodated) into the second hole 315, and thus, the second vibration device 500 may not be disposed in the second hole 315 without a separate mechanism or a separate structure. Accordingly, when a total size of the second hole 315 is less than a total size of the first vibration device 400, the second vibration device 500 may be disposed in the second hole 315 without a separate mechanism or a separate structure. For example, the second hole 315 according to an example embodiment of the present disclosure may have the same shape as that of the second vibration device 500 or may have a quadrilateral shape, a circular shape, an oval shape, or a polygonal shape, but embodiments of the present disclosure are not limited thereto.

The lateral cover part 330 may be bent from an edge or a periphery of the rear cover part 310 and may support the guide member 200. The lateral cover part 330 may provide a backlight accommodation space or an accommodation space in the rear cover part 310 and may surround lateral surfaces of the backlight part 130 accommodated into (or supported by) the backlight accommodation space. The lateral cover part 330 may transfer a sound vibration, generated in the rear cover part 310 by the second vibration device 500, to the guide member 200.

The rear cover 300 according to an example embodiment of the present disclosure may further include a reinforcement part 350. The reinforcement part 350 may reinforce the stiffness of the rear cover 300, and thus, may be a stiffness reinforcement part, but embodiments of the present disclosure are not limited thereto.

The reinforcement part 350 according to an example embodiment of the present disclosure may be formed in a region (or a connection region) where the rear cover part 310 intersects with the lateral cover part 330. In an example embodiment of the present disclosure, the reinforcement part 350 may be formed along the periphery region EA of the rear cover part 310. For example, the reinforcement part 350 may protrude in a rear-surface direction to include an inclined surface inclined from an end of the rear cover part 310. When the rear cover 300 includes the reinforcement part 350, the lateral cover part 330 may be connected to an end or a portion of the reinforcement part 350.

The first vibration device 400 may be disposed at a first rear region of the rear cover 300 and may vibrate a first rear region of the display member 100. For example, the first rear region of the rear cover 300 may overlap a middle region MA or a periphery region EA of the display member 100, and the first region of the display member 100 may be the middle region MA or the periphery region EA.

When the vibrating member is bisected in the longitudinal direction, the first rear region may be a region overlapping the central portion except for a periphery or an edge of the bisected rear cover 300.In this example, the periphery or the edge may include the periphery region EA, and the central portion may include the center region CA and the middle region MA.

The first rear region may be disposed on an upper end side or an upper portion of the central portion. In this example, the upper end side may be an upper portion when the vibrating member is vertically bisected.

The first rear region may be disposed at a periphery of the central portion, and the periphery may be a side or portion adjacent to the short side edge (or the short side periphery) of the vibration member.

The first vibration device 400 according to an example embodiment of the present disclosure may be disposed at the middle region MA of the rear cover 300 and may vibrate the middle region MA of the display member 100. The first vibration device 400 may generate a sound pressure level between the display member 100 and the rear cover 300 at the middle region MA of the display member 100. The first vibration device 400 may generate a sound pressure level between the display member 100 and the rear cover 300 and may vibrate the middle region MA of the display member 100 based on the sound pressure level to generate the first sound S1 of the first pitched sound band at the middle region MA of the display member 100. The first sound S1 of the first pitched sound band according to an example embodiment of the present disclosure may have a frequency of a low pitched sound band. For example, the low pitched sound band may be 200 Hz or less, but embodiments of the present disclosure are not limited thereto and may be, for example, 3 kHz or less.

The first vibration device 400 according to an example embodiment of the present disclosure may be coupled to or disposed at the middle region MA of the rear cover part 310 of the rear cover 300. For example, the first vibration device 400 may be coupled to or disposed at the middle region MA of the rear cover part 310. Therefore, in response to a sound signal (or a voice signal) input from the outside, the first vibration device 400 may vibrate the middle region MA of the rear cover part 310 to generate a sound pressure level and may vibrate the middle region MA of the display member 100 based on the sound pressure level to generate the first sound S1. The first vibration device 400 according to an example embodiment of the present disclosure may include a sound actuator or a sound exciter, but embodiments of the present disclosure are not limited thereto and may be implemented as a sound generating apparatus using, for example, a coil (or a voice coil) and a magnet.

The first vibration device 400 according to an example embodiment of the present disclosure may include a first sound generating device 410 and a second sound generating device 430.

The first sound generating device 410 may vibrate a first middle region MA1 of the middle region MA of the display member 100 to output the first sound S1 of the first pitched sound band in the forward direction FD of the display panel 110. The first sound generating device 410 may be disposed at a first middle region MA1 of the middle region MA of the rear cover part 310. For example, the first sound generating device 410 may be disposed at or coupled to the rear cover part 310 to cover the first hole 313 in the first middle region MA1 of the rear cover part 310.

In response to a sound signal, the first sound generating device 410 according to an example embodiment of the present disclosure may vibrate the first middle region MA1 of the rear cover part 310 to generate a sound pressure level in an inner portion (or a first gap space) of the first hole 313, and thus, may vibrate the first middle region MA1 of the display member 100 to generate the first sound S1 of the first pitched sound band. For example, when the first sound generating device 410 vibrates based on the sound signal, a sound pressure level may be generated in the first hole 313 based on a vibration of the first middle region MA1 of the rear cover part 310 based on a vibration of the first sound generating device 410, a sound pressure level may be generated in the sound transfer space STS based on a vibration of the backlight part 130 based on the sound pressure level in the first hole 313, and the first sound S1 of the first pitched sound band, generated based on the vibration of the first middle region MA1 of the display panel 110 based on the sound pressure level generated in the sound transfer space STS, may be output in the forward direction FD of the display panel 110. Accordingly, a sound wave generated based on a vibration of the first sound generating device 410 may be directly transferred (or propagated) to the display member 100 through the first hole 313, and thus, a sound pressure level characteristic and sound quality of the first sound S1 may be enhanced.

The second sound generating device 430 may vibrate a second middle region MA2 of the middle region MA of the display member 100 to output the first sound S1 of the first pitched sound band in the forward direction of the display panel 110. The second sound generating device 430 may be disposed at a second middle region MA2 of the middle region MA of the rear cover part 310. For example, the second sound generating device 430 may be disposed at or coupled to the rear cover part 310 to cover the first hole 313 formed in the second middle region MA2 of the rear cover part 310.

In response to the sound signal, the second sound generating device 430 according to an example embodiment of the present disclosure may vibrate the second middle region MA2 of the rear cover part 310 to generate a sound pressure level in an inner portion (or a first gap space) of the first hole 313, and thus, may vibrate the second middle region MA2 of the display member 100 to generate the first sound S1 of the first pitched sound band. For example, when the second sound generating device 430 vibrates based on the sound signal, a sound pressure level may be generated in the first hole 313 based on a vibration of the second middle region MA2 of the rear cover part 310 based on a vibration of the second sound generating device 430, and a sound pressure level may be generated in the sound transfer space STS based on a vibration of the backlight part 130 based on the sound pressure level in the first hole 313, and the first sound S1 of the first pitched sound band, generated based on the vibration of the second middle region MA2 of the display panel 110 based on the sound pressure level generated in the sound transfer space STS, may be output in the forward direction FD of the display panel 110. Accordingly, a sound wave generated based on a vibration of the second sound generating device 430 may be directly transferred (or propagated) to the display member 100 through the first hole 313, and thus, a sound pressure level characteristic and sound quality of the first sound S1 may be enhanced.

Positions of the first sound generating device 410 and the second sound generating device 430 according to an example embodiment of the present disclosure may be adjusted based on implementation of a sound including a stereophonic sound or harmony with a sound based on vibrations of the first sound generating device 410 and the second sound generating device 430. For example, an arrangement position of each of the first sound generating device 410 and the second sound generating device 430 may be disposed to have a symmetrical structure or to be asymmetrical with respect to a center line CL of the display member 100, with respect to a first direction X (or a widthwise direction) of the display member 100.

The second vibration device 500 may be disposed at a second rear region of the rear cover 300 and may vibrate a second rear region of the display member 100. For example, the second rear region of the rear cover 300 may be a portion other than the first rear region in the periphery region EA and the middle region MA of the display member 100, and the second rear region of the display member 100 may be a portion other than the first region in the periphery region EA and middle region MA.

When the vibration member is bisected in the longitudinal direction, the second rear region may be a region overlapping a periphery and an outermost corner of the bisected vibration member. The first rear region and second rear region may be regions which do not overlap each other. In this example, the periphery may be an area including the periphery region EA, and the area overlapping the outermost corner may be an area including the corner region CP.

The second vibration device 500 according to an example embodiment of the present disclosure may be disposed at the first rear region of the rear cover 300 and may vibrate the middle region MA or the periphery region EA of the display member 100. The second vibration device 500 may generate a sound vibration in the middle region MA or the periphery region EA of the display member 100. The second vibration device 500 may generate a second sound S2 of a second pitched sound band, which differs from the first sound S1 of the first pitched sound band generated in the middle region MA and the periphery region EA of the display member 100, in the periphery region EA of the display member 100.

In addition, the second vibration device 500 according to an example embodiment of the present disclosure may be disposed at the first rear region of the rear cover 300 and may vibrate the periphery region EA of the display member 100. The second vibration device 500 may generate a sound vibration in the periphery region EA of the display member 100. The second vibration device 500 may generate a second sound S2 of a second pitched sound band, which differs from the first sound S1 of the first pitched sound band generated in the middle region MA and the edge area EA of the display member 100, in the periphery region EA of the display member 100.

The second sound S2 of the second pitched sound band according to an example embodiment of the present disclosure may have a frequency of a middle-high pitched sound band or a high pitched sound band. For example, a middle pitched sound band may be 200 Hz to 3 kHz, but embodiments of the present disclosure are not limited thereto and may be, for example, 3 kHz to 5 kHz. A high pitched sound band may be 3 kHz or more, but embodiments of the present disclosure are not limited thereto and may be, for example, 5 kHz or more.

The second vibration device 500 according to an example embodiment of the present disclosure may be coupled to or disposed at the periphery region EA of the rear cover part 310 of the rear cover 300. For example, the second vibration device 500 may be coupled to or disposed at the periphery region EA of the rear cover part 310. Accordingly, in response to a sound signal (or a voice signal) input from the outside, the second vibration device 500 may vibrate the periphery region EA of the rear cover part 310 to generate a sound vibration and may vibrate the periphery region of the display member 100 based on the sound vibration of the second vibration device 500 to generate the second sound S2 of the second pitched sound band. The second vibration device 500 according to an example embodiment of the present disclosure may be configured to vibrate by the piezoelectric effect. The second vibration device 500 according to an example embodiment of the present disclosure may include a piezoelectric material or a piezoelectric device having a piezoelectric effect (or an inverse piezoelectric characteristic). For example, the piezoelectric device may be a piezoelectric material layer, a piezoelectric vibration part, a piezoelectric driving part, a piezoelectric vibration layer, a piezoelectric structure, or the like, but embodiments of the present disclosure are not limited thereto.

The second vibration device 500 according to an example embodiment of the present disclosure may include a first piezoelectric vibration device 510 and a second piezoelectric vibration device 530.

The first piezoelectric vibration device 510 may vibrate a first periphery region EA1 (or a first edge area or a left edge area) of the periphery region EA of the display member 100 to output the second sound S2 of the second pitched sound band in the forward direction of the display panel 110. The first piezoelectric vibration device 510 may be disposed at the first periphery region (or a left edge region or a left periphery region) EA1 among the periphery region EA of the rear cover part 310. For example, the first piezoelectric vibration device 510 may be disposed at or coupled to the rear cover part 310 to cover the second hole 315 in the first periphery region EA1 of the rear cover part 310.

In response to the sound signal, the first piezoelectric vibration device 510 according to an example embodiment of the present disclosure may vibrate the first periphery region EA1 of the rear cover part 310 to vibrate the first periphery region EA1 of the display panel 110, thereby generating the second sound S2 of the second pitched sound band in the first periphery region EA1 of the display panel 110. For example, when the first piezoelectric vibration device 510 vibrates based on the sound signal, a sound vibration generated in the first periphery region EA1 of the rear cover part 310 based on a vibration of the first piezoelectric vibration device 510 may be transferred to the first periphery region EA1 of the display panel 110 through the guide member 200 and the lateral cover part 330 of the rear cover 300, and the second sound S2 of the second pitched sound band, generated based on a vibration of the first periphery region EA1 of the display panel 110 based on the sound vibration transferred through the guide member 200, may be output in the forward direction of the display panel 110. Accordingly, a sound wave generated based on a vibration of the first piezoelectric vibration device 510 may be directly transferred (or propagated) to the first periphery region EA1 of the display member 100 through the second hole 315, and thus, a sound pressure level characteristic and sound quality of the second sound S2 may be enhanced. In addition, a vibration of the first periphery region EA1 of the rear cover part 310 based on a vibration of the first piezoelectric vibration device 510 may be reduced, and thus, a sound pressure level characteristic and sound quality of the second sound S2 may be further enhanced.

The first piezoelectric vibration device 510 according to an example embodiment of the present disclosure may be disposed adjacent to the lateral cover part 330 of the rear cover 300 so that a high-level second sound S2 generated based on a sound vibration of the first periphery region EA1 of the display panel 110 corresponding to a sound vibration of the first periphery region EA1 of the rear cover part 310 is directly transferred to a listener or user. For example, the first piezoelectric vibration device 510 may be disposed at the first periphery region EA1 of the rear cover part 310 to overlap the panel supporting part 210 of the guide member 200 being configured to support the first periphery region EA1 of the display panel 110.

The first piezoelectric vibration device 510 according to an example embodiment of the present disclosure may be disposed at the horizontal region HA or the corner region CP of the rear cover part 310, with respect to a lengthwise direction (or a vertical direction) of the rear cover part 310 parallel to a second direction Y. For example, the first sound generating device 410 of the first vibration device 400 according to an example embodiment of the present disclosure may be disposed on the same line as the first piezoelectric vibration device 510, or may be disposed on or under the horizontal line (or the center horizontal line) parallel to the first direction X, with respect to the first direction X. In an example embodiment of the present disclosure, a center portion of the first sound generating device 410 may be disposed on the horizontal line (or the center horizontal line) extending from a center portion of the first piezoelectric vibration device 510 in parallel with the first direction X. In another example embodiment of the present disclosure, a center portion of the first sound generating device 410 may be disposed in the horizontal region HA with respect to the second direction Y. The center portion of the first sound generating device 410 may be disposed under or above the horizontal line (or the center horizontal line) instead of being on the horizontal line (or the center horizontal line) with respect to the second direction Y, so that a first sound S1 of a low pitched sound generated based on a vibration of the first middle region MA1 of the middle region MA of the display member 100 is directly transferred to a listener or user.

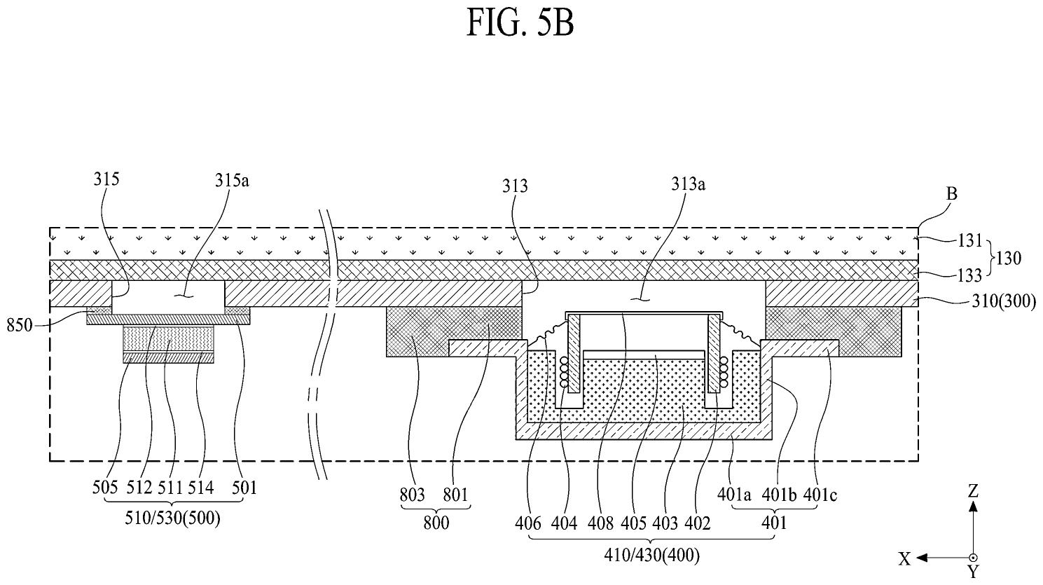

The first piezoelectric vibration device 510 according to an example embodiment of the present disclosure may include a first piezoelectric device 511 which is attached on a plate 501 by a first adhesive member 512, as illustrated, for example, in FIG. 5B.

The first piezoelectric device 511 may include a piezoelectric material layer having a piezoelectric effect.

The piezoelectric material layer may include a piezoelectric material which vibrates based on an electrical field. In this example, the piezoelectric material may have a characteristic where pressure or twisting is applied to a crystalline structure by an external force, a potential difference occurs due to dielectric polarization caused by a relative position change of a positive (+) ion (or cation) and a negative (−) ion (or anion), and a vibration is generated by an electrical field based on a voltage applied thereto.

The piezoelectric material layer according to an example embodiment of the present disclosure may include a polymer piezoelectric material, a thin-film piezoelectric material, a composite piezoelectric material, a single crystalline ceramic piezoelectric material, or a polycrystalline piezoelectric material. The polymer piezoelectric material according to an example embodiment of the present disclosure may include polyvinylidene fluoride (PVDF), poly(vinylidene fluoride-trifluoroethylene) (P(VDF-TrFe)), or poly(vinylidene fluoride-tetrafluoroethylene) (P(VDF-TeFE)). The thin-film piezoelectric material according to an example embodiment of the present disclosure may include ZnO, CdS, or AlN. The composite piezoelectric material according to an example embodiment of the present disclosure may include lead zirconate titanate (PZT)-PVDF, PZT-silicone rubber, PZT-epoxy, PZT-foam polymer, or PZT-foam urethane. The single crystalline ceramic piezoelectric material according to an example embodiment of the present disclosure may include aluminum phosphate (for example, berlinite and α-AlPO4), silicon dioxide (for example, α-SiO₂), lithium niobate (LiNbO₃), terbium molydbate (Tb₂(MoO₄)₃), lithium tetraborate (Li₂B₄O₇), or ZnO. The polycrystalline ceramic piezoelectric material according to an example embodiment of the present disclosure may include a PZT-based material, a PT-based material, a PZT-complex perovskite-based material, or barium titanate (BaTiO₃).

The first piezoelectric device 511 according to an example embodiment of the present disclosure may have a first length parallel to the first direction X and a second length parallel to the second direction Y. For example, the first length of the first piezoelectric device 511 may be shorter than the second length, but embodiments of the present disclosure are not limited thereto and may be longer than or equal to the second length.

The first adhesive member 512, as shown, for example, in FIG. 5B, may include a double-sided tape or a natural curable adhesive, but embodiments of the present disclosure are not limited thereto. For example, the first adhesive member 512 may include a thermal-curable adhesive or a UV-curable adhesive, but in this case, a characteristic of the first piezoelectric device 511 may be reduced because of heat occurring in a curing process of the first adhesive member 512.

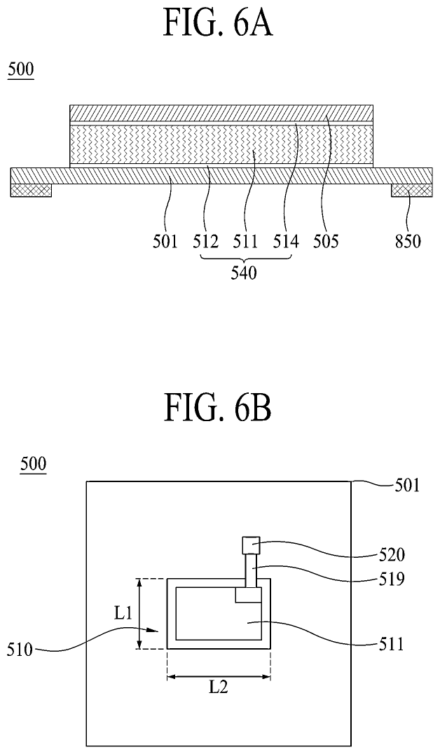

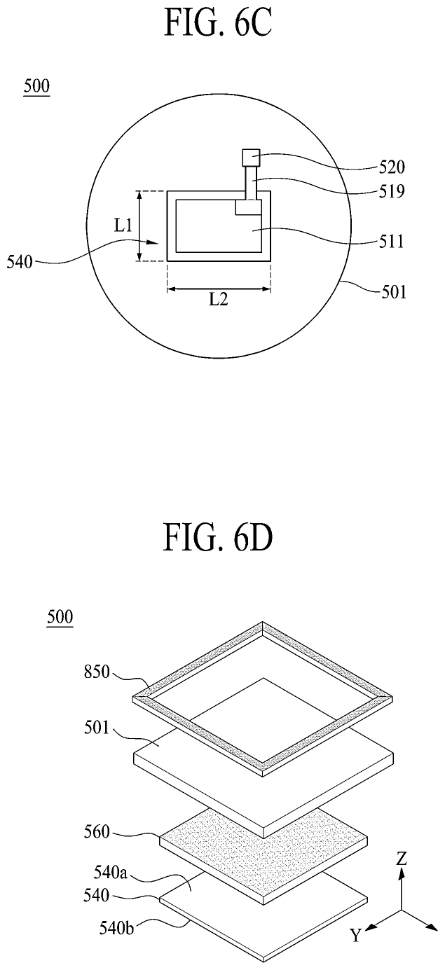

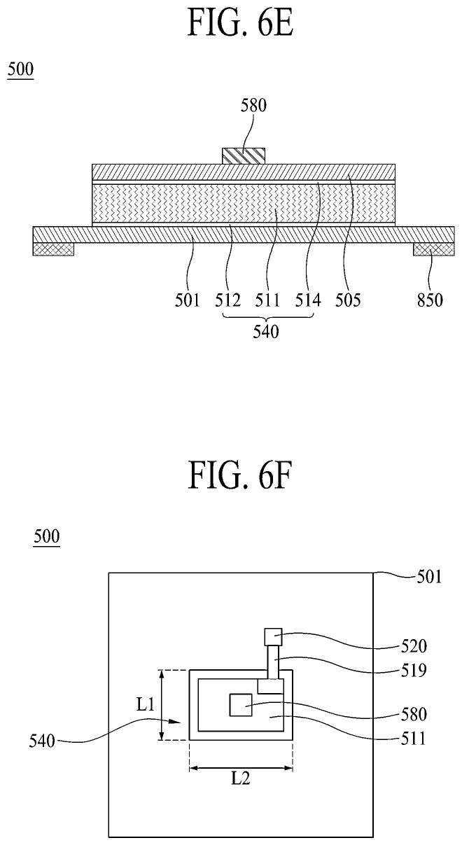

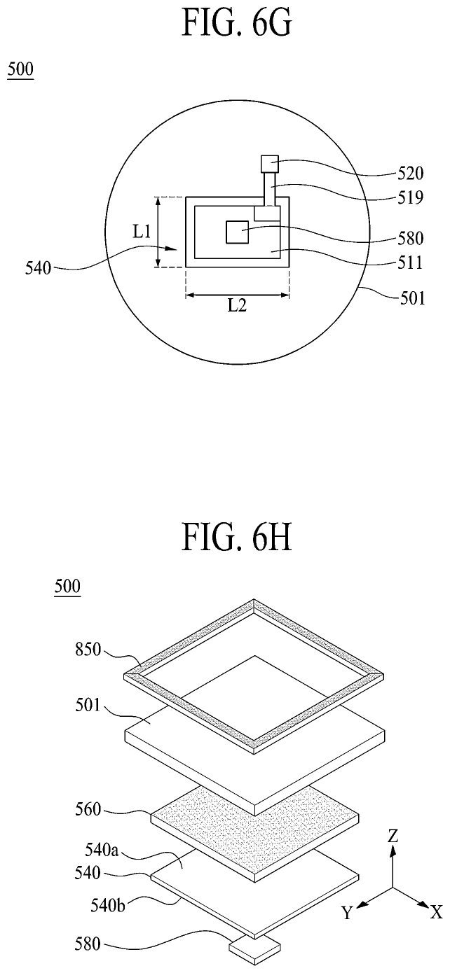

The first piezoelectric vibration device 510 according to an example embodiment of the present disclosure may further include a first protection member 513 which is attached on a front surface of the first piezoelectric device 511 and a second protection member 515 which is attached on a rear surface of the first piezoelectric device 511, as illustrated, for example, in FIGS. 6, 8, and 14. A first protection member 513 and a second protection member 515 may be sometimes referred to as a first cover member 513 and a second cover member 515, respectively.

A size of the first protection member 513 and a second protection member 515 may be formed to have a size which is wider than the first piezoelectric device 511 and may be attached on the front and rear surface of the first piezoelectric device 511. The first protection member 513 and the second protection member 515 may prevent the first piezoelectric device 511 from being damaged by a physical impact and/or an electrical impact such as static electricity. For example, the first piezoelectric device 511 may be damaged by static electricity which occurs in the display member 100 such as the panel driving circuit part or flows in from the outside, and moreover, may be damaged by a physical contact with the display member 100 caused by pressing of the display member 100. Therefore, the first protection member 513 may be disposed on the front surface of the first piezoelectric device 511 and the second protection member 515 may be disposed on the rear surface of the first piezoelectric device 511, and thus, may cut off or prevent static electricity transferred to the first piezoelectric device 511 through the display member 100 to protect the first piezoelectric device 511 and may protect the first piezoelectric device 511 from a physical impact which is applied from the display member 100 to the first piezoelectric device 511. The first protection member 513 and the second protection member 515 according to an example embodiment of the present disclosure may include a single-sided insulation tape, a double-sided insulation tape, a single-sided insulation foam tape, or a double-sided insulation foam tape having an adhesive layer attached on the front and rear surface, respectively, of the first piezoelectric device 511. The first protection member 513 and the second protection member 515 may include a polyethylene terephthalate (PET) or a polyvinyl chloride (PVC).

The second piezoelectric vibration device 530 may vibrate a second periphery region EA2 (or a right edge region or a right periphery region) of the periphery region EA of the display member 100 to output the second sound S2 of the second pitched sound band in the forward direction FD of the display panel 110. The second piezoelectric vibration device 530 may be disposed in the second periphery region (or a right edge region or a right periphery region) EA2 in the periphery region EA of the rear cover part 310. For example, the second piezoelectric vibration device 530 may be disposed in or coupled or connected to the rear cover part 310 to cover the second hole 315 among the second periphery region EA2 of the rear cover part 310.

In response to the sound signal, the second piezoelectric vibration device 530 according to an example embodiment of the present disclosure may vibrate the second periphery region EA2 of the rear cover part 310 to vibrate the second periphery region EA2 of the display panel 110, thereby generating the second sound S2 of the second pitched sound band in the second periphery region EA2 of the display panel 110. For example, when the second piezoelectric vibration device 530 vibrates based on the sound signal, a sound vibration generated in the second periphery region EA2 of the rear cover part 310 based on a vibration of the second piezoelectric vibration device 530 may be transferred to the second periphery region EA2 of the display panel 110 through the guide member 200 and the lateral cover part 330 of the rear cover 300, and the second sound S2 of the second pitched sound band generated based on a vibration of the second periphery region EA2 of the display panel 110 based on the sound vibration transferred through the guide member 200 may be output in the forward direction of the display panel 110. Accordingly, a sound wave generated based on a vibration of the second piezoelectric vibration device 530 may be directly transferred (or propagated) to the second periphery region EA2 of the display member 100 through the second hole 315, and thus, a sound pressure level characteristic and sound quality of the second sound S2 may be enhanced. In addition, a vibration of the second periphery region EA2 of the rear cover part 310 based on a vibration of the first piezoelectric vibration device 510 may be reduced, and thus, a sound pressure level characteristic and sound quality of the second sound S2 may be further enhanced.

The second piezoelectric vibration device 530 according to an example embodiment of the present disclosure may be disposed in the second periphery region EA2 of the rear cover part 310 or may be disposed at a different position so as to be symmetrical with the first piezoelectric vibration device 510, with respect to the center line CL of the display member 100.

Positions of the first piezoelectric vibration device 510 and the second piezoelectric vibration device 530 according to an example embodiment of the present disclosure may be adjusted based on implementation of a sound including a stereophonic sound or harmony with a sound based on vibrations of the first piezoelectric vibration device 510 and the second piezoelectric vibration device 530. For example, an arrangement position of each of the first piezoelectric vibration device 510 and the second piezoelectric vibration device 530 may be disposed to have a symmetrical structure or to be asymmetrical with the center line CL of the display member 100, with respect to the first direction X (or the widthwise direction) of the display member 100.

The second piezoelectric vibration device 530 according to an example embodiment of the present disclosure may include a second piezoelectric device which is attached on the plate 501 by a first adhesive member 512, as illustrated, for example, in FIG. 5B.

The second piezoelectric device may include a piezoelectric material layer having a piezoelectric effect. The second piezoelectric device may have substantially the same configuration (or structure) as that of the first piezoelectric device 511 of the first piezoelectric vibration device 510, and thus, its repeated description may be omitted for brevity.

The first adhesive member 512 may include a double-sided tape or a natural curable adhesive, but embodiments of the present disclosure are not limited thereto. For example, the first adhesive member 512 may include a thermal-curable adhesive or a UV-curable adhesive, but in this case, a characteristic of the second piezoelectric device may be reduced because of heat occurring in a curing process of the first adhesive member 512.

The second piezoelectric vibration device 530 according to an example embodiment of the present disclosure may further include a first protection member 513 which is attached on a front surface of the second piezoelectric device and a second protection member 515 which is attached on a rear surface of the second piezoelectric device.

A size of the first protection member 513 and the second protection member 515 may be formed to have a size which is wider than the second piezoelectric device and may be attached on the rear surface of the second piezoelectric device. The first protection member 513 and the second protection member 515 may prevent the second piezoelectric device from being damaged by a physical impact and/or an electrical impact such as static electricity. The first protection member 513 and the second protection member 515 may have substantially the same configuration (or structure) as that of the first protection member 513 and the second protection member 515 of the first piezoelectric device 511, and thus, its repeated description may be omitted for brevity.

The apparatus according to an example embodiment of the present disclosure may further include a system rear cover 600 disposed on the rear surface of the rear cover 300.

The system rear cover 600 may accommodate the display member 100 coupled or connected to each of the first and second vibration devices 400 and 500 and may surround a lateral surface of the display member 100. For example, the system rear cover 600 may be referred to as a set cover, a rear set cover, an uppermost set cover, a product cover, or an uppermost product cover, but the terms are not limited thereto.

The system rear cover 600 according to an example embodiment of the present disclosure may include a rear structure 610 and a lateral structure 630.

The rear structure 610 may be an outermost rear mechanism (or an outermost rear structure) disposed at a rear surface of the apparatus, and the rear structure 610 may support (or accommodate) the display member 100 and may cover the rear surface of the display member 100.

The lateral structure 630 may be an outermost lateral mechanism (or an outermost lateral structure) disposed at a lateral surface of the apparatus. The lateral structure 630 may be connected to an edge or a periphery of the rear structure 610 and may cover lateral surfaces of the display member 100.

FIG. 2C illustrates an example where an apparatus according to an example embodiment of the present disclosure is divided into a left region, a right region, and first to sixteenth regions 1 to 16.

Referring to FIG. 2C, the apparatus according to an example embodiment of the present disclosure may be laterally symmetrical with respect to a center line CL and may be divided into a left region LA and a right region RA. The left region LA may be divided into first to sixteenth regions 1 to 16 in a matrix sequence from a left uppermost end to a right lowermost end to have the same sixteen areas, and the right region RA may be divided into first to sixteenth regions 1 to 16 in a matrix sequence from a right uppermost end to a left lowermost.

The apparatus according to an example embodiment of the present disclosure may include a center region CA, a middle region MA comprising a first middle region MA1 and a second middle region MA2, and a periphery region EA comprising a first periphery region EA1 and a second periphery region EA2 in the first direction X. The center region CA may include a fourth area 4, a eighth area 8, a twelfth area 12, and a sixteenth area 16. The middle region MA may include a second area 2, a third area 3, a sixth area 6, a seventh area 7, a tenth area 10, an eleventh area 11, a fourteenth area 14, and a fifteenth area 15. The periphery region EA may include a first area 1, a fifth area 5, a ninth area 9, and a thirteenth area 13.

The apparatus according to an example embodiment of the present disclosure may includes a center region at a center of the rear cover, a periphery region at a periphery of the rear cover, and a middle region between the center region and the periphery region. For example, the center region may include an eighth area 8, and a twelfth area 12; the periphery region may include a first area 1, a second area 2, a third area 3, a fourth area 4, a fifth area 5, a ninth area 9, a tenth area 10, a thirteenth area 13, a fourteenth area 14, and a fifteenth area 15, and a sixteenth area 16; and the middle region may include a second area 2, a third area 3, a sixth area 6, a seventh area 7, a tenth area 10, and an eleventh area 11. In some example embodiments, the first vibration device may be disposed in one or more regions in the first to sixteenth regions close to the center of the rear cover. And, the second vibration device may be disposed in one or more regions in the first to sixteenth regions close to outside of the rear cover.

In addition, the apparatus according to an example embodiment of the present disclosure may includes a horizontal region HA and a corner region CP comprising a first corner region CP1 and a second corner region CP2 in the second direction Y. The horizontal region HA may include the fifth area to the eighth area, and the ninth area to the twelfth area. The first corner region CP1 may include the first area to the fourth area, and the second corner region CP2 may include the thirteenth area to the sixteenth area. The horizontal region HA is located between the first corner region CP1 and the second corner region CP2 in Y direction, as shown in FIG. 2C. So it is the portion of the apparatus extending from the left to the right lateral side in the middle portion.

According to an example embodiment of the present disclosure, a first vibration device 400 may include first and second sound generating devices 410 and 430, and for example, may be disposed at sixth, seventh, tenth, and eleventh regions of the rear cover 300.

According to an example embodiment of the present disclosure, a second vibration device 500 may include first and second sound piezoelectric vibration devices 510 and 530, and for example, may be disposed at first, fifth, ninth, and thirteenth regions of the rear cover 300.

According to an example embodiment of the present disclosure, in the second vibration device 500, when a half of a rear surface (half side) of a supporting member (or apparatus or rear cover 300) is divided into, for example, 16 equal parts (or 4×4) with respect to a horizontal direction, the second vibration device 500 may be disposed in at least one or more of a first region 1 and a thirteenth region 13 within a first region to a sixteenth region 1-16, and it may be disposed on the side or the portion adjacent to a corner periphery (or corner) of the support member. In this example, the corner periphery may include a corner region CP.

When the second vibration device 500 is disposed at the periphery of the rear cover 300, the periphery of the rear cover 300 may be secured (or utilized) as a transmission path of the high pitched sound (or high frequency sound wave HSW) generated by the second vibration device 500, and the high-pitched sound generated by the second vibration device 500 may be radiated, and thus, the high-pitched sound characteristics of the device may be improved. In this example, the periphery may include the periphery region EA.

According to an example embodiment of the present disclosure, the second vibration device 500 may be configured to vibrate a corner of the display module (or vibration member). For example, when the half side of the rear surface of the supporting member (or device) is divided into 16 equal parts, the second vibration device 500 is disposed in at least one or more of the first region 1 and the thirteenth region 13 among the first to sixteenth regions 1-16.

According to an example embodiment of the present disclosure, the first vibration device 400 may be disposed in any one of a sixth region 6 and a tenth region 10 among the first to sixteenth regions 1-16. Alternatively, the first vibration device 400 may be disposed in any one of the seventh region 7 and the eleventh region 11 among the first to sixteenth regions 1-16.

According to an example embodiment of the present disclosure, when the rear surface of the supporting member (or device) is bisected in the longitudinal direction (X direction), the first rear region may be a region that overlaps with a central portion excluding the periphery of the bisected supporting member (or vibration member). In this example, the central portion may include the center region CA and the middle region MA.

According to an example embodiment of the present disclosure, the first rear region may be disposed at an upper end side (or an upper portion) of the central portion.

According to an example embodiment of the present disclosure, the first rear region may be disposed at a periphery of the central portion, and the periphery may be a side adjacent to a short side of the support member (or vibration member).

According to an example embodiment of the present disclosure, the first vibration device 400 may be disposed at a region or portion that does not overlap with the horizontal and diagonal directions of the vibration plate or the vibration member with respect to the horizontal and diagonal directions of the vibration plate or the vibration member. In one or more examples, the first vibration device 400 may be disposed at a region or portion that does not overlap with the vertical and diagonal directions of the vibration plate or the vibration member with respect to the vertical and diagonal directions of the vibration plate or the vibration member. In this example, the horizontal direction may be a line crossing the central portion of the horizontal area HA, the vertical direction may be the center line CL, and the diagonal direction is one of the lines connecting two diagonally facing vertices.

According to an example embodiment of the present disclosure, the first vibration device 400 may be disposed at a region or a portion that does not overlap a horizontal direction, a vertical direction, and a diagonal direction with respect to the horizontal direction, the vertical direction, and the diagonal direction of the vibration plate (e.g., display module) or the vibration member. For example, the first vibration device 400 may not be disposed at the same row or the same column as the second vibration device 500. For example, the first vibration device 400 may not be disposed in the same horizontal or vertical direction as that of the second vibration device 500. For example, the first vibration device 400 may be disposed at an oblique or diagonal direction to the second vibration device 500. For example, the first vibration device 400 may be disposed on the same line as the second vibration device 500 in an oblique or diagonal direction.

For example, the central portion of the first vibration device 400 and the central portion of the second vibration device 500 may be disposed at an oblique or diagonal line between a horizontal line in a horizontal direction and a vertical line in a vertical direction. In this example, the same row and the same column may be the same row or column in the first direction or the second direction in the vibrating member including the first to sixteenth regions.

According to an example embodiment of the present disclosure, the second vibration device 500 may be disposed at a position where the deviation of the amount of bending of the support member (e.g., cover bottom) is smaller. For example, the deviation of the amount of bending of the area overlapping the corner region CP among the periphery area EA may be smaller than the deviation of the amount of bending of the area not overlapping the corner region CP among the periphery area EA. For example, an area overlapping the corner area CP among the edge areas EA may include the first area 1 or the thirteenth area 13, and the corner area (CP) and the non-overlapping region among the edge areas EA may include a fifth region 5 or a ninth region 9. Accordingly, the second vibration device 500 may be disposed at the first region 1 or the thirteenth region 13. FIG. 5A illustrates an example of a region B of FIG. 3, and FIG. 5B illustrates another example of a region B of FIG. 3. FIGS. 5A and 5B are examples of an enlarged view of the region B illustrated in FIG. 3.The drawings illustrate in detail one or more examples of a structure of the first and second vibration devices in the apparatus illustrated in FIG. 3. In the following description, therefore, only each of the first and second vibration devices will be described in detail, the other elements are referred to by the same reference numerals as FIG. 3, and their repeated descriptions may be omitted or may be briefly given.

Referring to FIG. 5A, an apparatus according to an example embodiment may include a first sound generating device 410 and a second sound generating device 430 disposed at a rear cover 300.

An apparatus according to an example embodiment may include a vibration plate and a first vibration device 400 at a rear surface of the vibration plate. A first vibration device 400 according to an example embodiment of the present disclosure may include a first sound generating device 410 and a second sound generating device 430. For example, the first vibration device 400 may be a coil type vibration device.

Each of the first sound generating device 410 and the second sound generating device 430 may be supported by a rear cover part 310 of a rear cover 300 to cover a first hole 313 in the rear cover part 310. Each of the first sound generating device 410 and the second sound generating device 430 may vibrate based on a sound signal to vibrate a middle region MA of a display member 100, thereby generating a first sound S1 in the middle region MA of the display member 100. For example, each of the first sound generating device 410 and the second sound generating device 430 may vibrate based on the sound signal to generate a sound wave, the sound wave may pass through the first hole 313 and may be transferred (or propagated) to the display member 100, and the middle region MA of the display member 100 may vibrate based on the sound wave transferred through the first hole 313, whereby a first sound S1 may be output in a forward direction FD of the display member 100 at the middle region MA of the display member 100.

According to an example embodiment of the present disclosure, the first hole 313 may act as a sound wave propagation path (or a sound energy incident portion) through which a sound wave (or a sound) generated based on a vibration of each of the first sound generating device 410 and the second sound generating device 430 is directly propagated (or incident) to a rear surface of the display member 100.

According to an example embodiment of the present disclosure, each of the first sound generating device 410 and the second sound generating device 430 may not vibrate the rear cover part 310 and may independently vibrate, and thus, may directly vibrate the middle region MA of the display member 100 without using the rear cover part 310 as a vibration plate and may minimize a vibration of the rear cover part 310 to generate a stable sound pressure level, thereby minimizing the occurrence of noise caused by the vibration of the rear cover part 310.

Each of the first sound generating device 410 and the second sound generating device 430 according to an example embodiment of the present disclosure may include a module frame 401, a bobbin 402, a magnet member 403, a coil 404, a center pole 405, and a damper 406. For example, in each of the first sound generating device 410 and the second sound generating device 430, the module frame 401 may be referred to as a fixing portion which is fixed to the rear cover 300. For example, in each of the first sound generating device 410 and the second sound generating device 430, the bobbin 402, the magnet member 403, the coil 404, the center pole 405, and the damper 406 may be referred to as a vibration portion configured to vibrate the display member 100, but the terms are not limited thereto.

The module frame 401 may be supported by the rear cover part 310. The module frame 401 according to an example embodiment of the present disclosure may include a frame body 401a, an upper plate 401b, and a fixing bracket 401c. According to an example embodiment of the present disclosure, the first vibration device 400 may have a quadrilateral shape, an oval shape, or a circular shape, but embodiments of the present disclosure are not limited thereto. According to an example embodiment of the present disclosure, the module frame 401 may have a quadrilateral shape, an oval shape, or a circular shape, but embodiments of the present disclosure are not limited thereto.

The frame body 401a may be fixed to the rear cover part 310. The frame body 401a may perform a function of a lower plate which supports the magnet member 403.

The upper plate 401b may be disposed at a front edge or a front periphery of the frame body 401a to have a cylindrical shape including a hollow portion. The hollow portion of the upper plate 401b may have a cylindrical structure, but embodiments of the present disclosure are not limited thereto. For example, the hollow portion of the upper plate 401b may have a circular shape or an oval shape. The frame body 401a and the upper plate 401b may be implemented as one body having a U-shape. For example, the frame body 401a and the upper plate 401b are not limited to these terms and may be referred to as other terms such as a yoke. The frame body 401a and the upper plate 401b may have a size corresponding to the first hole 313 in the rear cover part 310 of the rear cover 300.

The fixing bracket 401c may protrude from a lateral surface of the upper plate 40 lb. The fixing bracket 401c may be fixed to the rear cover part 310 by a second coupling member 800, and thus, the module frame 401 may be fixed to the rear cover part 310. The second coupling member 800 may be disposed between the fixing bracket 401c and the rear cover 300. The second coupling member 800 may be connected to the rear cover 300 by the fixing bracket 401c. For example, the second coupling member 800 may be a double-sided tape or a double-sided adhesive pad. For example, the second coupling member 800 may be a screw or a bolt.

The bobbin 402 may be disposed on the module frame 401 so that a portion of an uppermost portion thereof is inserted or accommodated into the first hole 313. The bobbin 402 may vibrate (for example, performs a vertical reciprocating motion) based on a magnetic force in a region 313a overlapping the first hole 313 of the rear cover part 310 to generate a sound pressure level in the region 313a overlapping the first hole 313 of the rear cover part 310. The bobbin 402 may vibrate or perform a vertical reciprocating motion based on a magnetic force, and thus, the bobbin 402 may vibrate the vibration member (or vibration plate) adjacent to to the first hole 313 disposed at the supporting member or the rear cover part 310.

The bobbin 402 according to an example embodiment of the present disclosure may be disposed on the module frame 401 and may be configured to vibrate the rear cover part 310. The bobbin 402 according to an example embodiment of the present disclosure may be configured to have a hollow portion and connected or coupled to a rear surface of the rear cover 300. For example, the bobbin 402 may be implemented with an annular structure which includes at least one or more of material formed by paper or pulp, aluminium, magnesium and alloy thereof, synthetic resin including polypropylene or the like, and fiber including polyamide, but embodiments of the present disclosure are not limited thereto.

The bobbin 402 according to an example embodiment of the present disclosure may have a circular shape or an ellipse or oval shape, but embodiments of the present disclosure are not limited thereto. The oval shape of the bobbin 402 may have an elliptical shape, a rectangular shape with rounded corners, or a non-circular curved shape having a width different from its height, but embodiments of the present disclosure are not limited thereto. For example, when a bobbin is of an oval shape, a ratio of a long-axis diameter to a short-axis diameter may be set to 1.3:1 to 2:1. The bobbin of the oval shape may further improve a sound of a high-pitched sound band than a circular shape and may decrease the occurrence of heat caused by a vibration, and thus, may have an excellent heat dissipation characteristic.

The magnet member 403 may be disposed on the module frame 401 so as to be accommodated into the hollow portion of the bobbin 402. For example, the magnet member 403 may be accommodated or inserted into the hollow portion of the bobbin 402. For example, the magnetic member 403 may be a permanent magnet. The magnetic member 403 may be implemented, e.g., with a material such as barium ferrite, and a material of the magnetic member 403 may be formed of ferric oxide (Fe₂O₃), barium carbonate (BaCO₃), neodymium (Nd) magnet, strontium ferrite with improved magnetism, or alloy-casting magnet of aluminum (Al), nickel (Ni), cobalt (Co), and/or the like, but embodiments of the present disclosure are not limited thereto. For example, the neodymium magnet may be neodymium-iron-boron (Nd—Fe—B), but embodiments of the present disclosure are not limited to these examples.

The coil 404 may be wound to surround a lower outer perimeter surface of the bobbin 402 and may be supplied with a sound signal (or a voice signal) from the outside. The coil 404 may be elevated together with the bobbin 402. If a sound signal (or current) is applied to the coil 404, the bobbin 402 may be vibrated, e.g., may be reciprocally moved in an up-and-down direction in accordance with Fleming's left-hand rule for motors, based on an applied magnetic field formed around the coil 404 and an external magnetic field formed around the magnetic member 403. The coil 404 may be referred to as a voice coil, but embodiments of the present disclosure are not limited thereto.

The center pole 405 may be disposed on the magnet member 403 and may guide a vibration of the bobbin 402. For example, when the center pole 405 is inserted or accommodated into the hollow portion of the bobbin 402, the center pole 405 may be surrounded by the bobbin 402. The center pole 405 may be referred to as an elevating guider or a pole piece, but embodiments of the present disclosure are not limited thereto.

The damper 406 may be disposed between the module frame 401 and the bobbin 402. The damper 406 according to an example embodiment of the present disclosure may be between the frame body 401a of the module frame 401 and an upper circumferential surface of the bobbin 402. The damper 406 may have a wrinkled structure between its two ends, and the damper 406 may contract and/or relax in accordance with the vibration of the bobbin 402. The damper 406 may control the vibration distance of the bobbin 402. For example, if the bobbin 402 vibrates to be higher or lower than a particular distance, the bobbin 402 may be restored to its original position by the restoring force of the damper 406. The damper 406 may be referred to as a “spider,” “suspension,” or “edge.” Each of the magnet member 403, the coil 404, the center pole 405, and the damper 406 is disposed to overlap only the first hole 313 without overlapping the rear cover part 310.

The first vibration device 400 according to another example embodiment of the present disclosure has a relatively thin thickness so as not to increase the thickness of the apparatus, and thereby, when the height (or thickness) of the bobbin 402 is decreased, this can cause a problem where the sound pressure may be lowered. Accordingly, in order to solve the problem that the sound pressure is lowered due to the decreased height of the bobbin 402, a structure for increasing the area of the damper 406 disposed around the bobbin 402 may be included. When the area of the damper 406 is increased, the arrangement space of a wiring or a line for applying the current to the coil 404 becomes narrow, so that interference between the wiring and the damper 406 may occur.

According to another example embodiment of the present disclosure, the damper 406 may be configured as a conductor in which the damper 406 can function as a wiring at the same time, and the damper 406 may include a metal material electrically connected to the coil 404. For example, the damper 406 may be formed of stainless steel or copper (Cu), but embodiments are not limited thereto. According to an example embodiment of the present disclosure, the shape of the damper 406 may be configured in a zigzag shape. When the damper 406 is configured diagonally, disconnection of the damper may occur due to a vertical motion of the damper 406, and when a length of the damper 406 is long, the damper 406 may affect a resonance frequency. For example, the overlapping portion between the damper 406 and the module frame 401 may be configured to have the same thickness and different widths, and disconnection may be avoided or prevented from occurring in an overlapping portion therebetween.

The first vibration device 400 according to an example embodiment of the present disclosure may be referred to as an “internal” type in which the magnetic member 403 may be inserted or accommodated into the hollow portion of the bobbin 402. Alternatively, the first vibration device 400 according to another example embodiment of the present disclosure may be an external type (or dynamic type) in which the magnetic member 403 may surround the circumferential surface of the bobbin 402. In the first vibration device 400 of the external type, the magnetic member 403 may be between the frame body 401a and the upper plate 401b, and the center pole 405 may be inserted into the hollow portion of the bobbin 402, or may be on the frame body 401a or lower plate, except for these structures, the external type may be substantially the same as the internal type.

The second coupling member 800 may be disposed between the fixing bracket 401c of the module frame 401 and the rear cover part 310 near the first hole 313 and may couple or fix the first sound generating device 410 and the second sound generating device 430 to the rear cover 300. The second coupling member 800 may include a double-sided tape, a single-sided tape, a single-sided foam tape, a double-sided foam tape, a single-sided foam pad, or a double-sided foam pad, including an adhesive layer. The adhesive layer of the second coupling member 800 according to an example embodiment of the present disclosure may include an acrylic-based or urethane-based adhesive material. For example, the adhesive layer of the second coupling member 800 may include the urethane-based adhesive material, having a characteristic where hardness is relatively higher than the acrylic-based adhesive material and having a relatively ductile characteristic in comparison to the acrylic-based adhesive material, so as to minimize the transfer of a vibration of each of the first sound generating device 410 and the second sound generating device 430 to the rear cover part 310, but embodiments of the present disclosure are not limited thereto. Accordingly, the first vibration device 400 may be connected to the vibration member or the display member 100 by the second coupling member 800. In another example embodiment, the first vibration device 400 may be connected to the rear cover part 310 by the second coupling member 800.

The second coupling member (or a second connection member) 800 according to an example embodiment of the present disclosure may have a first thickness T1 of the rear cover part 310 of the rear cover 300, and for example, may have a second thickness T2 which is thicker than the first thickness T1 of the rear cover part 310. The second thickness T2 of the second coupling member 800 according to an example embodiment of the present disclosure may be one to four times the first thickness Ti of the rear cover part 310. For example, when the second thickness T2 of the second coupling member 800 is less than one times the first thickness T1 of the rear cover part 310, a distance (or an interval) between a rearmost surface of the display member 100 and the bobbin 402 may be relatively short, and thus, the bobbin 402 vibrating in a thickness direction Z of the display member 100 may pass through the first hole 313 and may physically contact the rearmost surface of the display member 100, whereby the bobbin 402 may be damaged. On the other hand, when the second thickness T2 of the second coupling member 800 is more than four times the first thickness T1 of the rear cover part 310, the distance (or the interval) between the rearmost surface of the display member 100 and the bobbin 402 may be relatively long, and thus, the transmission loss (or transfer loss) of a sound wave of the high pitched sound band proportional to a distance may increase, whereby a sound of the middle-high pitched sound band may not be realized or a sound pressure level of the middle-high pitched sound band may be reduced and a sound separation phenomenon between a sound of the middle-high pitched sound band generated by the first vibration device 400 and a sound of the middle-low pitched sound band generated by the second vibration device 500 may occur. Accordingly, the second thickness T2 of the second coupling member 800 may be adjusted to be one to four times the first thickness T1 of the rear cover part 310, so that the bobbin 402 does not physically contact the rearmost surface of the display member 100, stably vibrates in the first hole 313, and generates a sound of the middle-high pitched sound band and a sound pressure level of the middle-high pitched sound band.

According to another example embodiment of the present disclosure, the second coupling member 800 may include a mechanical structure, and the second coupling member 800 may include at least one of screw or bolt which passes through the fixing bracket 401c and connected to the rear cover part 310. In this embodiment, a buffer ring is provided between the rear cover part 310 and the fixing bracket 401c, and the buffer ring may prevent the vibration of the rear cover part 310 caused by the vibration of the first vibration device 400 from being transmitted to the module frame 401.

Each of the first sound generating device 410 and the second sound generating device 430 according to an example embodiment of the present disclosure may further include a bobbin protection member (or a protection member) 408 disposed on the bobbin 402. For example, the bobbin protection member 408 may be disposed between the bobbin 402 and the rear cover 300.

The bobbin protection member 408 according to an example embodiment of the present disclosure may be formed in a cylindrical structure including an opening portion overlapping the hollow portion of the bobbin 402 and may be coupled or connected to an upper surface of the bobbin 402. The bobbin protection member 408 according to an example embodiment of the present disclosure may cover the upper surface of the bobbin 402 to protect the bobbin 402, thereby preventing the deformation of the bobbin 402 caused by an external impact.

The bobbin protection member 408 according to an example embodiment of the present disclosure may be formed in a plate structure covering a whole upper surface and the hollow portion of the bobbin 402 and may be coupled to an upper surface of the bobbin 402. The bobbin protection member 408 according to another example embodiment of the present disclosure may cover the whole upper surface of the bobbin 402 to protect the bobbin 402, and thus, may prevent the deformation of the bobbin 402 caused by an external impact. In addition, the bobbin protection member 408 may be formed in a plate structure on the bobbin 402 and may increase a sound pressure level generated based on a vibration of the bobbin 402.

The bobbin protection member 408 according to an example embodiment of the present disclosure may be connected or coupled to the bobbin 402 by at least one of a single sided tape, a double sided tape, a single sided foam tape, a double sided foam tape, a single sided foam pad, a double sided foam pad, or an adhesive resin. For example, the adhesive resin may be an epoxy resin or acrylic resin, but embodiments of the present disclosure are not limited thereto.

Therefore, each of the first sound generating device 410 and the second sound generating device 430 according to an example embodiment of the present disclosure may independently vibrate without using the rear cover part 310 as a vibration plate, and thus, may generate a sound wave (or a sound) which passes through the first hole 313 and directly vibrates the display member 100 and may minimize a vibration of the rear cover part 310 to generate a stable sound pressure level, thereby minimizing the occurrence of noise caused by the vibration of the rear cover part 310.

Referring to FIGS. 1, 2A, and 3, a second vibration device 500 according to another example embodiment of the present disclosure may include first and second piezoelectric vibration devices 510 and 530.

Each of the first and second piezoelectric vibration devices 510 and 530 may be supported by a rear cover part 310 of a rear cover 300 to cover a second hole 315 in the rear cover part 310. Each of the first and second piezoelectric vibration devices 510 and 530 may vibrate based on a sound signal to vibrate a periphery region EA of a display member 100, thereby generating a second sound S2 in the periphery region EA of the display member 100. For example, each of the first and second piezoelectric vibration devices 510 and 530 may vibrate based on the sound signal to generate a sound wave, the sound wave may pass through the second hole 315 and may be transferred (or propagated) to the display member 100, and the periphery region EA of the display member 100 may vibrate based on the sound wave transferred through the second hole 315, whereby a second sound S2 may be output in a forward direction FD of the display member 100 at the periphery region EA of the display member 100.

According to an example embodiment of the present disclosure, the second hole 315 may act as a sound wave propagation path (or a sound energy incident portion) through which a sound wave (or a sound) generated based on a vibration of each of the first and second piezoelectric vibration devices 510 and 530 is directly propagated (or incident) to a rear surface of the display member 100.

According to an example embodiment of the present disclosure, each of the first and second piezoelectric vibration devices 510 and 530 may not vibrate the rear cover part 310 and may independently (or autonomously or individually) vibrate, and thus, may directly vibrate the periphery region EA of the display member 100 without using the rear cover part 310 as a vibration plate and may minimize a vibration of the rear cover part 310 to generate a stable sound pressure level, thereby minimizing the occurrence of noise caused by the vibration of the rear cover part 310.

Each of the first and second piezoelectric vibration devices 510 and 530 according to an example embodiment of the present disclosure may include a plate 501 and a piezoelectric device 511.

The plate 501 may be coupled or connected to the rear cover part 310 of the rear cover 300 by a third coupling member (a third connection member) 850, which is illustrated, for example, in FIG. 5B. For example, the first and second piezoelectric vibration devices 510 and 530 are connected to the plate 501 by the first adhesive member 512. The plate 501 may cover the second hole 315 formed in the rear cover part 310. For example, the plate 501 may have a size which is greater than a size of the second hole 315. For example, the plate 501 may be a base plate, a first plate, a supporting plate, a vibration object, or a connection plate, but embodiments of the present disclosure are not limited thereto. The plate 501 may include one or more of a metal, a paper, and a polymer film, but embodiments of the present disclosure are not limited thereto. The plate 501 may have at least one of a circular shape, an oval shape, a rectangle shape, or a square shape, but embodiments of the present disclosure are not limited thereto. When the base plate 501 has a quadrilateral shape including a rectangle shape or a square shape, a first side and a second side orthogonal to the first side of the base plate 501 may be equal to, smaller than, or lager than each other.

The plate 501 may be used as a vibration plate which generates a sound pressure level in the second hole 315. The plate 501 according to an example embodiment of the present disclosure may include at least one or more of a paper, a fiber, a fabric, a leather, a plastic, a metal, a stainless steel, aluminium (Al), magnesium (Mg), a Mg alloy, a magnesium and lithium alloy (Mg—Li alloy), and an aluminium (Al) alloy, but embodiments of the present disclosure are not limited thereto. For example, the plate 501 may have a third thickness T3 which is thinner than the first thickness T1 of the rear cover part 310, so as to generate a sound of the middle-high pitched sound band. When the third thickness T3 of the plate 501 is thicker than the first thickness T1, a vibration of the piezoelectric device 511 may be difficult to propagate (or transfer) to an inner portion of the second hole 313. The plate 501 may vibrate based on a vibration of the piezoelectric device 511 to generate a sound (or a sound pressure level) of the middle-high pitched sound band of 3 kHz or more, and the sound may be propagated or transferred to the inner portion of the second hole 315.

The third coupling member 850, which is illustrated, for example, in FIG. 5B, may be disposed (or interposed) between the plate 501 and the rear cover part 310 near the second hole 315 and may couple or fix the first and second piezoelectric vibration devices 510 and 530 to the rear cover part 310 (or the rear cover 300). For example, the third coupling member 850 may be configured to have a quadrilateral band shape. The third coupling member 850 may include at least one of a double-sided tape, a single-sided tape, a double-sided foam tape, a single-sided foam tape, a double-sided foam pad, or a single-sided foam pad including an adhesive layer. The adhesive layer of the third coupling member 850 according to an example embodiment of the present disclosure may include an acrylic-based or urethane-based adhesive material. For example, the adhesive layer of the third coupling member 850 may include the urethane-based adhesive material, having a characteristic where hardness is relatively higher than the acrylic-based adhesive material and having a relatively ductile characteristic compared to the acrylic-based adhesive material, so as to minimize the transfer of a vibration of each of the first and second piezoelectric vibration devices 510 and 530 to the rear cover part 310, but embodiments of the present disclosure are not limited thereto.

For example, the third coupling member 850 and the first adhesive member 512 may have a different modulus (or adhesive force or hardness). For example, the third coupling member 850 may have a modulus (or adhesive force or hardness) which is greater than a modulus of the first adhesive member 512.

The piezoelectric device 511 may be disposed at the plate 501 and may vibrate the plate 501. The piezoelectric device 511 may be disposed at a rear surface of the plate 501 to overlap the second hole 315 of the rear cover part 310. For example, the piezoelectric device 511 may be coupled or connected to the plate 501 by a first adhesive member 512.

The piezoelectric device 511 according to an example embodiment of the present disclosure may have a size which is less than that of the second hole 315, so as to be disposed at a region 315a overlapping the second hole 315 of the rear cover part 310. For example, a center portion of the piezoelectric device 511 may be disposed at a center portion of the second hole 315. For example, a center portion of the piezoelectric device 511 may be disposed at the center portion of the second hole 315.

The first adhesive member 512, as illustrated, for example, in FIG. 5B, may include a double-sided tape or a natural curable adhesive, but embodiments of the present disclosure are not limited thereto. For example, the first adhesive member 512 may include a thermal-curable adhesive or a UV-curable adhesive, but in this case, a characteristic of the piezoelectric device 511 may be reduced because of heat occurring in a curing process of the first adhesive member 512.

Each of the first and second piezoelectric vibration devices 510 and 530 according to an example embodiment of the present disclosure may further include a cover plate 505 as illustrated, for example, in FIG. 5B.

Referring to FIGS. 3 and 5B, the cover plate 505 may be coupled or connected to a rear surface of the piezoelectric device 511 by a second adhesive member 514. The cover plate 505 may cover the rear surface of the piezoelectric device 511 to protect the piezoelectric device 511. In addition, the cover plate 505 may reinforce or increase a mass of the first and second piezoelectric vibration devices 510 and 530 to decrease a resonance frequency of the first and second piezoelectric vibration devices 510 and 530 based on an increase in mass, thereby increasing a sound pressure level characteristic of the low pitched sound band of the first and second piezoelectric vibration devices 510 and 530. The cover plate 505 according to an example embodiment of the present disclosure may have the same material and thickness as those of the plate 501. However, embodiments of the present disclosure are not limited thereto, and the cover plate 505 may have a material or a thickness which differs from that of the plate 501, based on a sound characteristic needed for the first and second piezoelectric vibration devices 510 and 530. For example, the cover plate 505 may be a plate, a second plate, a mass plate, a protection plate, a reinforce plate, or a resonance control plate, but embodiments of the present disclosure are not limited thereto.

The second adhesive member 514 may include a double-sided tape or a natural curable adhesive, but embodiments of the present disclosure are not limited thereto. For example, the second adhesive member 514 may include a thermal-curable adhesive or a UV-curable adhesive, but in this case, a characteristic of the piezoelectric device 511 may be reduced because of heat occurring in a curing process of the second adhesive member 514.

Therefore, the apparatus according to an example embodiment of the present disclosure may have the same effect as that of the apparatus illustrated in FIGS. 2A to 4. In addition, in the apparatus according to an example embodiment of the present disclosure, the display member 100 may vibrate based on a sound wave, which is generated based on a vibration of each of the first vibration device 400 and the second vibration device 500 and passes through the first and second rear cover holes 313 and 315, to output sounds S1 and S2, and thus, may vibrate based on a vibration of the display member 100 to output the sounds S1 and S2 without using the rear cover 300 as a vibration plate. Accordingly, a vibration of the rear cover part 310 may be minimized, and thus, the occurrence of noise caused by the vibration of the rear cover part 310 may be prevented or minimized.

Referring to FIG. 5B, the vibration device 500 according to an example embodiment of the present disclosure may include a vibration device 400 and second vibration device 500 at a rear surface of the rear cover 300. The apparatus comprising the second vibration device 500 illustrated in FIG. 5B, may have substantially the same structures as those of the apparatus illustrated in FIG. 5A, except that the structure of the second coupling member 800 is different, and thus, the repeated description of substantially the same structures may be omitted for brevity.

The second coupling member 800 may include a structure surrounding the first vibration device 400. The second coupling member 800 may include a first part 801 that overlaps with the fixing bracket 401c, and a second part 803 that laterally protrudes from the fixing bracket 401c and surrounds the first vibration device 400. A second surface of the second part 803 of the second coupling member 800 may be connected or coupled to the rear cover part 310. A first surface of the second part 803 of the second coupling member 800 may be disposed on the same plane as the first surface of the fixing bracket 401c, but embodiments of the present disclosure are not limited thereto. The first vibration device 400 may be connected or coupled to the rear cover part 310 by the first part 801 and the second part 803 of the second coupling member 800, and thus, an adhesive area or fixing region may be increased compared to the first vibration device 400 of FIG. 5A. For example, the first part 801 and the second part 803 of the second coupling member 800 may have the same material, or may have different materials. For example, the first part 801 and the second part 803 of the second coupling member 800 may have the same modulus (or adhesive force or hardness), or may have a different modulus (or adhesive force or hardness).

The first part 801 of the second coupling member 800 may be referred to as a coupling member, a connection member, an adhesive member, or the like. The second part 803 of the second coupling member 800 may be referred to as an outer ring support, a lateral ring support, a ring support, an exciter support, or the like.

The second coupling member 800 comprising the first part and second part 803 may include at least one of a double-sided tape, a single-sided tape, a double-sided foam tape, a single-sided foam tape, a double-sided foam pad, and a single-sided foam pad.

FIG. 6A is a cross-sectional view of a second vibration device according to an example embodiment of the present disclosure.

Referring to FIG. 6A, the second vibration device 500 according to an example embodiment of the present disclosure may include a vibration generator 540, a base plate (or a plate) 501, a cover plate 505, and a third adhesive member 850. The vibration generator 540 in FIG. 6A may have a structure comprising a vibration device 511, a first adhesive member 512, and a second adhesive member 514. However, the structure of the vibration generator 540 is not limited thereto, and may be defined as a structure further including a first cover member 513 and a second cover member 515 described later in FIG. 8.

The vibration generator 540 may be configured to vibrate (or displace or drive) based on a driving signal (or an electrical signal or a voice signal) applied thereto to vibrate (or displace or drive) a vibration member 100. For example, the vibration generator 540 may be referred to as a vibration device, a vibration structure, a vibrator, a vibration generating device, a sound generator, a sound device, a sound generating structure, or a sound generating device, but embodiments of the present disclosure are not limited thereto.

The vibration generator 540 according to an example embodiment of the present disclosure may include a piezoelectric material (or an electroactive material) having a piezoelectric characteristic. The vibration generator 540 may autonomously vibrate (or displace or drive) based on a vibration (or a displacement or drive) of a piezoelectric material generated by the driving signal applied thereto, or may vibrate (or displace) the vibration member. For example, the vibration generator 540 may vibrate (or displace) as contraction and/or expansion are alternately repeated by a piezoelectric effect (or a piezoelectric characteristic). For example, the vibration generator 540 may vibrate (or displace or drive) in a vertical direction (or a thickness direction) Z as contraction and/or expansion are alternately repeated by an inverse piezoelectric effect.

The vibration generator 540 may be configured to have flexibility. For example, the vibration generator 540 may be configured to be bent in a non-planar shape including a curved surface.

The vibration generator 540 according to an example embodiment of the present disclosure may include a tetragonal shape which has a first length parallel to a first direction X and a second length parallel to a second direction Y intersecting with the first direction X. For example, the vibration generator 540 may include a square shape where the first length is the same as the second length, or may include a rectangular shape where the first length differs from the second length.

The base plate 501 may be connected to or attached on the first adhesive member 512. For example, the base plate 501 may have a size or an area which is greater than that of the vibration generator 540. For example, a center portion of the base plate 501 may be aligned or positioned at a center portion of the vibration generator 540. The base plate 501 may be coupled to or attached on the rear cover part 310. For example, the base plate 501 may be substantially the same as the base plate 501 described above with reference to FIG. 5A, and thus, same reference numerals refer to same elements and their repeated descriptions may be omitted for brevity.

The cover plate 505 may be coupled or connected to a rear surface of the piezoelectric device 511 by a second adhesive member 514. The cover plate 505 may cover the rear surface of the piezoelectric device 511 to protect the piezoelectric device 511. In addition, the cover plate 505 may reinforce or increase a mass of the second vibration device 500 to decrease a resonance frequency of the second vibration device 500 based on an increase in mass, thereby increasing a sound pressure level characteristic of the low pitched sound band of the second vibration device 500.

With respect to the second vibration device 500 illustrated in FIG. 6A, the cover plate 505 is disposed on the rear surface of the vibration generator 540. In another example, the cover plate 505 may be omitted as needed.

Except that the top and bottom (or upper or lower) of the second vibration device 500 illustrated in FIG. 6A is reversed, the second vibration device 500 may be the same or substantially the same as the second vibration device 500 described above with reference to FIGS. 5A and 5B, and thus, same reference numerals refer to same elements and their repeated descriptions may be omitted for brevity.

FIGS. 6B and 6C are example plan views of the second vibration device of FIG. 6A

Referring to FIGS. 6B and 6C, the vibration generator 540 may be of a rectangular shape or a square shape, and a signal cable 519 may be disposed in at least part of the periphery of the vibration generator 540. When the vibration generator 540 has the shape of a rectangle or a square, a first side having a first length L1 of the vibration generator 540, and a second side having a second length L2 orthogonal to the first side may be equal to, smaller than, or lager than each other. The sound processing circuit and the signal cable 519 may be connected electrically, and the second vibration device 500 may further include a carbon nano tube 520 or a wire formed at one end of the signal cable 519 and electrically connected to the sound processing circuit to apply a sound signal from the sound processing circuit to the signal cable 519. The base plate 501 may have a size or an area which is greater than that of the vibration generator 540, and may have a quadrilateral shape or a circular shape, but embodiments of the present disclosure are not limited thereto.

FIG. 6D is a cross-sectional view of a second vibration device according to another example embodiment of the present disclosure.

Referring to FIG. 6D, the second vibration device 500 according to another example embodiment of the present disclosure may include a vibration generator 540, a fourth connection member 560, a base plate 501, a cover plate 505, and a third adhesive member 850.

Each of the vibration generator 540, a base plate 501, a cover plate 505, and a third adhesive member 850 of the second vibration device 500 may be substantially the same as those described above with reference to FIGS. 5A, and 6A-6C, and thus, same reference numerals refer to same elements and their repeated descriptions may be omitted for brevity.

The second vibration device 500 illustrated in FIG. 6D may have substantially the same structure as that of the second vibration device 500 illustrated in FIG. 6A, except that the cover plate 505 is removed and the forth connection member 560 is included.

The fourth connection member 560 may be connected or coupled to one of a first surface 540a and a second surface 540b, which is different from (or opposite to) the first surface 540a of the vibration generator 540. For example, in the vibration generator 540, the first surface 540a may be a top surface, a forward surface, a front surface, or an upper surface. In the vibration generator 540, the second surface 540b may be a bottom surface, a backside surface, a rear surface, a lower surface, or a backward surface. For example, in the vibration generator 540, the first surface 540a may be disposed closer to the fourth connection member 560 than the second surface 540b. For example, the fourth connection member 560 may be a first connection member, an adhesive member, or a first adhesive member.

The fourth connection member 560 according to an example embodiment of the present disclosure may include an adhesive layer (or a tacky layer) which is good in adhesive force or attaching force. For example, the fourth connection member 560 may include a double-sided adhesive tape, a double-sided foam pad, or a tacky (or an adhesive) sheet. For example, when the fourth connection member 560 includes a tacky sheet (or a tacky layer or an adhesive layer), the fourth connection member 560 may include only an adhesive layer or a tacky layer without a base member such as a plastic material or the like.

The adhesive layer (or a tacky layer) of the fourth connection member 560 according to an example embodiment of the present disclosure may include epoxy, acrylic, silicone, or urethane, but embodiments of the present disclosure are limited thereto. The adhesive layer (or a tacky layer) of the fourth connection member 560 according to another example embodiment of the present disclosure may include a pressure sensitive adhesive (PSA), an optically clear adhesive (OCA), or an optically clear resin (OCR), but embodiments of the present disclosure are limited thereto.

The fourth connection member 560 according to an example embodiment of the present disclosure, as illustrated in FIG. 6D, may connect or couple the vibration generator 540 to the base plate 501. For example, the fourth connection member 560 may be disposed between the base plate 501 and the first surface 540a of the vibration generator 540.

FIG. 6E is a cross-sectional view of a second vibration device according to an example embodiment of the present disclosure. FIGS. 6F and 6G are example plan views of the second vibration device of FIG. 6E

Referring to FIGS. 6E to 6G, the second vibration device according to an example embodiment of the present disclosure may include a vibration generator 540, a base plate 501, a cover plate 505, a third adhesive member 850, and a pad 580.

Each of the vibration generator 540, a base plate 501, a cover plate 505, and a third adhesive member 850 of the second vibration device 500 may be substantially the same as those described above with reference to FIGS. 6A to 6C, and thus, same reference numerals refer to same elements and their repeated descriptions may be omitted for brevity.

The pad 580 may be coupled to or attached on a second surface of the vibration generator 540. For example, the pad 580 may be coupled to or attached on a center portion of the second surface of the vibration generator 540. The pad 580 may have a size which is smaller than or equal to that of the vibration generator 540. For example, the pad 580 may have a polygonal pillar shape or a circular pillar shape, but embodiments of the present disclosure are not limited thereto.

With respect to the second vibration device 500 illustrated in FIG. 6E, the cover plate 505 is coupled or connected to the rear surface of the vibration generator 540. In another example, the cover plate 505 may be omitted as needed. Therefore, the pad 580 may be directly coupled or connected to the vibration generator 540.

The pad 580 according to an example embodiment of the present disclosure may include a material having stiffness which is less than a bending stiffness of the vibration generator 540. The pad 580 according to another example embodiment of the present disclosure may include an elastic material which may act as a mass (or a weight) on the vibration generator 540.

The pad 580 according to an example embodiment of the present disclosure may increase a mass of the vibration generator 540, and thus, may reduce a lowest resonance frequency (or a lowest natural frequency) of the vibration generator 540. Therefore, the vibration generator 540 may vibrate at a relatively low frequency due to a lowest resonance frequency (or a lowest natural frequency) based on an increase in mass caused by the pad 580. Accordingly, a sound characteristic and/or a sound pressure level characteristic of a low-pitched sound band generated based on a vibration of the vibration generator 540 may be enhanced. For example, the pad 580 may be a resonance pad, a mass member, a weight clapper, or a weight member. For example, the low-pitched sound band may be about 300 Hz or about 500 Hz or less, but embodiments of the present disclosure are not limited thereto.

FIG. 6H is a cross-sectional view of a second vibration device according to another example embodiment of the present disclosure.

Referring to FIG. 6H, the second vibration device 500 according to another example embodiment of the present disclosure may include a vibration generator 540, a base plate 501, a cover plate 505, a third adhesive member 850, and a pad 580. In another example embodiment, the pad 580 may be omitted.

The second vibration device 500 may include the base plate 501 connected to the rear cover 300 and the vibration generator 540 connected to a rear surface of the base plate 501. Each of the vibration generator 540, a fourth connection member 560, a base plate 501, a third adhesive member 850, and a pad of the second vibration device 500 may be substantially the same as those described above with reference to FIGS. 6A to 6G, and thus, same reference numerals refer to same elements and their repeated descriptions may be omitted for brevity.

The second vibration device 500 illustrated in FIG. 6H, may have substantially the same structure as that of the second vibration device 500 illustrated in FIG. 6E, except that the cover plate 505 is removed and the forth connection member 560 is included.

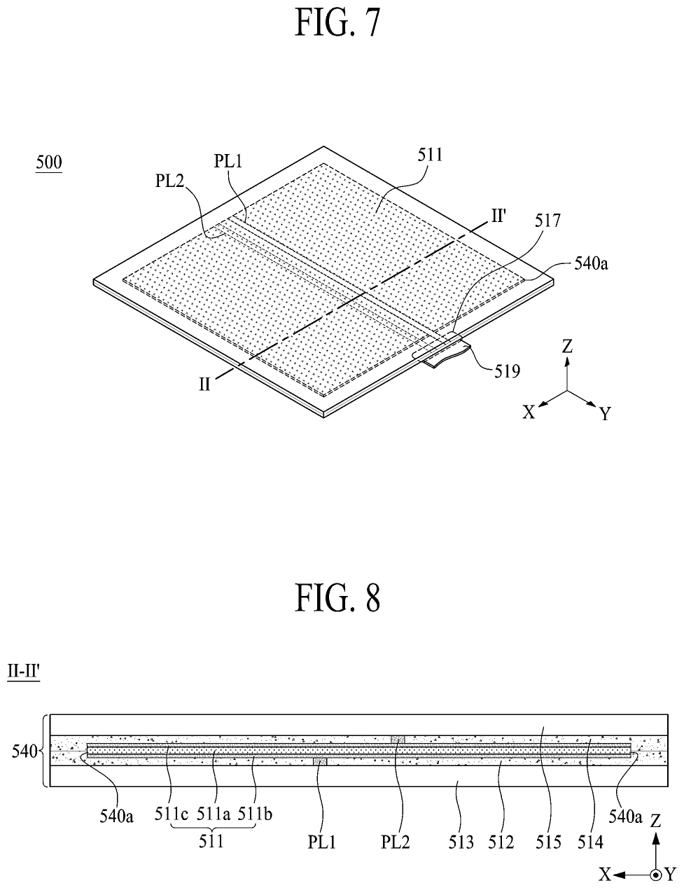

FIG. 7 is a perspective view of a second vibration device 500 according to an example embodiment of the present disclosure, and FIG. 8 is an example of a cross-sectional view taken along line II-II′ of FIG. 7.

Referring to FIGS. 7 and 8, the second vibration device 500 according to an example embodiment of the present disclosure may be referred to as a flexible vibration structure, a flexible vibrator, a flexible vibration generating device, a flexible vibration generator, a flexible sounder, a flexible sound device, a flexible sound generating device, a flexible sound generator, a flexible actuator, a flexible speaker, a flexible piezoelectric speaker, a film actuator, a film-type piezoelectric composite actuator, a film speaker, a film-type piezoelectric speaker, or a film-type piezoelectric composite speaker, but the terms are not limited thereto.

The vibration portion 511a may include a piezoelectric material. For example, the vibration portion 511a may include a piezoelectric material (or an electroactive material) having a piezoelectric effect. For example, the piezoelectric material may have a characteristic where pressure or twisting is applied to a crystalline structure by an external force, a potential difference occurs due to dielectric polarization caused by a relative position change of of a positive (+) ion (or cation) and a negative (−) ion (or anion), and a vibration is generated by an electric field based on a voltage applied thereto. The vibration portion 511a may be referred to as the terms such as a vibration layer, a vibration structure, a piezoelectric layer, a piezoelectric material layer, an electroactive layer, a vibration portion, a piezoelectric material portion, an electroactive portion, a piezoelectric structure, a piezoelectric composite layer, a piezoelectric composite, or a piezoelectric ceramic composite, but the terms are not limited thereto. The vibration portion 511a may include a transparent conductive material, a semitransparent conductive material, or an opaque conductive material and may be transparent, semitransparent, or opaque.

The vibration portion 511a according to an example embodiment of the present disclosure may include a ceramic-based material for implementing a relatively high vibration, or may include a piezoelectric ceramic having a perovskite crystalline structure. The perovskite crystalline structure may have a piezoelectric effect and an inverse piezoelectric effect, and may be a plate-shaped structure having orientation. The perovskite crystalline structure may be represented by a chemical formula “ABO₃” In the chemical formula, “A” may include a divalent metal element, and “B” may include a tetravalent metal element. For example, in the chemical formula “ABO₃,” “A” and “B” may be cations, and “O” may be anions. For example, the vibration portion 511a may include one or more of lead(II) titanate (PbTiO₃), lead zirconate (PbZrO₃), lead zirconate titanate(PbZrTiO₃), barium titanate (BaTiO₃), and strontium titanate (SrTiO₃), but embodiments of the present disclosure are not limited thereto.

In a case where the perovskite crystalline structure includes a center ion (for example, PbTiO₃), a position of a Ti ion may be changed by an external stress or a magnetic field, and thus, polarization or poling may be changed, thereby generating a piezoelectric effect. For example, in the perovskite crystalline structure, a cubic shape corresponding to a symmetric structure may be changed to a tetragonal, orthorhombic, or rhombohedral structure corresponding to an unsymmetric structure, and thus, a piezoelectric effect may be generated. In a tetragonal, orthorhombic, or rhombohedral structure corresponding to an unsymmetric structure, polarization may be high in a morphotropic phase boundary (MPB), and realignment of polarization may be easy, whereby the perovskite crystalline structure may have a high piezoelectric characteristic.

According to an example embodiment of the present disclosure, the vibration portion 511a may include one or more materials of lead (Pb), zirconium (Zr), titanium (Ti), zinc (Zn), nickel (Ni), and niobium (Nb), but embodiments of the present disclosure are not limited thereto.

According to another example embodiment of the present disclosure, the vibration portion 511a may include single crystalline ceramic or polycrystalline ceramic. The single crystalline ceramic may be a material where particles having a single crystal domain having a certain structure are regularly arranged. The polycrystalline ceramic may include irregular particles having various crystal domains.

According to another example embodiment of the present disclosure, the vibration portion 511a may include a lead zirconate titanate (PZT)-based material including lead (Pb), zirconium (Zr), and titanium (Ti) or may include a lead zirconate nickel niobate (PZNN)-based material including lead (Pb), zirconium (Zr), nickel (Ni), and niobium (Nb), but embodiments of the present disclosure are not limited thereto. In another example embodiment, the vibration portion 511a may include at least one or more of CaTiO₃, BaTiO₃, and SrTiO₃ without Pb, but embodiments of the present disclosure are not limited thereto.

According to another example embodiment of the present disclosure, the vibration portion 511a may have a piezoelectric deformation modulus (or a piezoelectric modulus) d₃₃ of 1,000 pC/N or more based on a thickness direction Z thereof. A vibration device may be applied to a vibration member or a display panel having a large size, and the vibration portion 511a may have a high piezoelectric deformation modulus d₃₃, so as to have a sufficient vibration characteristic or a sufficient piezoelectric characteristic. For example, the vibration portion 511a may include a PZT-based material (PbZrTiO₃) as a main component, and for example, may include a softener dopant material doped in A site (Pb) and a relaxer ferroelectric material doped into B site (ZrTi).

The softener dopant material may enhance a piezoelectric characteristic and a dielectric characteristic of the vibration portion 511a, and for example, may increase the piezoelectric deformation modulus d₃₃ of the vibration portion 511a. The softener dopant material according to an example embodiment of the present disclosure may include a divalent element and a triad element. A morphotropic phase boundary (MPB) may be formed by adding the softener dopant material to the PZT-based material (PbZrTiO₃), and thus, a piezoelectric characteristic and a dielectric characteristic may be enhanced. For example, the softener dopant material may include strontium (Sr), barium (Ba), lanthanum (La), neodymium (Nd), calcium (Ca), yttrium (Y), erbium (Er), or ytterbium (Yb). For example, an ion (Sr²⁺, Ba²⁺, La²⁺, Nd³⁺, Ca³⁺, Y³⁺, Er³⁺, or Yb³⁺) of the softener dopant material doped into the PZT-based material (PbZrTiO₃) may substitute a portion of lead (Pb) in the PZT-based material (PbZrTiO₃), and a substitution amount thereof may be about 2 mol % to about 20 mol %. For example, when the substitution amount is less than 2 mol % or more than 20 mol %, the perovskite crystalline structure may be broken, and thus, an electromechanical coupling coefficient kP and the piezoelectric deformation modulus d₃₃ may be reduced. When the softener dopant material is substituted, a morphotropic phase boundary (MPB) may be formed, and a high piezoelectric characteristic and a high dielectric characteristic may be realized in the morphotropic phase boundary (MPB), thereby implementing a vibration device having a high piezoelectric characteristic and a high dielectric characteristic.

According to an example embodiment of the present disclosure, a relaxer ferroelectric material doped into the PZT-based material (PbZrTiO₃) may enhance an electric deformation characteristic of the vibration portion 511a. The relaxer ferroelectric material according to an example embodiment of the present disclosure may include a lead magnesium niobate (PMN)-based material, or a lead nickel niobate (PNN)-based material, but example embodiments of the present disclosure are not not limited thereto. The PMN-based material may include Pb, magnesium (Mg), and Nb, and for example, may be Pb(Mg, Nb)O₃. For example, the relaxer ferroelectric material doped into the PZT-based material (PbZrTiO₃) may substitute a portion of each of zirconium (Zr) and titanium (Ti) in the PZT-based material (PbZrTiO₃), and a substitution amount thereof may be about 5 mol % to about 25 mol %. For example, when the substitution amount is less than 5 mol % or more than 25 mol %, the perovskite crystalline structure may be broken, and thus, the electromechanical coupling coefficient kP and the piezoelectric deformation modulus d₃₃ may be reduced.

According to an example embodiment of the present disclosure, the vibration portion 511a may further include a donor material doped into B site (ZrTi) of the PZT-based material (PbZrTiO₃), in order to additionally enhance a piezoelectric coefficient. For example, a donor material doped into the B site (ZrTi) may include quadrivalent to hexad elements. For example, the donor material doped into B site (ZrTi) may include tellurium (Te), germanium (Ge), uranium (U), bismuth (Bi), niobium (Nb), tantalum (Ta), antimony (Sb), or tungsten (W).

The vibration portion 511a according to an example embodiment of the present disclosure may have the piezoelectric deformation modulus d₃₃ of 1,000 pC/N or more based on the thickness direction Z thereof, thereby implementing a vibration device with an enhanced vibration characteristic. For example, a vibration device with an enhanced vibration characteristic may be implemented in a large-area apparatus or vibration member (or vibration object).

The first electrode portion 511b may be disposed at a first surface (or an upper surface) of the vibration portion 511a and may be electrically connected to the first surface of the vibration portion 511a. The second electrode portion 511c may be disposed at a surface which differs from the first surface of the vibration portion 511a. For example, the vibration portion 511a may be polarized (or poling) by a certain voltage applied to the first electrode portion 511b and the second electrode portion 511c in a certain temperature atmosphere or a temperature atmosphere which is changed from a high temperature to a room temperature.

For example, the first electrode portion 511b may have a common electrode form (or a single electrode) where the first electrode portion 511b is disposed at the whole first surface of the vibration portion 511a. The first electrode portion 511b according to an example embodiment of the present disclosure may include a transparent conductive material, a semitransparent conductive material, or an opaque conductive material. For example, the transparent conductive material or the semitransparent conductive material may include indium tin oxide (ITO) or indium zinc oxide (IZO), but example embodiments of the present disclosure are not not limited thereto. The opaque conductive material may include aluminium (Al), copper (Cu), gold (Au), silver (Ag), platinum (Pt), molybdenum (Mo), manganese (Mg), or an alloy thereof, but example embodiments of the present disclosure are not not limited thereto.

The second electrode portion 511c may be disposed at the second surface (or a rear or backside surface), which is opposite to or different from the first surface, of the vibration portion 511a and may be electrically connected to the second surface of the vibration portion 511a. For example, the second electrode portion 511c may have a common electrode form (or a single electrode) where the second electrode portion 511c is disposed at the whole second surface of the vibration portion 511a. The second electrode portion 511c according to an example embodiment of the present disclosure may include a transparent conductive material, a semitransparent conductive material, or an opaque conductive material. For example, the second electrode portion 511c may include the same material as that of the first electrode portion 511b, but example embodiments of the present disclosure are not not limited thereto. In another example embodiment of the present disclosure, the second electrode portion 511c may include a material which differs from that of the first electrode portion 511b.

According to another example embodiment of the present disclosure, the second vibration device 500 may further include a first cover member 513 and a second cover member 515.

The first cover member 513 may be disposed at a first surface of the second vibration device 500. For example, the first cover member 513 may be provided in the first electrode portion 511b. For example, the first cover member 513 may be provided on the first electrode portion 511b. For example, the first cover member 513 may cover the first electrode portion 511b disposed on the first surface of the vibration portion 511a, and thus, may protect the first surface of the vibration portion 511a or the first electrode portion 511b.

The second cover member 515 may be disposed at a second surface of the second vibration device 500. For example, the second cover member 515 may be provided in the second electrode portion 511c. For example, the second cover member 515 may be provided under the second electrode portion 511c. For example, the second cover member 515 may cover the second electrode portion 511c disposed on the second surface of the vibration portion 511a, and thus, may protect the second surface of the vibration portion 511a or the second electrode portion 511c.

Each of the first cover member 513 and the second cover member 515 according to an example embodiment of the present disclosure may include one or more materials of plastic, fiber, and wood, but example embodiments of the present disclosure are not not limited thereto. For example, each of the first cover member 513 and the second cover member 515 may include the same material or different materials. For example, each of the first cover member 513 and the second cover member 515 may be a polyimide film or a polyethylene terephthalate film, but example embodiments of the present disclosure are not not limited thereto. For example, each of the the first cover member 513 and the second cover member 515 may include a double-sided insulation tape, a single-sided insulation tape, a single-sided insulation foam tape, or a double-sided insulation foam tape having an adhesive layer attached to the rear or front surface of the piezoelectric device 511.

The vibration device 500 according to another example embodiment of the present disclosure may further include a first adhesive layer 512 and a second adhesive layer 514. For example, the first adhesive layer 512 may be disposed between the first cover member 513 and the first electrode portion 511b. For example, the second adhesive layer 514 may be disposed between the second cover member 515 and the second electrode portion 511c.

The first cover member 513 according to an example embodiment of the present disclosure may be disposed at the first surface of the vibration portion 511a by the first adhesive layer 512. For example, the first cover member 513 may be connected or coupled to the first electrode portion 511b by the first adhesive layer 512. For example, the first cover member 513 may be disposed at the first surface of the vibration portion 511a by a film laminating process using the first adhesive layer 512. Accordingly, the vibration portion 511a may be integrated (or disposed) into the first cover member 513.

The second cover member 515 according to an example embodiment of the present disclosure may be disposed at the second surface of the vibration portion 511a by the second adhesive layer 514. For example, the second cover member 515 may be connected or coupled to the second electrode portion 511c by the second adhesive layer 514. For example, the second cover member 515 may be disposed on a second surface of the vibration portion 511a by a film laminating process using the second adhesive layer 514. Accordingly, the vibration portion 511a may be integrated (or disposed) into the second cover member 515.

For example, the first adhesive layer 512 and the second adhesive layer 514 may fully surround the vibration device 500 or a vibration device 511. For example, the first adhesive layer 512 and the second adhesive layer 514 may be disposed between the first cover member 513 and the second cover member 515 to surround the vibration portion 511a, the first electrode portion 511b, and the second electrode portion 511c. For example, the first adhesive layer 512 and the second adhesive layer 514 may be disposed between the first cover member 513 and the second cover member 515 to fully or entirely surround the vibration portion 511a, the first electrode portion 511b, and the second electrode portion 511c. For example, the vibration portion 511a, the first electrode portion 511b, and the second electrode portion 511c may be buried or embedded between the first adhesive layer 512 and the second adhesive layer 514. For convenience of description, the first adhesive layer 512 and the second adhesive layer 514 are illustrated as at least two adhesive layers, but are not limited thereto, and may be provided as one adhesive layer.

Each of the first adhesive layer 512 and the second adhesive layer 514 according to an example embodiment of the present disclosure may include an electrical insulation material which has adhesive properties and is capable of compression and decompression. For example, each of the first adhesive layer 512 and the second adhesive layer 514 may include epoxy resin, acrylic resin, silicone resin, or urethane resin, but example embodiments of the present disclosure are not not limited thereto.

An audio controller may generate an alternating current (AC) vibration driving signal including a first vibration driving signal and a second vibration driving signal based on a sound source (or a sound signal). The first vibration driving signal may be one of a positive (+) vibration driving signal and a negative (−) vibration driving signal, and the second vibration driving signal may be one of the positive (+) vibration driving signal and the negative (−) vibration driving signal. For example, the first vibration driving signal may be supplied to the first electrode portion 511b of the vibration device 500 through a terminal of a signal cable 519, a pad electrode of a pad portion, and a first power supply line. The second vibration driving signal may be supplied to the second electrode portion 511c of the vibration device 500 through a terminal of the signal cable, a pad electrode of the pad portion, and a second power supply line.

According to an example embodiment of the present disclosure, the vibration portion 511a may be integrated by the first and second cover members 513 and 515, and thus, a vibration device having a simple structure and having a thin thickness may be provided.

One or more first power supply lines PL1 of the vibration device 500 may extend long in a second direction Y. The first power supply line PL1 may be disposed at the first cover member 513 and may be electrically connected to the first electrode portion 511b. For example, the first power supply line PL1 may be disposed at a rear surface of the first cover member 513 facing the first electrode portion 511b and may be electrically connected to the first electrode portion 511b. For example, the first power supply line PL1 may be disposed at the rear surface of the first cover member 513 directly facing the first electrode portion 511b and may be electrically and directly connected to the first electrode portion 511b. In an example embodiment of the present disclosure, the first power supply line PL1 may be electrically connected to the first electrode portion 511b by using an anisotropic conductive film. In another example embodiment of the present disclosure, the first power supply line PL1 may be electrically connected to the first electrode portion 511b by a conductive material (or a particle) in the first adhesive layer 512.

The pad portion 517 may be disposed at a center portion of the first and second vibration generating portions 500A and 500B. The pad portion 517 may be electrically connected to a first portion (one side or one end) of one or more of the first power supply line PL1 and the second power supply line PL2. For example, the pad portion 517 may be provided at an edge portion or a periphery portion of one or more of the first cover member 513 and the second cover member 515. The pad portion 517 may be electrically connected to the first portion (one side or one end) of one or more of the first power supply line PL1 and the second power supply line PL2.

The pad portion 517 according to an example embodiment of the present disclosure may include a first pad electrode, which is electrically connected to the first portion (one side or one end) of the first power supply line PL1, and a second pad electrode which is electrically connected to the first portion (one side or one end) of the first power supply line PL1. For example, one or more of the first pad electrode and the second pad electrode may be exposed at a first edge portion (or a first periphery portion) of one or more of the first cover member 513 and the second cover member 515.

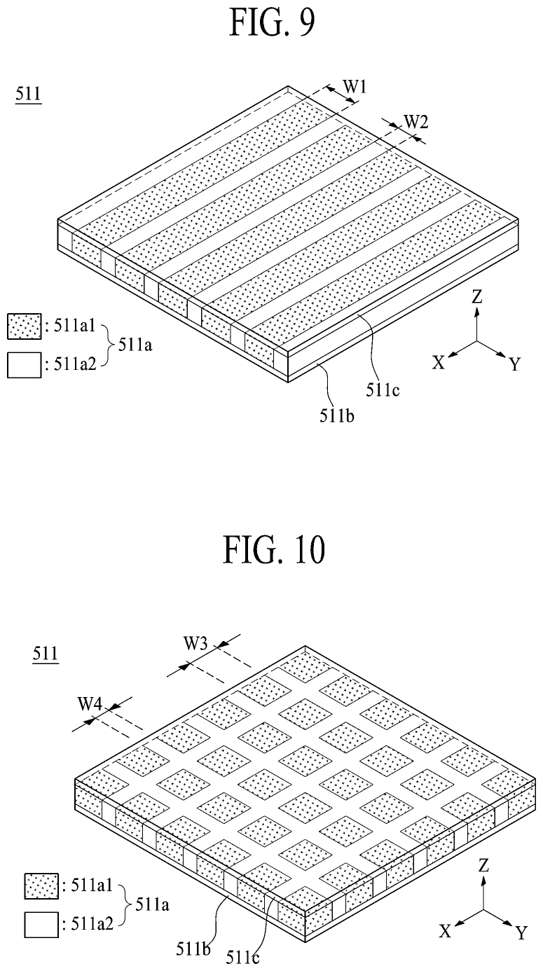

FIGS. 9 to 12 are perspective views of a vibration portion of a second vibration device 500 according to one or more example embodiments of the present disclosure.

Referring to FIGS. 9 to 12, a vibration portion 511a according to one or more example embodiments of the present disclosure may include a first vibration portion 511a1 and a second vibration portion 511a2.

Referring to FIGS. 9 to 12, the vibration portion 511a according to one or more example embodiments of the present disclosure may be referred to as a flexible vibration structure, a flexible vibrator, a flexible vibration generating device, a flexible vibration generator, a flexible sounder, a flexible sound device, a flexible sound generating device, a flexible sound generator, a flexible actuator, a flexible speaker, a flexible piezoelectric speaker, a film actuator, a film-type piezoelectric composite actuator, a film speaker, a film-type piezoelectric speaker, or a film-type piezoelectric composite speaker, but the terms are not limited thereto.

The vibration portion 511a according to an example embodiment of the present disclosure may include a plurality of first portions 511a1 and a plurality of second portions 511a2. For example, the plurality of first portions 511a1 and the plurality of second portions 511a2 may be alternately and repeatedly arranged in a first direction X (or a second direction Y). For example, the first direction X may be a widthwise direction of the vibration portion 511a and the second direction Y may be a lengthwise direction of the vibration portion 511a intersecting with the first direction X, but embodiments of the present disclosure are not limited thereto. For example, the first direction X may be a lengthwise direction of the vibration portion 511a, and the second direction Y may be a widthwise direction of the vibration portion 511a.

Each of the plurality of first portions 511a1 may include an inorganic material portion. For example, the inorganic material portion may include a piezoelectric material having a piezoelectric effect, a composite piezoelectric material, or an electroactive material. For example, each of the plurality of first portions 511a1 may be referred to as an electroactive portion, an inorganic material portion, a piezoelectric material portion, or a vibration portion, but embodiments of the present disclosure are not limited thereto.

Each of the plurality of first portions 511a1 may include a ceramic-based material for implementing a relatively high vibration, or may include a piezoelectric ceramic having a perovskite-based crystalline structure. The perovskite crystalline structure may have a piezoelectric effect and an inverse piezoelectric effect, and may be a plate-shaped structure having orientation. The perovskite crystalline structure may be represented by a chemical formula “ABO₃.” In the chemical formula, “A” may include a divalent metal element, and “B” may include a tetravalent metal element. For example, in the chemical formula “ABO₃”, “A” and “B” may be cations, and “O” may be anions. For example, the first portions 51a may include one or more of lead(II) titanate (PbTiO₃), lead zirconate (PbZrO₃), lead zirconate titanate(PbZrTiO₃), barium titanate (BaTiO₃), and strontium titanate (SrTiO₃), but embodiments of the present disclosure are not limited thereto.

The vibration portion 511a according to an example embodiment of the present disclosure may include a lead zirconate titanate (PZT)-based material including lead (Pb), zirconium (Zr), and titanium (Ti) or may include a lead zirconate nickel niobate (PZNN)-based material including lead (Pb), zirconium (Zr), nickel (Ni), and niobium (Nb), but is not limited thereto. In another example embodiment of the present disclosure, the vibration portion 511a may include at least one of CaTiO₃, BaTiO₃, and SrTiO₃ without Pb, but embodiments of the present disclosure are not limited thereto.

In the vibration portion 511a, the plurality of first portions 511a1 and the plurality of second portions 511a2 may be disposed (or arranged) in parallel on the same plane (or the same layer). The plurality of second portions 511a2 may be disposed between the plurality of first portions 511a1. For example, the plurality of second portions 511a2 may include a pattern of a polygonal shape. Each of the plurality of second portions 511a2 may be configured to fill a gap between two adjacent first portions 511a1 and may be connected or adhered to an adjacent first portion 511a1. Accordingly, the vibration portion 511a may extend up to a desired size or length based on a lateral connection (or coupling) between the first portion 511a1 and the second portion 511a2.

Referring to FIG. 9, a vibration portion 511a of a vibration device 511 according to an example embodiment of the present disclosure may include a plurality of first portions 511a1 and a plurality of second portions 511a2, which are alternately and repeatedly arranged in a first direction X. Each of the plurality of first portions 511a1 may be disposed between the plurality of second portions 511a2 and may have a first width W1 parallel to the first direction X (or a second direction Y) and a length parallel to the second direction Y (or the first direction X). Each of the plurality of second portions 511a2 may have a second width W2 parallel to the first direction X (or the second direction Y) and a length parallel to the second direction Y (or the first direction X). The first width W1 may be the same as or different from the second width W2. For example, the first width W1 may be greater than the second width W2. For example, the first portion 511a1 and the second portion 511a2 may include a line shape or a stripe shape having the same size or different sizes. Accordingly, the vibration portion 511a may have a 2-2 type composite structure having a piezoelectric characteristic of a 2-2 vibration mode and may have a resonance frequency of 20 kHz or less, but embodiments of the present disclosure are not limited thereto. For example, the resonance frequency of the vibration portion 511a may vary based on one or more of a shape, a length, or a thickness.

Referring to FIG. 10, a vibration portion 511a of a vibration device 511 according to an example embodiment of the present disclosure may include a plurality of first portions 511a1 and a plurality of second portions 511a2. For example, the plurality of first portions 511a1 and the plurality of second portions 511a2 may be alternately and repeatedly arranged in the second direction Y. Each of the plurality of first portions 511a1 may be disposed between the plurality of second portions 511a2 and may have a third width W3 parallel to the second direction Y and a length parallel to the first direction X (or the second direction Y). Each of the plurality of second portions 511a2 may have a fourth width W4 which is the same as the third width W3 and may have a length parallel to the first direction X (or the second direction Y). For example, the first portion 511a1 and the second portion 511a2 may include a line shape or a stripe shape having the same size or different sizes. Accordingly, the vibration portion 511a of the vibration device 511 illustrated in FIG. 10 may have a 2-2 type composite and may have a resonance frequency of 20 kHz or less, but embodiments of the present disclosure are not limited thereto. For example, the resonance frequency of the vibration portion 511a may vary based on one or more of a shape, a length, or a thickness.

In the vibration portion 511a, the width W2 of each of the plurality of second portions 511a2 may decrease progressively in a direction from a center portion of the vibration portion 511a or the vibration device 511 to both edge portions (or both ends or both peripheries) thereof.

According to an example embodiment of the present disclosure, when the vibration portion 511a or the vibration device 511 vibrates in a vertical direction Z (or a thickness direction), a second portion 511a2 having a largest width W4 among the plurality of second portions 511a2 may be disposed at a portion on which a relatively largest stress concentrates. When the vibration portion 511a or the vibration device 511 vibrates in the vertical direction Z, a second portion 511a2 having a smallest width W4 among the plurality of second portions 511a2 may be disposed at a portion where a relatively smallest stress occurs. For example, the second portion 511a2 having the largest width W4 among the plurality of second portions 511a2 may be disposed at a center portion of the vibration portion 511a, and the second portion 511a2 having the smallest width W4 among the plurality of second portions 511a2 may be disposed at both edge portions (or both ends or both peripheries) of the vibration portion 511a. Accordingly, when the vibration portion 511a or the vibration device 511 vibrates in the vertical direction Z, an overlap of a resonance frequency or interference of a sound wave occurring at a portion on which a largest stress concentrates may be minimized, and thus, a dip of a sound pressure level occurring in a low pitched sound band may be reduced and the flatness of a sound characteristic may be improved in the low pitched sound band.

In the vibration portion 511a, the plurality of first portions 511a1 may have different sizes (or widths). For example, a size (or a width) of each of the plurality of first portions 511a1 may decrease or increase progressively in a direction from the center portion of the piezoelectric vibration portion 511a or the vibration device 511 to both edge portions (or both ends or both peripheries) thereof. In this case, a sound pressure level characteristic of a sound of the vibration portion 511a may be enhanced by various natural vibration frequencies based on vibrations of the plurality of first portions 511a1 having different sizes, and a reproduction band of a sound may extend.

Each of the plurality of second portions 511a2 may be disposed between the plurality of first portions 511a1. Therefore, in the vibration portion 511a or the vibration device 511, vibration energy based on a link in a unit lattice of the first portion 511a1 may be increased by the second portion 511a2, and thus, a vibration characteristic may increase and a piezoelectric characteristic and flexibility may be secured. For example, the second portion 511a2 may include one or more of an epoxy-based polymer, an acrylic-based polymer, and a silicone-based polymer, but embodiments of the present disclosure are not limited thereto.

Each of the plurality of second portions 511a2 according to an example embodiment of the present disclosure may be configured with an organic material portion. For example, the organic material portion may be disposed between two adjacent inorganic material portions, and thus, may absorb an impact applied to the inorganic material portion (or the first portion) and may release a stress concentrating on the inorganic material portion, thereby enhancing the durability of the vibration portion 511a or the vibration device 511 and realizing the flexibility of the vibration portion 511a or the vibration device 511.

The second portion 511a2 according to an example embodiment of the present disclosure may have viscoelasticity characteristic and a modulus (or Young's modulus) that are lower than those of the first portion 511a1, and thus, the second portion 511a2 may enhance the reliability of the first portion 511a1 vulnerable to an impact due to a brittle or fragile characteristic of the first portion 511a1. For example, the second portion 511a2 may include a material having a loss coefficient of about 0.01 to about 1 and a modulus of about 0.1 GPa (Giga Pascal) to about 10 GPa (Giga Pascal).

The organic material portion in the second portion 511a2 may include an organic material, an organic polymer, an organic piezoelectric material, or an organic non-piezoelectric material having a flexible characteristic compared to the inorganic material portion which is the first portion 511a1. For example, the second portion 511a2 may be referred to as an adhesive portion, a extendable portion, a bending portion, a damping portion, or a ductile portion, or the same, but embodiments of the present disclosure are not limited thereto.

The plurality of first portions 511a1 and the plurality of second portions 511a2 may be disposed on (or connected to) the same plane, and thus, the vibration portion 511a according to an example embodiment of the present disclosure may have a single thin film form. For example, the vibration portion 511a may have a structure where the plurality of first portions 511a1 are connected to one side thereof. For example, the vibration portion 511a may have a structure where the plurality of first portions 511a1 are connected in all of the vibration portion 511a. For example, the vibration portion 511a may be vibrated in a vertical direction by the first portion 511a1 having a vibration characteristic and may be bent in a curved shape by the second portion 511a2 having flexibility. In addition, in the vibration portion 511a according to an example embodiment of the present disclosure, a size of the first portion 511a1 and a size of the second portion 511a2 may be adjusted based on a piezoelectric characteristic and flexibility needed for the vibration portion 511a or the vibration device 511. For example, in the vibration portion 511a requiring a piezoelectric characteristic rather than flexibility, a size of the first portion 511a1 may be adjusted to be greater than that of the second portion 511a2. As another example embodiment of the present disclosure, in the vibration portion 511a requiring flexibility rather than a piezoelectric characteristic, a size of the second portion 511a2 may be adjusted to be greater than that of the first portion 511a1. Accordingly, a size of the vibration portion 511a may be adjusted based on a desired characteristic, and the vibration portion 511a may be easily designed.

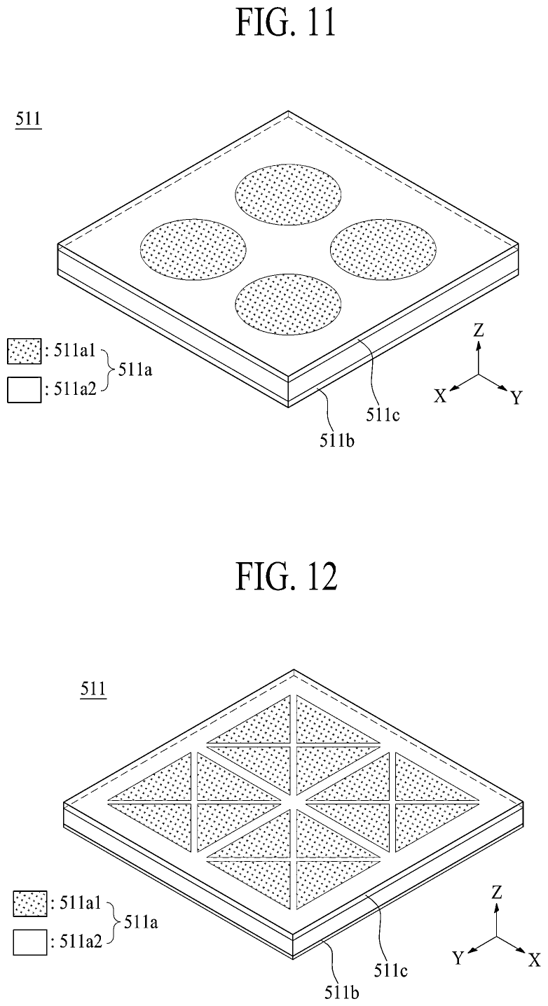

Referring to FIG. 11, a vibration portion 511a according to another example embodiment of the present disclosure may include a plurality of first portions 511a1, which are apart from one another in a first direction X and a second direction Y, and a second portion 511a2 disposed between the plurality of first portions 511a1.

The plurality of first portions 511a1 may be spaced apart from one another in each of the first direction X and the second direction Y. For example, the plurality of first portions 511a1 may have a hexahedral shape having the same size and may be arranged in a lattice shape. Each of the plurality of first portions 511a1 may include substantially the same material as that of the first portion 511a1 described above with reference to FIGS. 9 and 10, and thus, same reference numerals refer to same elements and their repeated descriptions may be omitted for brevity.

The second portion 511a2 may be disposed between the plurality of first portions 511a1 in each of the first direction X and the second direction Y. The second portion 511a2 may be configured to fill a gap between two adjacent first portions 511a1 or to surround each of the plurality of first portions 511a1, and thus, may be connected to or attached on an adjacent first portion 511a1. According to an example embodiment of the present disclosure, a width of a second portion 511a2 disposed between two first portions 511a1 adjacent to each other in the first direction X may be the same as or different from that of the first portion 21a1, and a width of a second portion 511a2 disposed between two first portions 511a1 adjacent to each other in the second direction Y may be the same as or different from that of the first portion 511a1. The second portion 511a2 may include substantially the same material as that of the second portion 511a2 described above with reference to FIGS. 9 and 10, and thus, same reference numerals refer to same elements and their repeated descriptions may be omitted for brevity.

As described above, the vibration portion 511a according to another example embodiment of the present disclosure may include a 1-3 type composite structure having a piezoelectric characteristic of a 1-3 vibration mode, and thus, may have a resonance frequency of 30 MHz or less, but embodiments of the present disclosure are not limited thereto. For example, the resonance frequency of the piezoelectric vibration portion 511a may vary based on one or more of a shape, a length, or a thickness.

Referring to FIG. 11, a vibration portion 511a according to another example embodiment of the present disclosure may include a plurality of first portions 511a1, which are spaced apart from one another in a first direction X and a second direction Y, and a second portion 511a2 disposed between the plurality of first portions 511a1.

Each of the plurality of first portions 511a1 may have a planar structure having a circular shape. For example, each of the plurality of first portions 511a1 may have a circular plate shape, but embodiments of the present disclosure are not limited thereto. For example, each of the plurality of first portions 511a1 may have a dot shape including an oval shape, a polygonal shape, or a donut shape. Each of the plurality of first portions 511a1 may include substantially the same piezoelectric material as that of the first portion 511a1 described above with reference to FIGS. 9 and 10, and thus, same reference numerals refer to same elements and their repeated descriptions may be omitted for brevity.

The second portion 511a2 may be disposed between the plurality of first portions 511a1 in each of the first direction X and the second direction Y. The second portion 511a2 may be configured to surround each of the plurality of first portions 511a1, and thus, may be connected to or attached on a lateral surface of each of the plurality of first portions 511a1. The plurality of first portions 511a1 and the second portion 511a2 may be disposed (or arranged) in parallel on the same plane (or the same layer). The second portion 511a2 may include substantially the same organic material as that of the second portion 511a2 described above with reference to FIGS. 9 and 10, and thus, same reference numerals refer to same elements and their repeated descriptions may be omitted for brevity.

Referring to FIG. 12, in a vibration device 511 according to another example embodiment of the present disclosure, a vibration portion 511a may include a plurality of first portions 511a1 which are spaced apart from one another in a first direction X and a second direction Y and a second portion 511a2 disposed between the plurality of first portions 511a1.

Each of the plurality of first portions 511a1 may have a planar structure having a triangular shape. For example, each of the plurality of first portions 511a1 may have a triangular plate shape, but embodiments of the present disclosure are not limited thereto. Each of the plurality of first portions 511a1 may include substantially the same material as that of the first portion 511a1 described above with reference to FIGS. 9 and 10, and thus, same reference numerals refer to same elements and their repeated descriptions may be omitted for brevity.

According to an example embodiment of the present disclosure, four adjacent first portions 511a1 of the plurality of first portions 511a1 may be disposed adjacent to one another to form a quadrilateral shape (or a square shape). A vertex of each of four adjacent first portions 511a1 forming a quadrilateral shape may be disposed adjacent to a middle portion (or a center portion) of a quadrilateral shape.

The second portion 511a2 may be disposed between the plurality of first portions 511a1 in each of the first direction X and the second direction Y. The second portion 511a2 may be configured to surround each of the plurality of first portions 511a1, and thus, may be connected to or attached on a lateral surface of each of the plurality of first portions 511a1. The plurality of first portions 511a1 and the second portion 511a2 may be disposed (or arranged) in parallel on the same plane (or the same layer). The second portion 511a2 may include substantially the same material as that of the second portion 511a2 described above with reference to FIGS. 9 and 10, and thus, same reference numerals refer to same elements and their repeated descriptions may be omitted for brevity.

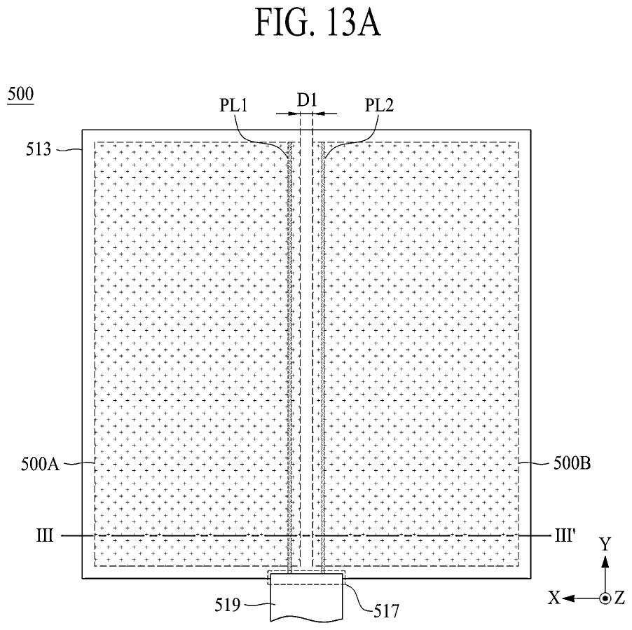

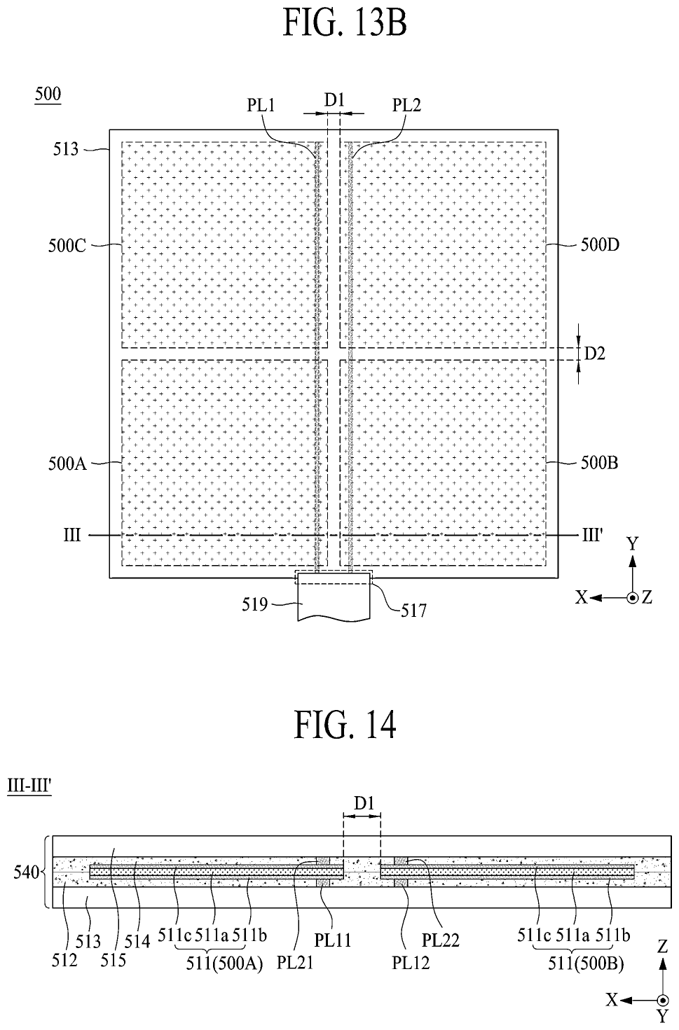

FIG. 13A and FIG. 13B are plan views of a vibration device according to an example embodiment of the present disclosure, and FIG. 14 is an example of a cross-sectional view taken along line of FIG. 13A and FIG. 13B.

Referring to FIGS. 13A, 13B, and 14, a vibration device 500 according to another example embodiment of the present disclosure may include first and second vibration generating portions 500A and 500B.

The first and second vibration generating portions 500A and 500B may be spaced apart from and electrically disconnected (or isolated) from each other in a first direction X. Each of the first and second vibration generating portions 500A and 500B may alternately repeat contraction and/or expansion based on a piezoelectric effect to vibrate. For example, the first and second vibration generating portions 500A and 500B may be arranged or tiled at a certain interval D1 in the first direction X. Accordingly, the vibration device 500 where the first and second vibration generating portions 500A and 500B are tiled may be a vibration array, a vibration array portion, a vibration module array portion, a vibration array structure, a tiling vibration array, a tiling array module, or a tiling vibration film.

Each of the first and second vibration generating portions 500A and 500B according to an example embodiment of the present disclosure may have a quadrilateral shape. For example, each of the first and second vibration generating portions 500A and 500B may have a quadrilateral shape having a width of 5 cm or more. For example, each of the first and second vibration generating portions 500A and 500B may have a square shape having a size of 5c mx5c m or more, but embodiments of the present disclosure are not limited thereto.

Each of the first and second vibration generating portions 500A and 500B may be disposed or tiled on the same plane, and thus, the vibration device 500 may be implemented to have a large area vibration device through tiling of the first and second vibration generating portions 500A and 500B having a relatively small size.

The first and second vibration generating portions 500A and 500B may be arranged or tiled at a certain interval, and thus, may be implemented as one vibration device (or a single vibration device) driven as one complete single body without being independently driven. According to an example embodiment of the present disclosure, with respect to the first direction X, a first separation distance D1 between the first and second vibration generating portions 500A and 500B may be 0.1 mm or more and less than 3 cm, but embodiments of the present disclosure are not limited thereto.

According to an example embodiment of the present disclosure, the first and second vibration generating portions 500A and 500B may be arranged or tiled to have a separation distance (or interval) D1 of 0.1 mm or more and less than 3 cm and thus may be driven as one vibration device, and a sound pressure level characteristic of a sound and a reproduction band of a sound generated based on a single-body vibration of each of the first and second vibration generating portions 500A and 500B may increase. For example, the first and second vibration generating portions 500A and 500B may be arranged at an interval D1 of 0.1 mm or more and less than 5 mm, in order to increase a reproduction band of a sound generated based on a single-body vibration of each of the first and second vibration generating portions 500A and 500B and increase a sound pressure level characteristic of a sound of a low pitched sound band (for example, at 500 Hz or less).

According to an example embodiment of the present disclosure, in a case where the first and second vibration generating portions 500A and 500B are arranged at an interval D1 of less than 0.1 mm or without the interval D1, the reliability of the first and second vibration generating portions 500A and 500B or the vibration device 500 may be reduced due to damage or the occurrence of a crack caused by a physical contact between the first and second vibration generating portions 500A and 500B when the first and second vibration generating portions 500A and 500B are vibrating.

According to an example embodiment of the present disclosure, when the first and second vibration generating portions 500A and 500B are arranged at an interval D1 of 3 cm or more, the first and second vibration generating portions 500A and 500B may not be driven as one vibration device due to an independent vibration of each of the first and second vibration generating portions 500A and 500B. Accordingly, a sound pressure level characteristic of a sound and a reproduction band of a sound generated based on a vibration of each of the first and second vibration generating portions 500A and 500B may decrease. For example, when the first and second vibration generating portions 500A and 500B are arranged at an interval D1 of 3 cm or more, each of a sound characteristic and a sound pressure level characteristic in the low pitched sound band (for example, at 500 Hz or less) may be reduced.

According to an example embodiment of the present disclosure, when the first and second vibration generating portions 500A and 500B are arranged at an interval D1 of 5 mm, each of the first and second vibration generating portions 500A and 500B may not be driven as one vibration device, and as a result, each of a sound characteristic and a sound pressure level characteristic in the low pitched sound band (for example, at 200 Hz or less) may be reduced.

According to another example embodiment of the present disclosure, when the first and second vibration generating portions 500A and 500B are arranged at an interval D1 of 1 mm, the first and second vibration generating portions 500A and 500B may be driven as one vibration device, and thus, a reproduction band of a sound may increase and a sound pressure level characteristic of a sound in the low pitched sound band (for example, at 500 Hz or less) may increase. For example, when the first and second vibration generating portions 500A and 500B are arranged at an interval D1 of 1 mm, a separation distance between the first and second vibration generating portions 500A and 500B may be optimized, and thus, the vibration device 500 may be implemented as a vibrator having a large area. Accordingly, the vibration device 500 may be driven as a large-area vibrator based on a single-body vibration of the first and second vibration generating portions 500A and 500B, and thus, a sound characteristic and a sound pressure level characteristic in the low pitched sound band and a reproduction band of a sound generated based on a large-area vibration of the vibration device 500 may increase or be enhanced.

Therefore, in order to implement a single-body vibration (or one vibration device) of the first and second vibration generating portions 500A and 500B, a separation distance D1 between the first and second vibration generating portions 500A and 500B may be adjusted to 0.1 mm or more and less than 3 cm. In addition, in order to increase a sound pressure level characteristic of a sound of the low pitched sound band along with implementing a single-body vibration (or one vibration device) of the first and second vibration generating portions 500A and 500B, a separation distance D1 between the first and second vibration generating portions 500A and 500B may be adjusted to 0.1 mm or more and less than 5 mm.

Each of the first and second vibration generating portions 500A and 500B according to an example embodiment of the present disclosure may include a piezoelectric vibration portion 511a, a first electrode portion 511b, and a second electrode portion 511c.

The vibration portion 511a of each of the first and second vibration generating portions 500A and 500B may include a piezoelectric material (or an electroactive material) including a piezoelectric effect. For example, the vibration portion 511a of each of the first and second vibration generating portions 500A and 500B may be substantially the same as one of the vibration portions 511a described above with reference to FIGS. 7 to 12, and thus, its repeated description may be omitted for brevity.

According to an example embodiment of the present disclosure, each of the first and second vibration generating portions 500A and 500B may include one vibration portion 511a or different piezoelectric vibration portions 21a among the vibration portions 511a described above with reference to FIGS. 7 to 12.

The first electrode portion 511b may be disposed at a first surface of the vibration portion 511a and may be electrically connected to the first surface of the vibration portion 511a. This may be substantially the same as the first electrode portion 511b described above with reference to FIG. 8, and thus, same reference numerals refer to same elements and its repeated description may be omitted for brevity.

The second electrode portion 511c may be disposed at a second surface of the vibration portion 511a and may be electrically connected to the second surface of the vibration portion 511a. This may be substantially the same as the first electrode portion 511c described above with reference to FIG. 8, and thus, same reference numerals refer to same elements and its repeated description may be omitted for brevity.

The vibration device 500 according to another example embodiment of the present disclosure may further include a first cover member 513 and a second cover member 515.

The first cover member 513 may be disposed on a first surface of the vibration device 500. For example, the first cover member 513 may be provided in the first electrode portion 511b disposed on a first surface of each of the first and second vibration generating portions 500A and 500B, and thus, may be connected to the first surface of each of the first and second vibration generating portions 500A and 500B in common and may support the first surface of each of the first and second vibration generating portions 500A and 500B in common. Accordingly, the first cover member 513 may protect the first surface of each of the first and second vibration generating portions 500A and 500B or the first electrode portion 511b.

The second cover member 515 may be disposed at a second surface of the vibration device 500. For example, the second cover member 515 may be provided in the second electrode portion 511c disposed on a second surface of each of the first and second vibration generating portions 500A and 500B, and thus, may be connected to the second surface of each of the first and second vibration generating portions 500A and 500B in common and may support the second surface of each of the first and second vibration generating portions 500A and 500B in common. Accordingly, the second cover member 515 may protect the second surface of each of the first and second vibration generating portions 500A and 500B or the second electrode portion 511c.

Each of the first cover member 513 and the second cover member 515 according to an example embodiment of the present disclosure may include one or more materials of plastic, fiber, and wood, but embodiments of the present disclosure are not limited thereto. For example, each of the first cover member 513 and the second cover member 515 may include the same material or different materials. For example, each of the first cover member 513 and the second cover member 515 may be a polyimide film or a polyethylene terephthalate film, but embodiments of the present disclosure are not limited thereto.

The first cover member 513 according to an example embodiment of the present disclosure may be disposed at the first surface of each of the first and second vibration generating portions 500A and 500B by a first adhesive layer 512. For example, the first cover member 513 may be directly disposed at the first surface of each of the first and second vibration generating portions 500A and 500B by a film laminating process using the first adhesive layer 512. Accordingly, the first and second vibration generating portions 500A and 500B may be integrated (or arranged) or tiled into the first cover member 513 to have a certain interval D1.

The second cover member 515 according to an example embodiment of the present disclosure may be disposed at the second surface of each of the first and second vibration generating portions 500A and 500B by using a second adhesive layer 514. For example, the second cover member 515 may be directly disposed at the second surface of each of the first and second vibration generating portions 500A and 500B by a film laminating process using the second adhesive layer 514. Accordingly, the first and second vibration generating portions 500A and 500B may be integrated (or arranged) or tiled into the second cover member 515 to have a certain interval D1.

The first adhesive layer 512 may be disposed between the first and second vibration generating portions 500A and 500B and at the first surface of each of the first and second vibration generating portions 500A and 500B. For example, the first adhesive layer 512 may be formed at a rear surface (or an inner surface) of the first cover member 513 facing the first surface of each of the first and second vibration generating portions 500A and 500B, may be filled between the first and second vibration generating portions 500A and 500B, and may be disposed between the first cover member 512 and the first surface of each of the first and second vibration generating portions 500A and 500B.

The second adhesive layer 514 may be disposed between the first and second vibration generating portions 500A and 500B and at the second surface of each of the first and second vibration generating portions 500A and 500B. For example, the second adhesive layer 514 may be formed at a front surface (or an inner surface) of the second cover member 515 facing the second surface of each of the first and second vibration generating portions 500A and 500B, may be filled between the first and second vibration generating portions 500A and 500B, and may be disposed between the second cover member 515 and the second surface of each of the first and second vibration generating portions 500A and 500B.

The first adhesive layer 512 and the second adhesive layer 514 may be connected to each other between the first and second vibration generating portions 500A and 500B. Therefore, each of the first and second vibration generating portions 500A and 500B may be surrounded by the first adhesive layer 512 and the second adhesive layer 514. For example, the first adhesive layer 512 and the second adhesive layer 514 may be configured between the first cover member 513 and the second cover member 515 to fully or entirely surround the first and second vibration generating portions 500A and 500B, respectively. For example, each of the first and second vibration generating portions 500A and 500B may be buried or embedded between the first adhesive layer 512 and the second adhesive layer 514.

Each of the first adhesive layer 512 and the second adhesive layer 514 according to an example embodiment of the present disclosure may include an electrical insulation material which has adhesive properties and is capable of compression and decompression. For example, each of the first adhesive layer 512 and the second adhesive layer 514 may include epoxy resin, acrylic resin, silicone resin, or urethane resin, but embodiments of the present disclosure are not limited thereto. For example, each of the first adhesive layer 512 and the second adhesive layer 514 may be transparent, semitransparent, or opaque.

The vibration device 500 according to another example embodiment of the present disclosure may further include a first power supply line PL1 disposed in the first cover member 513, a second power supply line PL2 disposed in the second cover member 515, and a pad portion 517 electrically connected to the first power supply line PL1 and the second power supply line PL2.

The first power supply line PL1 may be disposed at a rear surface of the first cover member 513 facing the first surface of each of the first and second vibration generating portions 500A and 500B. The first power supply line PL1 may be electrically connected to the first electrode portion 511b of each of the first and second vibration generating portions 500A and 500B. For example, the first power supply line PL1 may be directly and electrically connected to the first electrode portion 511b of each of the first and second vibration generating portions 500A and 500B. In an example embodiment of the present disclosure, the first power supply line PL1 may be electrically connected to the first electrode portion 511b of each of the first and second vibration generating portions 500A and 500B by an anisotropic conductive film. In another example embodiment of the present disclosure, the first power supply line PL1 may be electrically connected to the first electrode portion 511b of each of the first and second vibration generating portions 500A and 500B by a conductive material (or a particle) included in the first adhesive layer 512.

The first power supply line PL1 according to an example embodiment of the present disclosure may include first and second upper power lines PL11, and PL12 disposed in the second direction Y. For example, the first upper power line PL11 may be electrically connected to the first electrode portion 511b of the first vibration generating portion 500A. The second upper power line PL12 may be electrically connected to the first electrode portion 511b of the second vibration generating portion 500B.

The second power supply line PL2 may be disposed at a front surface of the second cover member 515 facing the second surface of each of the first and second vibration generating portions 500A and 500B. The second power supply line PL2 may be electrically connected to the second electrode portion 511c of each of the first and second vibration generating portions 500A and 500B. For example, the second power supply line PL2 may be directly and electrically connected to the second electrode portion 511c of each of the first and second vibration generating portions 500A and 500B. In an example embodiment of the present disclosure, the second power supply line PL2 may be electrically connected to the second electrode portion 511c of each of the first and second vibration generating portions 500A and 500B by an anisotropic conductive film. In another example embodiment of the present disclosure, the second power supply line PL2 may be electrically connected to the second electrode portion 511c of each of the first and second vibration generating portions 500A and 500B by a conductive material (or a particle) included in the second adhesive layer 514.

The second power supply line PL2 according to an example embodiment may include first and second lower power lines PL21 and PL22 disposed in the second direction Y. For example, the first lower power line PL21 may be electrically connected to the second electrode portion 511c of the first vibration generating portion 500A. For example, the first lower power line PL21 may overlap the first upper power line PL11. The second lower power line PL22 may be electrically connected to the second electrode portion 511c of the second vibration generating portion 500B. For example, the second lower power line PL22 may overlap the second upper power line PL12.

The pad portion 517 may be configured at one edge portion (or one periphery portion) of one of the first cover member 513 and the second cover member 515 so as to be electrically connected to one side or one end of the first power supply line PL1 and the second power supply line PL2.

The pad portion 517 according to an example embodiment of the present disclosure may include a first pad electrode, which is electrically connected to one end (or one portion) of the first power supply line PL1, and a second pad electrode which is electrically connected to one end (or one portion) of the second power supply line PL2.

The first pad electrode may be connected to one end (or one portion) of the first and second upper power lines PL11 and PL12 of the first power supply line PL1 in common. For example, one end (or one portion) of each of the first and second upper power lines PL11 and PL12 may branch from the first pad electrode. The second pad electrode may be connected to one end (or one portion) of the first and second lower power lines PL21 and PL22 of the second power supply line PL2 in common. For example, one end (or one portion) of each of the first and second lower power lines PL21 and PL22 may branch from the second pad electrode.

The vibration device 500 according to another example embodiment of the present disclosure may further include a signal cable (or a signal apply member or a signal supply member) 519.

The signal cable 519 may be electrically connected to the pad portion 517 disposed in the vibration device 500 and may supply the vibration device 500 with a vibration driving signal (or a sound signal) provided from a sound processing circuit. The signal cable 519 according to an example embodiment of the present disclosure may include a first terminal electrically connected to a first pad electrode of the pad portion 517 and a second terminal electrically connected to a second pad electrode of the pad portion 517. For example, the signal cable 519 may be configured as a flexible printed circuit cable, a flexible flat cable, a single-sided flexible printed circuit, a single-sided flexible PCB, a flexible multi-layer printed circuit, or a flexible multi-layer PCB, but embodiments of the present disclosure are not limited thereto.

The sound processing circuit may generate an alternating current (AC) vibration driving signal including a first vibration driving signal and a second vibration driving signal based on sound data provided from the external sound data generating circuit part. The first vibration driving signal may be one of a positive (+) vibration driving signal and a negative (−) vibration driving signal, and the second vibration driving signal may be one of the positive (+) vibration driving signal and the negative (−) vibration driving signal. For example, the first vibration driving signal may be supplied to the first electrode portion 511b of each of the first and second vibration generating portions 500A and 500B through the first terminal of the signal cable 519, the first pad electrode of the pad portion 517, and the first power supply line PL1. The second vibration driving signal may be supplied to the second electrode portion 511c of each of the first and second vibration generating portions 500A and 500B through the second terminal of the signal cable 519, the second pad electrode of the pad portion 517, and the second power supply line PL2.

As described above, the vibration device 500 according to another example embodiment of the present disclosure may be implemented in a thin film form the same as the vibration device 500 described above with reference to FIGS. 7 to 12, and thus, may be bent in a shape corresponding to a shape of a vibration member or a vibration object, a vibration member including various curved portions may easily vibrate, and a sound characteristic and/or a sound pressure level characteristic in the low pitched sound band generated based on a vibration of the vibration member may be enhanced. In addition, the vibration device 500 according to another example embodiment of the present disclosure may include the first and second vibration generating portions 500A and 500B arranged (or tiled) at a certain interval D1 so as to be implemented as one single vibrator without being independently driven, and thus, may be driven as a large-area vibration body based on a single-body vibration of the first and second vibration generating portions 500A and 500B.

The vibration device 500 according to an example embodiment of the present disclosure may further include a pad 580 disposed at the rear surface of the first and second vibration generating portions 500A and 500B. For example, the pad 580 may be disposed at the center portion of the first and second vibration generating portions 500A and 500B.

Referring to FIG. 13B, the vibration device 500 according to an example embodiment of the present disclosure may include a first vibration generating portion 500A, a second vibration generating portion 500B, a third vibration generating portion 500C, and a fourth vibration generating portion 500D.

The first vibration generating portion 500A, the second vibration generating portion 500B, the third vibration generating portion 500C, and the fourth vibration generating portion 500D may be spaced apart from and electrically disconnected (or isolated) from each other in a first direction X and a second direction Y. Each of the first and second vibration generating portions 500A and 500B and each of the third and fourth vibration generating portions 500C and 500D may be spaced apart from and electrically disconnected (or isolated) from each other in a first direction X.

For example, the first and second vibration generating portions 500A and 500B may be arranged or tiled at a certain interval D1 in the first direction X, the third and fourth vibration generating portions 500C and 500D may be arranged or tiled at a certain interval D1 in the first direction X. For example, the first and second vibration generating portions 500A and 500B may be arranged or tiled at a certain interval D2 in the first direction Y, the third and fourth vibration generating portions 500C and 500D may be arranged or tiled at a certain interval D2 in the first direction Y.

Accordingly, the vibration device 500 where first vibration generating portion 500A, the second vibration generating portion 500B, the third vibration generating portion 500C, and the fourth vibration generating portion 500D are tiled may be a vibration array, a vibration array portion, a vibration module array portion, a vibration array structure, a tiling vibration array, a tiling array module, or a tiling vibration film.

The vibration device 500 according to an example embodiment of the present specification may further include a pad 580 on a rear surface of the first vibration generating portion 500A, the second vibration generating portion 500B, the third vibration generating portion 500C, and the fourth vibration generating portion 500D. For example, the pad 580 may be disposed at the center of the first and second vibration generating portions 500A and 500B.

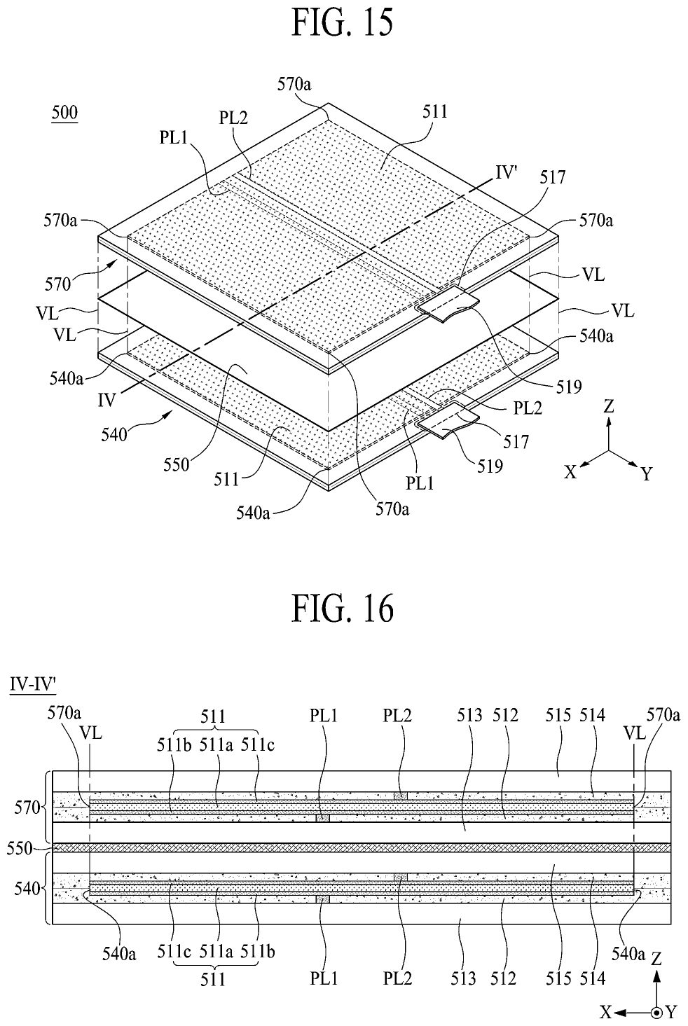

Except for the structure of the vibration generating portion that is separately disposed, the second vibration device 500 of FIG. 13B is substantially the same as the second vibration device 500 described with reference to FIG. 13A, since the cross-sectional view taken along line of FIG. 13B has the same configuration (or structure) as that of the cross-sectional view of FIG. 13A described with reference to FIG. 14, and thus, same reference numerals refer to same elements and their repeated descriptions may be omitted for brevity. FIG. 15 is a perspective view of a vibration portion of a vibration device according to an example embodiment of the present disclosure, and FIG. 16 is an example of a cross-sectional view taken along line IV-IV′ of FIG. 15.

Referring to FIGS. 15 and 16, the vibration device 500 according to an example embodiment of the present disclosure may include two or more vibration generators (for example, first and second vibration generators) 540 and 570 which are stacked to be displaced (or vibrated or driven) in the same direction.

According to an example embodiment of the present disclosure, the first vibration generator 540 may be connected to a rear surface of a display member 100 or disposed at a rear surface of a display member 100 by a connection member 550 (or a first connection member). The second vibration generator 570 may be disposed or attached on the first vibration generator 540 by a connection member 550 (or a third connection member).

According to an example embodiment of the present disclosure, the connection member 550 (or a coupling member or an intermediate member or an adhesive member) may include a material including an adhesive layer which is good in adhesive force or attaching force with respect to each of the plurality of vibration generators 540 and 570. For example, the connection member 550 may include a foam pad, a double-sided tape, an adhesive, or the like, but embodiments of the present disclosure are not limited thereto. For example, the adhesive layer of the connection member 550 may include epoxy, acrylic, silicone, or urethane, but embodiments of the present disclosure are not limited thereto. For example, the adhesive layer of the connection member 550 may include a urethane-based material which has a higher ductile characteristic than an acrylic-based material. Accordingly, the vibration loss caused by displacement interference between the plurality of vibration generators 540 and 570 may be minimized, or each of the plurality of vibration generators 540 and 570 may be freely displaced.

According to another example embodiment of the present disclosure, the connection member 550 may include one or more of a thermo-curable adhesive, a photo-curable adhesive, and a thermal bonding adhesive. For example, the connection member 550 may include the thermal bonding adhesive. The thermal bonding adhesive may be a heat-active type or a thermo-curable type. For example, the connection member 550 including the thermal bonding adhesive may attach or couple two adjacent vibration generators 540 and 570 by heat and pressure. The plurality of vibration generators 540 and 570 according to an example embodiment of the present disclosure may be integrated as one structure (or an element or a component) by a laminating process using the connection member 550. For example, the plurality of vibration generators 540 and 570 may be integrated as one structure by a laminating process using a roller.

For example, the plurality of vibration generators 540 and 570 may be implemented so that the plurality of vibration generators 540 and 570 overlap or are stacked to have the same driving direction, and thus, a driving force of each of the plurality of vibration generators 540 and 570 may increase or may be maximized, thereby enhancing one or more of a sound pressure level characteristic of a sound and a sound characteristic of a middle-low-pitched sound band generated by the vibration member or plate 501 based on vibrations of the plurality of vibration generators 540 and 570. For example, the middle-low-pitched sound band may be 200 Hz to 1 kHz, but embodiments of the present disclosure are not limited thereto. For example, a high-pitched sound band may be 1 kHz or more or 3 kHz or more, but embodiments of the present disclosure are not limited thereto.

Each of the first and second vibration generators 540 and 570 according to an example embodiment of the present disclosure may include a plurality of vibration generating portions 500A and 500B. Each of the plurality of vibration generating portions 500A and 500B may include a vibration device, a first cover member 513, and a second cover member 515.

The vibration generating portions 500A and 500B (or a vibration device) according to an example embodiment of the present disclosure may include a vibration portion 511a, a first electrode portion 511b disposed at a first surface of the vibration portion 511a, and a second electrode portion 511c disposed at a second surface, which is opposite to the first surface, of the vibration portion 511a. The vibration portion 511a may be configured to be substantially equal to one of the vibration portions 511a described above with reference to FIGS. 9 to 12, and thus, same reference numerals refer to same elements and their repeated descriptions may be omitted for brevity.

The first electrode portion 511b may be disposed at a first surface (or an upper surface or a front surface) of the vibration portion 511a. The second electrode portion 511c may be disposed on a second surface (or a rear surface), which is opposite to the first surface, of the vibration portion 511a. The first electrode portion 511b and the second electrode portion 511c may be substantially the same as descriptions of the first electrode portion 511b and the second electrode portion 511c described above with reference to FIGS. 7 and 8, and thus, same reference numerals refer to same elements and their repeated descriptions may be omitted for brevity.

In each of the first and second vibration generators 540 and 570, the first electrode portion 511b may be disposed closer to the display member 100 than the second electrode portion 511c, but embodiments of the present disclosure are not limited thereto. For example, in the second vibration device 500 including the first and second vibration generators 540 and 570 according to an example embodiment of the present disclosure, the first electrode portion 511b of each of the first and second vibration generators 540 and 570 may be disposed closer to the display member 100 than the second electrode portion 511c.

The vibration generating portions 500A and 500B (or the vibration portion 511a) of the first vibration generator 540 may have the same size as that of the vibration device 511 (or the vibration portion 511a) of the second vibration generator 570. In order to maximize or increase a displacement amount or an amplitude displacement of the vibration device 500, the vibration generating portions 500A and 500B (or the vibration portion 511a) of the first vibration generator 540 may substantially overlap the vibration device 511 (or the vibration portion 511a) of the second vibration generator 570 not to be staggered. For example, the vibration generating portions 500A and 500B (or the vibration portion 511a) of the first vibration generator 540 may substantially overlap the vibration device 511 (or the vibration portion 511a) of the second vibration generator 570 not to be staggered within an error range in a manufacturing process. For example, the vibration generating portions 500A and 500B (or the vibration portion 511a) of the first vibration generator 540 and the vibration generating portions 500A and 500B (or the vibration portion 511a) of the second vibration generator 570 may be implemented in a stack structure which overlap not to be staggered and to have the same size, and thus, a displacement amount or an amplitude displacement of the vibration device 500 may be maximized or increase. For example, the vibration generating portions 500A and 500B (or the vibration portion 511a) of the first vibration generator 540 and the vibration generating portions 500A and 500B (or the vibration portion 511a) of the second vibration generator 570 may be implemented in a stack structure which accurately overlap not to be staggered and to have the same size, and thus, a displacement amount or an amplitude displacement of the vibration device 500 may be maximized or increase.

According to an example embodiment of the present disclosure, a first portion (end or outer surface or each edge portion or periphery portion) 540a of each of the vibration generating portions 500A and 500B (or the vibration portion 511a) of the first vibration generator 540 may be aligned in a virtual extension line VL (or vertical lines, or overlapping lines) or may be disposed in the virtual extension line VL. For example, the first portion (end or outer surface or each edge portion or periphery portion) 540a of each of the vibration generating portions 500A and 500B (or the vibration portion 511a) of the first vibration generator 540 may be accurately aligned in the virtual extension line VL or may be accurately disposed in the virtual extension line VL. A second portion (end or outer surface or each edge portion or periphery portion) 570a of each of the vibration generating portions 500A and 500B (or the vibration portion 511a) of the second vibration generator 570 may be aligned in the virtual extension line VL or may be disposed in the virtual extension line VL. For example, the second portion (end or outer surface or each edge portion or periphery portion) 570a of each of the vibration generating portions 500A and 500B (or the vibration portion 511a) of the second vibration generator 570 may be accurately aligned in the virtual extension line VL or may be accurately disposed in the virtual extension line VL. The first portion 540a of each of the vibration generating portions 500A and 500B (or the vibration portion 511a) of the first vibration generator 540 may be aligned with or overlap the second portion 570a of each of the vibration generating portions 500A and 500B (or the vibration portion 511a) of the second vibration generator 570. For example, the first portion 540a of each of the vibration generating portions 500A and 500B (or the vibration portion 511a) of the first vibration generator 540 may be accurately aligned with or overlap the second portion 570a of each of the vibration generating portions 500A and 500B (or the vibration portion 511a) of the second vibration generator 570. For example, the first portion 540a of each of the vibration generating portions 500A and 500B (or the vibration portion 511a) of the first vibration generator 540 may correspond to the second portion 570a of each of the vibration generating portions 500A and 500B (or the vibration portion 511a) of the second vibration generator 570. Accordingly, in the vibration device according to an example embodiment of the present disclosure, the vibration generating portions 500A and 500B (or a first vibration portion) of the first vibration generator 540 and the vibration generating portions 500A and 500B (or a second vibration portion) of the second vibration generator 570 may be displaced in the same direction, and thus, a displacement amount or an amplitude displacement may be maximized or increase. Therefore, a displacement amount (or a bending force) or an amplitude displacement of the display member 100 may increase (or be maximized).

In the first vibration generator 540, a first cover member 513 may be disposed on the first electrode portion 511b and may protect the first electrode portion 511b. A second cover member 515 may be disposed on the second electrode portion 511c. The second cover member 515 may protect the second electrode portion 511c. For example, each of the first cover member 513 and the second cover member 515 of the first vibration generator 540 may include a plastic material, a fiber material, or a wood material, but embodiments of the present disclosure are not limited thereto. For example, in the first vibration generator 540, the first cover member 513 may include a material which is the same as or different from that of the second cover member 515. One or more of the first cover member 513 and the second cover member 515 of the first vibration generator 540 may be connected or coupled to a rear surface of the display member 100 by a connection member 550 (or a third connection member). For example, the first cover member 513 of the first vibration generator 540 may be connected or coupled to the rear surface of the display member 100 by the connection member 550 (or the third connection member).

In the second vibration generator 570, a first cover member 513 may be disposed on the first electrode portion 511b. The first cover member 513 may protect the first electrode portion 511b. A second cover member 515 may be disposed on the second electrode portion 511c. The second cover member 515 may protect the second electrode portion 511c. For example, each of the first cover member 513 and the second cover member 515 of the second vibration generator 570 may include a plastic material, a fiber material, or a wood material, but embodiments of the present disclosure are not limited thereto. For example, in the second vibration generator 570, the first cover member 513 may include a material which is the same as or different from that of the second cover member 515. One or more of the first cover member 513 and the second cover member 515 of the second vibration generator 570 may be connected or coupled to a rear surface of the first vibration generator 540 by using the connection member 550 (or the third connection member). For example, the first cover member 513 of the second vibration generator 570 may be connected or coupled to the second cover member 515 of the first vibration generator 540 by the connection member 550 (or the third connection member).

In each of the first and second vibration generators 540 and 570, each of the first cover member 513 and the second cover member 515 may include a plastic material. For example, each of the first cover member 513 and the second cover member 515 may be a polyimide film or a polyethylene terephthalate film, but embodiments of the present disclosure are not limited thereto.

One or more of the first and second vibration generators 540 and 570 according to an example embodiment of the present disclosure may further include a first adhesive layer 512 and a second adhesive layer 514.

Referring to FIG. 16, in the first vibration generator 540, the first adhesive layer 512 may be disposed between the vibration generating portions 500A and 500B and the first cover member 513. For example, the first adhesive layer 512 may be disposed between the first electrode portion 511b of each of the vibration generating portions 500A and 500B and the first cover member 513. The first cover member 513 may be disposed on a first surface (or the first electrode portion 511b) of the vibration portion 511a by the first adhesive layer 512. For example, the first cover member 513 may be coupled or connected to the first surface (or the first electrode portion 511b) of the vibration portion 511a by a laminating process using the first adhesive layer 512.

In the first vibration generator 540, the second adhesive layer 514 may be disposed between the vibration generating portions 500A and 500B and the second cover member 515. For example, the second adhesive layer 514 may be disposed between the second electrode portion 511c of each of the vibration generating portions 500A and 500B and the second cover member 515. For example, the second protection member 215 may be coupled or connected to a second surface (or the second electrode portion 511c) of the vibration portion 511a by a laminating process using a second adhesive layer 514.

In the first vibration generator 540, the first adhesive layer 512 and the second adhesive layer 514 may be connected or coupled to each other between the first cover member 513 and the second cover member 515. For example, in the first vibration generator 540, the first adhesive layer 512 and the second adhesive layer 514 may be connected or coupled to each other at an edge portion (or a periphery portion) between the first cover member 513 and the second cover member 515. Therefore, in the first vibration generator 540, the vibration generating portions 500A and 500B may be surrounded by the first adhesive layer 512 and the second adhesive layer 514. For example, the first adhesive layer 512 and the second adhesive layer 514 may fully or entirely surround all of the vibration generating portions 500A and 500B of the first vibration generator 540. For example, the first adhesive layer 512 and the second adhesive layer 514 may be provided as one adhesive layer.

In the second vibration generator 570, the first adhesive layer 512 may be disposed between the vibration generating portions 500A and 500B and the first cover member 513. For example, the first adhesive layer 512 may be disposed between the first electrode portion 511b of each of the vibration generating portions 500A and 500B and the first cover member 513. The first cover member 513 may be disposed on a first surface (or the first electrode portion 511b) of the vibration portion 511a by the first adhesive layer 512. For example, the first cover member 513 may be coupled or connected to the first surface (or the first electrode portion 511b) of each of the vibration generating portions 500A and 500B by a laminating process using the first adhesive layer 512.

In the second vibration generator 570, the second adhesive layer 514 may be disposed between the vibration generating portions 500A and 500B and the second cover member 515. For example, the second adhesive layer 514 may be disposed between the second electrode portion 511c of each of the vibration generating portions 500A and 500B and the second cover member 515. The second cover member 515 may be disposed on a second surface (or the second electrode portion 511c) of each of the vibration generating portions 500A and 500B by the second adhesive layer 514. For example, the second cover member 515 may be coupled or connected to the second surface (or the second electrode portion 511c) of each of the vibration generating portions 500A and 500B by a laminating process using the second adhesive layer 514.

In the second vibration generator 570, the first adhesive layer 512 and the second adhesive layer 514 may be connected or coupled to each other between the first cover member 513 and the second cover member 515. For example, in the second vibration generator 570, the first adhesive layer 512 and the second adhesive layer 514 may be connected or coupled to each other at an edge portion (or a periphery portion) between the first cover member 513 and the second cover member 515. Therefore, in the second vibration generator 570, the vibration generating portions 500A and 500B may be surrounded by the first adhesive layer 512 and the second adhesive layer 514. For example, the first adhesive layer 512 and the second adhesive layer 514 may fully or entirely surround all of the vibration generating portions 500A and 500B of the second vibration generator 570. For example, the first adhesive layer 512 and the second adhesive layer 514 may be provided as one adhesive layer.

In each of the first and second vibration generators 540 and 570, each of the first adhesive layer 512 and the second adhesive layer 514 may include an electrical insulation material. For example, the electrical insulation material may include a material which has adhesive properties and is capable of compression and decompression. For example, one or more of the first adhesive layer 512 and the second adhesive layer 514 may include epoxy resin, acrylic resin, silicone resin, or urethane resin, but embodiments of the present disclosure are not limited thereto.

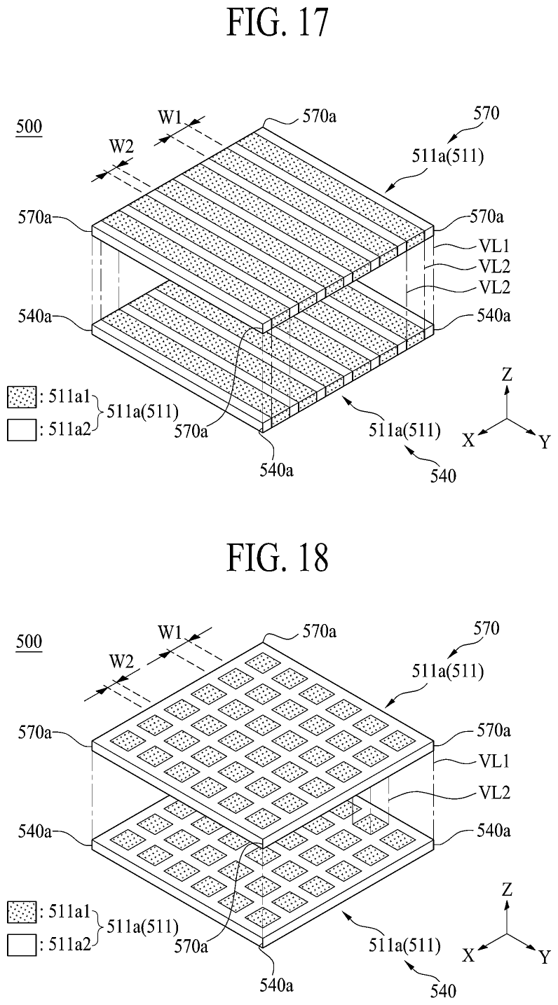

FIG. 17 is a perspective view of a vibration portion of a vibration device according to an example embodiment of the present disclosure.

Referring to FIG. 17, a vibration portion 511a according to an example embodiment of the present disclosure may include a plurality of first portions 511a1 and a plurality of second portions 511a2. For example, the plurality of first portions 511a1 and the plurality of second portions 511a2 may be alternately and repeatedly arranged in a second direction Y (or a first direction X). For example, the first direction X may be a widthwise direction of the vibration portion 511a and the second direction Y may be a lengthwise direction of the vibration portion 511a intersecting with the first direction X, but embodiments of the present disclosure are not limited thereto. For example, the first direction X may be a lengthwise direction of the vibration portion 511a, and the second direction Y may be a widthwise direction of the vibration portion 511a. For example, the first portion 511a1 may be a piezoelectric portion, a piezoelectric element, an inorganic portion, an inorganic material portion, a piezoelectric layer, a vibration layer, a displacement layer, or a displacement element, but the terms are not limited thereto. For example, the second portion 511a2 may be a ductile portion, an elastic portion, a extendable portion, an organic portion, an organic material portion, a damping portion, a bending portion, or a bounce portion, but the terms are not limited thereto.

Each of the plurality of first portions 511a1 may include an inorganic material portion. For example, the inorganic material portion may include a material described above. Each of the plurality of second portions 511a2 may include an organic material portion. The organic material portion may include a material described above.

Each of the plurality of first portions 511a1 according to an example embodiment of the present disclosure may be disposed between the plurality of second portions 511a2. The plurality of first portions 511a1 and the plurality of second portions 511a2 may be substantially the same as the plurality of first portions 511a1 and the plurality of second portions 511a2 described above with reference to FIG. 9, and thus, their repeated descriptions may be omitted for brevity.

A vibration device 511 of a first vibration generator 540 and a vibration device 511 of a second vibration generator 570 may have the same size and may overlap, so as to maximize or increase a displacement amount or an amplitude displacement of a second vibration device 500. For example, a first portion (end or outer surface or each edge portion or periphery portion) 540a of the vibration device 511 (or the vibration portion 511a) of the first vibration generator 540 may be aligned with or overlap a second portion (end or outer surface or each edge portion or periphery portion) 570a of the vibration device 511 (or the vibration portion 511a) of the second vibration generator 570. For example, the first portion (end or outer surface or each edge portion or periphery portion) 540a of the vibration device 511 (or the vibration portion 511a) of the first vibration generator 540 may be aligned with or overlap the second portion (end or outer surface or each edge portion or periphery portion) 570a of the vibration device 511 (or the vibration portion 511a) of the second vibration generator 570 within an error range in a manufacturing process without being staggered. For example, the first portion (end or outer surface or each edge portion or periphery portion) 540a of the vibration device 511 (or the vibration portion 511a) of the first vibration generator 540 may be aligned in a virtual first extension line VL1 or may be disposed in the virtual first extension line VL1. The first portion (end or outer surface or each edge portion or periphery portion) 540a of the vibration device 511 (or the vibration portion 511a) of the first vibration generator 540 may be accurately aligned in the virtual first extension line VL1 or may be accurately disposed in the virtual first extension line VL1. A second portion (end or outer surface or each edge portion or periphery portion) 570a of a vibration device 511 (or the vibration portion 511a) of a second vibration generator 570 may be aligned in the virtual first extension line VL1 or may be disposed in the virtual first extension line VL1. For example, the second portion (end or outer surface or each edge portion or periphery portion) 570a of the vibration device 511 (or the vibration portion 511a) of the second vibration generator 570 may be accurately aligned in the virtual first extension line VL1 or may be accurately disposed in the virtual first extension line VL1.

According to an example embodiment of the present disclosure, a plurality of first portions 511a1 of the first vibration generator 540 and a plurality of first portions 511a1 of the second vibration generator 570 may have the same size as or may substantially overlap. For example, the plurality of first portions 511a1 of the first vibration generator 540 and the plurality of first portions 511a1 of the second vibration generator 570 may have the same size as or may substantially overlap without being staggered. According to an example embodiment of the present disclosure, a first portion (end or outer surface or each edge portion or periphery portion) of each of the plurality of first portions 511a1 of the first vibration generator 540 may substantially overlap a first portion (end or outer surface or each edge portion or periphery portion) of each of the plurality of first portions 511a1 of the second vibration generator 570. For example, the first portion (end or outer surface or each edge portion or periphery portion) of each of the plurality of first portions 511a1 of the first vibration generator 540 may substantially overlap the first portion (end or outer surface or each edge portion or periphery portion) of each of the plurality of first portions 511a1 of the second vibration generator 570 without being staggered. For example, the first portion (end or outer surface or each edge portion or periphery portion) of each of the plurality of first portions 511a1 of the first vibration generator 540 and the first portion (end or outer surface or each edge portion or periphery portion) of each of the plurality of first portions 511a1 of the second vibration generator 570 may be aligned in a second extension line VL2 or may be disposed in the second extension line VL2. For example, the first portion (end or outer surface or each edge portion or periphery portion) of each of the plurality of first portions 511a1 of the first vibration generator 540 and the first portion (end or outer surface or each edge portion or periphery portion) of each of the plurality of first portions 511a1 of the second vibration generator 570 may be accurately aligned in the second extension line VL2 or may be accurately disposed in the second extension line VL2.

According to an example embodiment of the present disclosure, a plurality of second portions 511a2 of the first vibration generator 540 and a plurality of second portions 511a2 of the second vibration generator 570 may have the same size as or may substantially overlap. For example, the plurality of second portions 511a2 of the first vibration generator 540 and the plurality of second portions 511a2 of the second vibration generator 570 may have the same size as or may substantially overlap without being staggered. According to an example embodiment of the present disclosure, a first portion (end or outer surface or each edge portion or periphery portion) of each of the plurality of second portions 511a2 of the first vibration generator 540 may substantially overlap a first portion (end or outer surface or each edge portion or periphery portion) of each of the plurality of second portions 511a2 of the second vibration generator 570 without being staggered. For example, the first portion (end or outer surface or each edge portion or periphery portion) of each of the plurality of second portions 511a2 of the first vibration generator 540 may substantially overlap the first portion (end or outer surface or each edge portion or periphery portion) of each of the plurality of second portions 511a2 of the second vibration generator 570 without being staggered. For example, the first portion (end or outer surface or each edge portion or periphery portion) of each of the plurality of second portions 511a2 of the first vibration generator 540 and the first portion (end or outer surface or each edge portion or periphery portion) of each of the plurality of second portions 511a2 of the second vibration generator 570 may be aligned in the second extension line VL2 or may be disposed in the second extension line VL2. For example, the first portion (end or outer surface or each edge portion or periphery portion) of each of the plurality of second portions 511a2 of the first vibration generator 540 and the first portion (end or outer surface or each edge portion or periphery portion) of each of the plurality of second portions 511a2 of the second vibration generator 570 may be accurately aligned in the second extension line VL2 or may be accurately disposed in the second extension line VL2. Accordingly, in the second vibration device 500 according to an example embodiment of the present disclosure, the vibration portion 511a of the first vibration generator 540 and the vibration portion 511a of the second vibration generator 570 may be displaced (or vibrated or driven) in the same direction, and thus, a displacement amount or an amplitude displacement may be maximized or increase. Therefore, a displacement amount (or a bending force) or an amplitude displacement of the display member 100 may increase (or maximized).

In FIG. 17 and relevant descriptions, a vibration device 500 according to another example embodiment of the present disclosure is described as including first and second vibration generators 540 and 570, but embodiments of the present disclosure are not limited thereto. For example, the vibration device 500 according to another example embodiment of the present disclosure may include a plurality of (for example, three or more) vibration generators 540 and 570. Even in this case, in order to maximize or increase a displacement amount or an amplitude displacement of the vibration device 500, the plurality of vibration generators 540 and 570 may have the same size and may overlap. According to an example embodiment of the present disclosure, a first portion 511a1 of the vibration generator 540 disposed in an upper layer (or a top layer) among the three or more vibration generators 540 and 570 and a first portion 511a1 of the vibration generator 570 disposed in a lower layer (or a bottom layer) among the three or more vibration generators 540 and 570 may substantially overlap. For example, the first portion 511a1 of the vibration generator 540 disposed in the upper layer (or the top layer) among the three or more vibration generators 540 and 570 and the first portion 511a1 of the vibration generator 570 disposed in the lower layer (or the bottom layer) among the three or more vibration generators 540 and 570 may substantially overlap without being staggered. For example, the first portion 511a1 of the vibration generator 540 disposed in the upper layer (or the top layer) among the three or more vibration generators 540 and 570 and the first portion 511a1 of the vibration generator 570 disposed in the lower layer (or the bottom layer) among the three or more vibration generators 540 and 570 may be aligned in a virtual extension line VL or may be disposed in the virtual extension line VL. For example, the first portion 511a1 of the vibration generator 540 disposed in the upper layer (or the top layer) among the three or more vibration generators 540 and 570 and the first portion 511a1 of the vibration generator 570 disposed in the lower layer (or the bottom layer) among the three or more vibration generators 540 and 570 may be accurately aligned in the virtual extension line VL or may be accurately disposed in the virtual extension line VL. In addition, a second portion 511a2 of the vibration generator 540 disposed in the upper layer (or the top layer) among the three or more vibration generators 540 and 570 and a second portion 511a2 of the vibration generator 570 disposed in the lower layer (or the bottom layer) among the three or more vibration generators 540 and 570 may substantially overlap. For example, the second portion 511a2 of the vibration generator 540 disposed in the upper layer (or the top layer) among the three or more vibration generators 540 and 570 and the second portion 511a2 of the vibration generator 570 disposed in the lower layer (or the bottom layer) among the three or more vibration generators 540 and 570 may substantially overlap without being staggered. For example, the second portion 511a2 of the vibration generator 540 disposed in the upper layer (or the top layer) among the three or more vibration generators 540 and 570 and the second portion 511a2 of the vibration generator 570 disposed in the lower layer (or the bottom layer) among the three or more vibration generators 540 and 570 may be aligned in the virtual extension line VL or may be disposed in the virtual extension line VL. For example, the second portion 511a2 of the vibration generator 540 disposed in the upper layer (or the top layer) among the three or more vibration generators 540 and 570 and the second portion 511a2 of the vibration generator 570 disposed in the lower layer (or the bottom layer) among the three or more vibration generators 540 and 570 may be accurately aligned in the virtual extension line VL or may be accurately disposed in the virtual extension line VL.

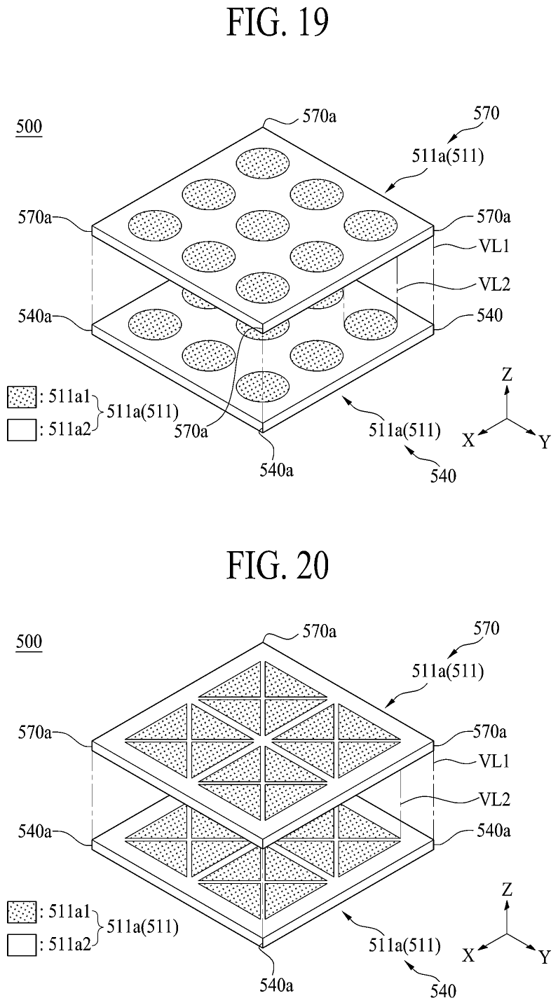

FIGS. 18 to 20 are perspective views of the vibration portion of the vibration device according to one or more example embodiments of the present disclosure. A vibration portion 511a of a vibration device 500 prepared based on FIGS. 18 to 20 may be an example embodiment where the vibration device 500 illustrated in, or similarly illustrated in, FIGS. 10 to 12 are configured with two vibration generators and which is implemented by modifying a shape of the vibration portion 511a of the vibration device 500 illustrated in FIG. 17. Therefore, descriptions of FIGS. 18 to 20 are substantially the same or similar to those of the earlier descriptions (e.g., descriptions of FIGS. 10 to 12), and thus, may be omitted for brevity.

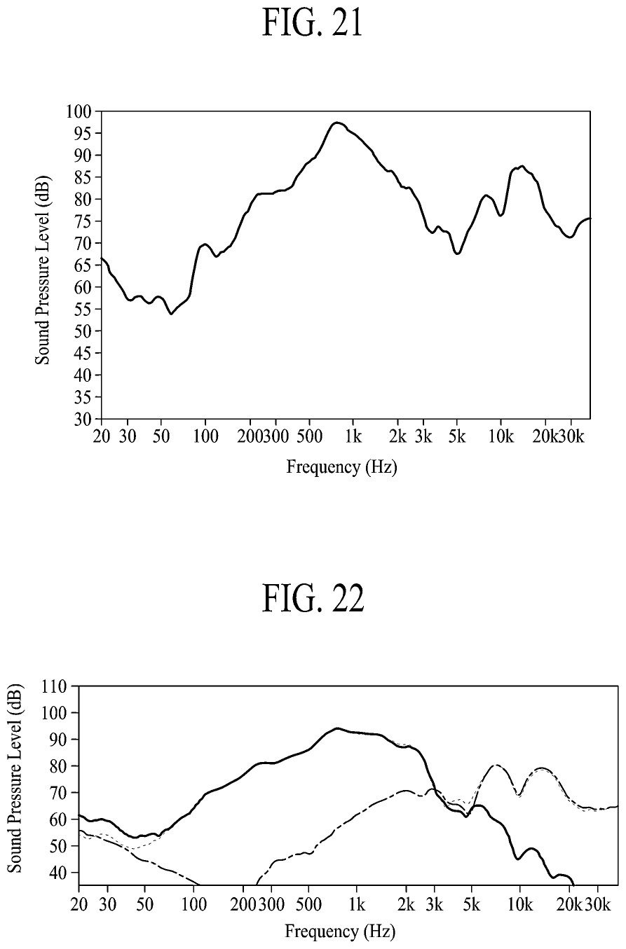

FIG. 21 is a graph showing a sound pressure level characteristic of an apparatus according to an example embodiment of the present disclosure.

A sound output characteristic may be measured by a sound analysis apparatus. For a sound pressure measurement, an APX525 device from Audio Precision as a commercial equipment, was used, the input voltage was set to 10 Vrms, and it was converted to EQ (equalizer). A sine sweep was applied by amplifying a signal to the second vibration device 500 in the range of 10 Hz to 40 kHz, and the average sound pressure was measured using a microphone at a position 0.5 m away from the vibration object. The measured sound pressure was corrected by ⅓ octave smoothing, and the sound pressure was measured in a half an echoic chamber. The sound analysis apparatus may include a sound card which transmits or receives a sound to or from a control personal computer (PC), an amplifier which amplifies a signal generated from the sound card and transfers the amplified signal to a vibration device, and a microphone which collects a sound generated by the vibration device in a display panel. For example, the microphone may be disposed at a center of the vibration device, and a distance between the display panel and the microphone may be about 50 cm. A sound may be measured in a state where the microphone is vertical to the vibration device. The sound collected by the microphone may be input to the control PC through the sound card, and the sound of the vibration device may be analyzed using a control program. For example, a frequency response characteristic of a frequency range of 20 Hz to 20 kHz may be measured by using a pulse program. In FIG. 21, the horizontal axis represents a frequency (Hz: Hertz), and the vertical axis represents a sound pressure level (SPL) (dB: decibel).

Referring to FIGS. 2C, 5A, 5B, and 21 and other related figures, in an apparatus according to an example embodiment of the present disclosure, a first vibration device 400 may be disposed in sixth, seventh, tenth, and eleventh regions of a rear cover 300, based on a natural frequency mode shape of a light guide plate 131, and thus, the low pitched sound performance of a sound may be secured. In addition, in the apparatus according to an example embodiment of the present disclosure, a plate 501 (which is connected to the second vibration device 500) including a material having excellent high pitched sound transmission performance may be disposed at a corner of the rear cover 300, and thus, a vibration transfer efficiency and/or a vibration transfer characteristic of a second vibration device 500 having high pitched sound performance may be maximized, thereby enhancing a sound pressure level characteristic of a frequency band of 100 Hz to 40 kHz.

FIG. 22 is an example of a graph showing a sound pressure level characteristic of a first vibration device, a second vibration device, and an apparatus provided based on FIG. 2A.

A measurement method for a sound output characteristic may be the same as details described above with reference to FIG. 21, and thus, may be omitted for brevity. In FIG. 22, the horizontal axis represents a frequency (Hz), and the vertical axis represents a sound pressure level (SPL) (dB).

A thick solid line in FIG. 22 represents a sound output characteristic of the first vibration device 400 disposed in the sixth region 6 of the apparatus of FIG. 2A, a dash-single dotted line represents a sound output characteristic of the second vibration device 500 disposed in the first region 1 of the apparatus of FIG. 2A, and a dotted line represents a sound output characteristic of the apparatus of FIG. 2A.

Referring to FIG. 22, when the first vibration device 400 is disposed in the sixth region 6, it has been confirmed that a sound output characteristic of a high pitched sound band is not sufficiently secured. In addition, when the second vibration device 500 is disposed in the first region 1, it has been confirmed that a sound output characteristic of a middle-low pitched sound band is not sufficiently secured. Furthermore, in a case where the first vibration device 400 and the second vibration device 500 are simultaneously disposed, it has been confirmed that a sound output characteristic of about 70 dB is secured in a frequency of about 100 Hz and a sound output characteristic of about 70 dB is secured in a frequency of 3 kHZ to 40 kHZ which is a high pitched sound band. In this case, a sound output characteristic of about 70 dB may be a reference value or a tuning target value for securing a sound output characteristic in a frequency range of 100 Hz to 20 kHz or 100 Hz to 40 kHz.

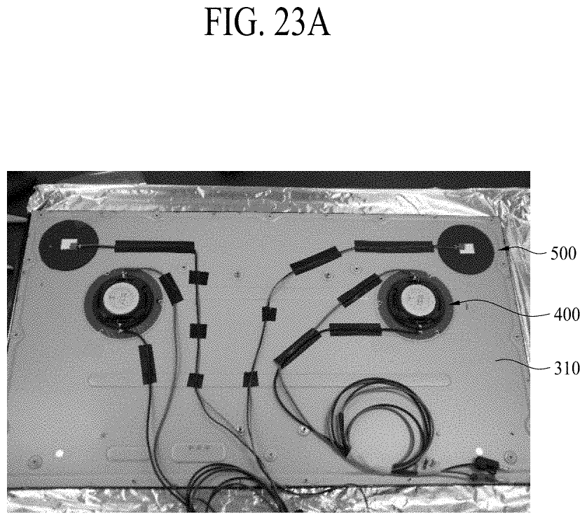

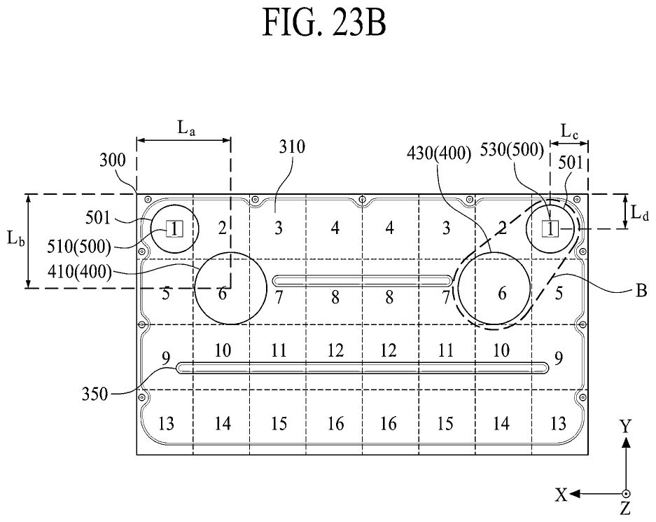

FIG. 23A is a photograph of an apparatus according to an example embodiment of the present disclosure.

Referring to FIG. 23A, an apparatus according to an example embodiment of the present disclosure may include one pair of the first vibration device 400, and one pair of the second vibration device 500 disposed at the rear cover part 310. The first vibration device 400 is disposed between a sixth region 6 and a seventh region 7, and the second vibration device 500 is disposed in the first region 1 as described above with reference to FIG. 2C.

FIG. 23B illustrates a vibration device at a rear cover of an apparatus according to an example embodiment of the present disclosure.

Referring to FIG. 23B, in a display apparatus for close-distance viewing, an audible position of a user may be close thereto, and thus, a distance between a first vibration device 400 and a second vibration device 500 may be important in this example. Position recognition of a voice or a sound may be performed in one half (½) of a wavelength. Herein, a high pitched sound may be transmitted and transferred by a display member 100 and may be radiated using a mechanism or structure transfer (corner portion) of the apparatus 10, and thus, a high pitched sound radiation center point may be disposed at a corner end (or a corner portion) of the display member 100 or the apparatus 10 and a distance between the corner end (or corner portion) of the apparatus 10 and the first vibration device 400 may be a factor important for determining a position of a sound. A natural voice frequency band of a person may be about 8 kHz band and it is required to recognize radiation of a voice occurring in a screen, and thus, radiation of a voice should be one half (½) of 428 mm which a sound wavelength of 8 kHz. A sound wavelength may denote a distance per one cycle of a sound wave.

A length from a center point of the first vibration device 400 to a corner adjacent thereto in a second direction Y may be defined as L_{b}, a length to a corner adjacent thereto in a first direction X may be defined as Lₐ, a length from a center point of the second vibration device 500 to a corner adjacent thereto in the second direction Y may be defined as L_{d}, and a length to a corner adjacent thereto in the first direction X may be defined as L_{c}. In a case where a calculation value of the following Equation 1 is calculated based on the lengths Lₐ, L_{b}, L_{c}, and L_{d} of the first vibration device 400 and the second vibration device 500 defined in this manner, for example, the calculation value may be about one half (½) of 428 mm which a sound wavelength of 8 kHz, and thus, it may be recognized that radiation of a voice occurs in a screen.

\sqrt{Lₐ²+L_{b}²}−\sqrt{L_{c}²+L_{d}²}<218 mm [Equation 1]

A cross-sectional structure of the indicated portion of a region B in FIG. 23B may have the same structures as those of the apparatus comprising the first vibration device 400 and the second vibration device 500 described above with reference to FIGS. 5A and 5B, respectively.

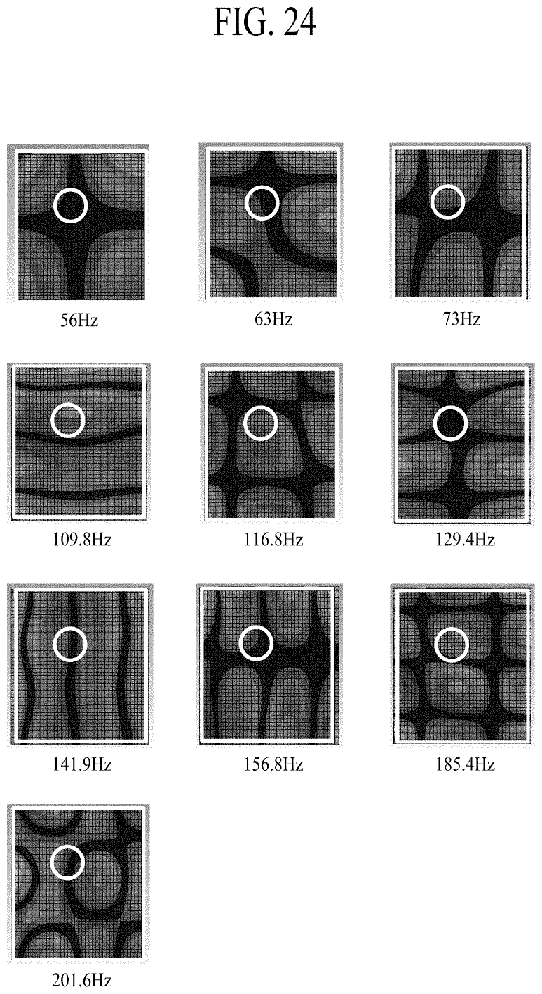

FIG. 24 illustrates an example of simulation photographs, where each photograph shows a resonance characteristic of a light guide plate of a first vibration device according to one or more example embodiments of the present disclosure. In FIG. 24, a resonance frequency at a lower region of each photograph is shown.

Referring to FIG. 24, in the resonance frequency of the first vibration device 400, an amplification of a light guide plate 131 (130) has been examined in a resonance frequency of 109.8 Hz or 116.8 Hz, and it has been seen that an undesired resonance peak is limited by being close to an anti-resonance node in a resonance frequency of 141.9 Hz or 156.8 Hz. The anti-resonance node means the maximum amplitude region between two adjacent nodes in the standing wave.

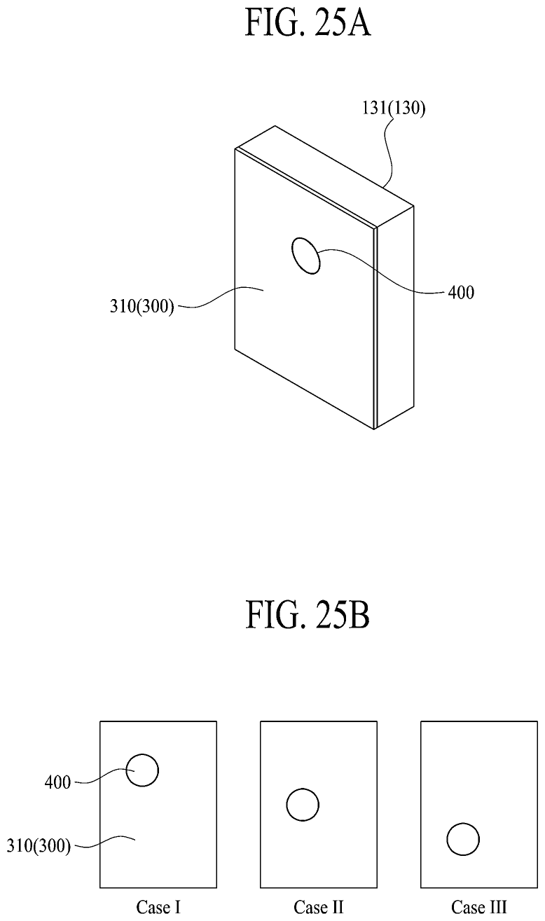

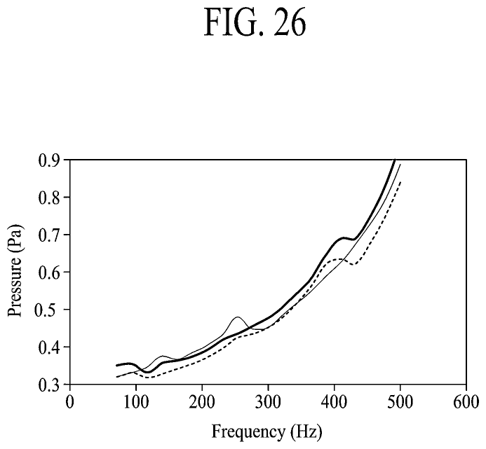

FIG. 25A is a schematic diagram of an example of a first vibration device, a rear cover, and a light guide plate of the present disclosure, FIG. 25B illustrates an example of a position change of a first vibration device at a rear cover of the present disclosure, and FIG. 26 is an example of a graph showing a sound pressure level characteristic measured under a condition of FIG. 25B. In FIGS. 25A and 25B, a change tendency of a sound characteristic based on a secondary vibration of a light guide plate 131 (130) has been confirmed through harmonic acoustic coupling analysis based on a relative position (for example, upward and downward movement) of a first vibration device 400 in a rear cover 300. In FIG. 26, when it is assumed that a supporting member (for example, a rear cover) is rigid, variations of a sound pressure level SPL caused by a vibration of the light guide plate 131 (130) based on a vibration position movement (Case I—solid line, Case II—dotted line, and Case III—solid line) have been compared by modeling internal air and front air.

In FIG. 26, the horizontal axis represents a frequency (Hz), the vertical axis represents a pressure level (Pa), and pressure level may be substituted into a sound pressure level using a certain equation.

Referring to FIGS. 25A, 25B, and 26, it may be seen that Case I is a case where a position of a first vibration device 400 is located at a relatively upper portion and a low pitched sound between 200 Hz and 300 Hz increases compared to Case II and Case III. Referring to this, it may be seen that as the position of the first vibration device 400 moves to the lower right or lower end on the rear cover 300, the frequency with which it has is moved to a relatively high frequency.

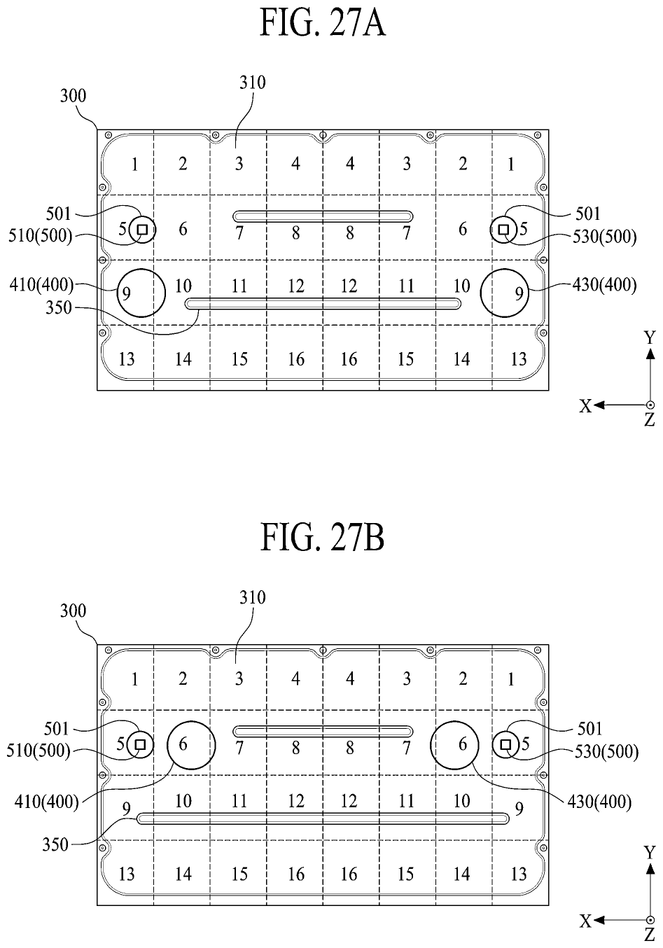

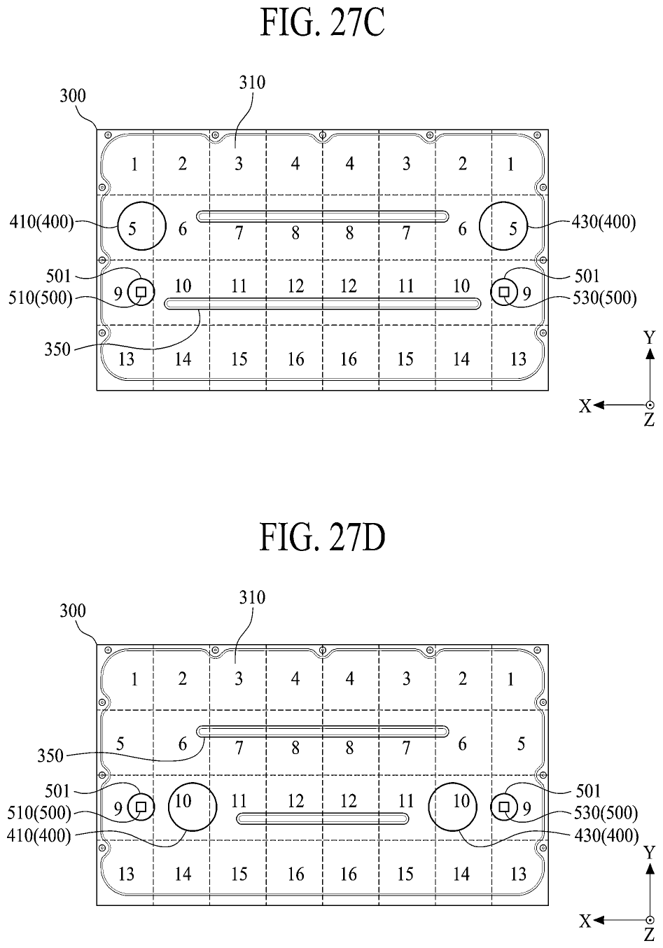

FIGS. 27A to 27D illustrate a vibration device at a rear cover of an apparatus according to one or more example embodiments of the present disclosure. In FIGS. 27A to 27D, the display module or the rear cover 300 may include a left region LA and a right region RA that are symmetrical with respect to the horizontal direction, and each of the left region LA and the right region RA may be divided into 16 equal parts, which may be defined as first to sixteenth regions 1-16.

In an apparatus provided based on FIG. 27A, comparing with the apparatus provided based on FIG. 2A, except that a first sound generating device 410 and a second sound generating device 430 of a first vibration device 400 are disposed between a ninth region 9 and a tenth region 10 and a first piezoelectric vibration device 510 and a second piezoelectric vibration device 530 of a second vibration device 500 are disposed in a fifth region 5, the apparatus of FIG. 27A may be substantially the same as the apparatus 10 described above with reference to FIG. 2, and thus, same reference numerals refer to same elements and their repeated descriptions may be omitted for brevity.

In an apparatus provided based on FIG. 27B, comparing with the apparatus provided based on FIG. 2A, except that a first sound generating device 410 and a second sound generating device 430 of a first vibration device 400 are disposed between a sixth region 6 and a seventh region 7 and a first piezoelectric vibration device 510 and a second piezoelectric vibration device 530 of a second vibration device 500 are disposed in a fifth region 5, the apparatus of FIG. 27B may be substantially the same as the apparatus 10 described above with reference to FIG. 2A, and thus, same reference numerals refer to same elements and their repeated descriptions may be omitted for brevity.

In an apparatus provided based on FIG. 27C, comparing with the apparatus provided based on FIG. 2A, except that a first sound generating device 410 and a second sound generating device 430 of a first vibration device 400 are disposed between a fifth region 5 and a sixth region 6 and a first piezoelectric vibration device 510 and a second piezoelectric vibration device 530 of a second vibration device 500 are disposed in a ninth region 9, the apparatus of FIG. 27C may be substantially the same as the apparatus 10 described above with reference to FIG. 2, and thus, same reference numerals refer to same elements and their repeated descriptions may be omitted for brevity.

In an apparatus provided based on FIG. 27D, comparing with the apparatus provided based on FIG. 2A, except that a first sound generating device 410 and a second sound generating device 430 of a first vibration device 400 are disposed between a tenth region 10 and an eleventh region 11 and a first piezoelectric vibration device 510 and a second piezoelectric vibration device 530 of a second vibration device 500 are disposed in a ninth region 9, the apparatus of FIG. 27D may be substantially the same as the apparatus 10 described above with reference to FIG. 2, and thus, same reference numerals refer to same elements and their repeated descriptions may be omitted for brevity.

FIG. 28 is an example of a graph showing a sound pressure level characteristic of the apparatus of FIGS. 27A to 27D, and Table 1 shows an example of a result of FIG. 28.

A measurement method for a sound output characteristic may be the same as details described above with reference to FIG. 21, and thus, may be omitted for brevity. In FIG. 28, the horizontal axis represents a frequency (Hz), and the vertical axis represents a sound pressure level (SPL) (dB).

TABLE 1

| | Apparatus- | Apparatus- | Apparatus- | Apparatus- |
|---|---|---|---|---|
| | FIG. 27A | FIG. 27B | FIG. 27C | FIG. 27D |
| SPL(@100 Hz) | 62.7 dB | 65.5 dB | 57.0 dB | 58.1 dB |
| Δ SPL | −2.8 dB | (reference) | −8.5 dB | −7.4 dB |
| Frequency | 145 Hz | 98 Hz | 127 Hz | 113 Hz |
| (@65 dB) | | | | |
| Δ Frequency | 50 Hz | (reference) | 29 Hz | 15 Hz |

In FIG. 28, a thick solid line represents a sound output characteristic of the apparatus of FIG. 27A, a dash-single dotted line represents a sound output characteristic of the apparatus of FIG. 27B, a thin solid line represents a sound output characteristic of the apparatus of FIG. 27C, and a dotted line represents a sound output characteristic of the apparatus of FIG. 27D.

Referring to FIG. 28, comparing with a sound pressure characteristic at 100 Hz, a highest sound pressure level of 65.5 dB has been measured in the apparatus of FIG. 27B, a sound pressure level of 62.7 dB has been measured in the apparatus of FIG. 27A, a sound pressure level of 57.0 dB has been measured in the apparatus of FIG. 27C, and a sound pressure level of 58.1 dB has been measured in the apparatus of FIG. 27D. The sound pressure level of the apparatus of FIG. 27A at 100 Hz is 2.8 dB less than that of the FIG. 27B, the sound pressure level of the apparatus of FIG. 27C at 100 Hz is 8.5 dB less than that of the FIG. 27B, and the sound pressure level of the apparatus of FIG. 27C at 100 Hz is 7.4 dB less than that of the FIG. 27B. Accordingly, it may be seen that a low pitched sound characteristic is highest in the apparatus of FIG. 27B.

Comparing with a frequency measured in 65 dB, a frequency of 98 Hz has been observed in a lowest sound in the apparatus of FIG. 27B, a frequency of 113 Hz has been observed in the apparatus of FIG. 27D, a frequency of 127 Hz has been observed in the apparatus of FIG. 27C, and a frequency of 148 Hz has been observed in the apparatus of FIG. 27A.

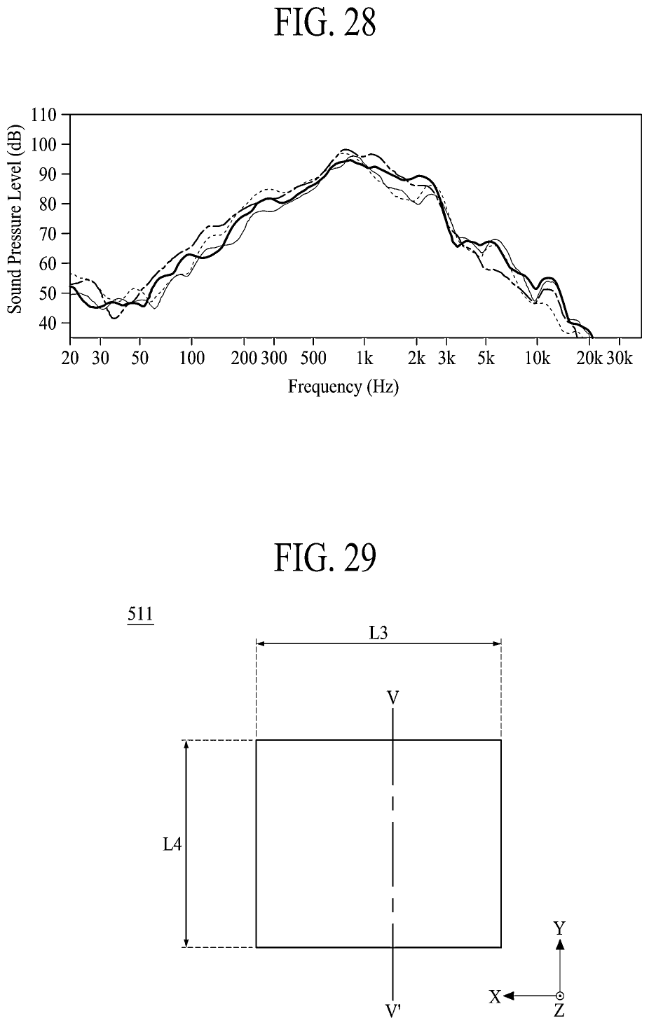

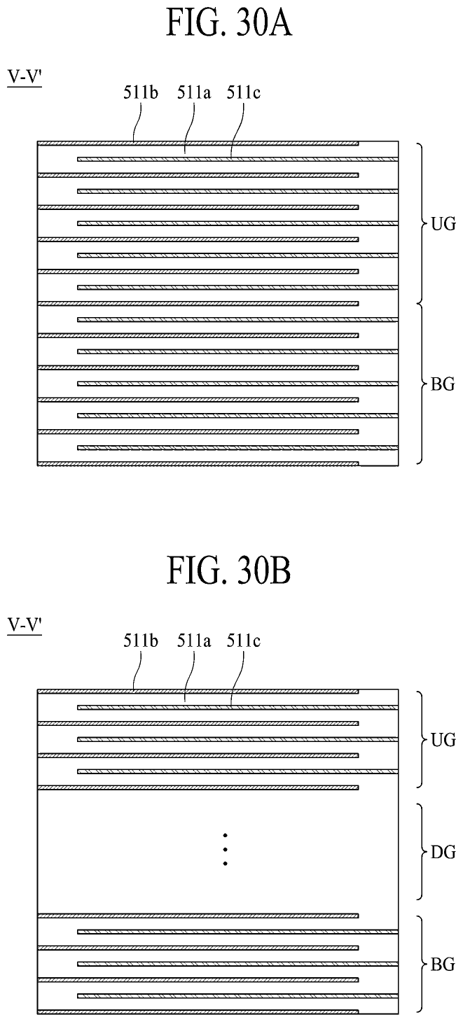

FIG. 29 illustrates an example of a piezoelectric device of a second vibration device, and FIGS. 30A and 30B are examples of cross-sectional views taken along line V-V′ of FIG. 29. The piezoelectric device of FIG. 29 is an example embodiment implemented by stacking twenty vibration portions.

Referring to FIGS. 29, 30A, and 30B, a vibration device (or piezoelectric device) 511 of a second vibration device 500 may be configured as a single layer or a multilayer. According to an example embodiment of the present disclosure, the vibration device 511 of the second vibration device 500 may be configured as a single layer or a multilayer, and at least a portion thereof may be configured as a dummy layer. The dummy layer may be disposed at a center portion of the multilayer, but embodiments of the present disclosure are not limited thereto.

The vibration device 511 according to an example embodiment of the present disclosure may have a third length L3 parallel to a first direction X and a fourth length L4 parallel to a second direction Y. For example, the third length L3 of the vibration device 511 may be shorter than the fourth length L4, but embodiments of the present disclosure are not limited thereto. For example, the third length L3 may be longer than or equal to the fourth length L4.

The vibration device 511 according to an example embodiment of the present disclosure may include a vibration portion 511a, a first electrode portion 511b, and a second electrode portion 511c, and for example, the first electrode portion 511b and the second electrode portion 511c may be disposed to engage with each other and may be disposed to be opposite to each other.

For example, the first electrode portion 511b may be disposed at a first surface (or an upper surface) of the vibration portion 511a and may be electrically connected to the first surface of the vibration portion 511a. The second electrode portion 511c may be disposed at a second surface (or a rear surface), which is opposite to the first surface, of the vibration portion 511a and may be electrically connected to the second surface of the vibration device 511. For example, the first electrode portion 511b and the second electrode portion 511c may be disposed with the vibration portion 511a therebetween. For example, the first electrode portion 511b and the second electrode portion 511c may include the same material, but embodiments of the present disclosure are not limited thereto. In another example embodiment of the present disclosure, the first electrode portion 511b and the second electrode portion 511c may include different materials.

According to an example embodiment of the present disclosure, one or more of the first electrode portion 511b and the second electrode portion 511c may include a transparent conductive material, a semitransparent conductive material, or an opaque conductive material. For example, the transparent conductive material or the semitransparent conductive material may include indium tin oxide (ITO) or indium zinc oxide (IZO), but embodiments of the present disclosure are not limited thereto. For example, the opaque conductive material may include aluminum (Al), copper (Cu), gold (Au), silver (Ag), platinum (Pt), molybdenum (Mo), magnesium (Mg), or an alloy thereof, but embodiments of the present disclosure are not limited thereto.

Referring to FIGS. 30A and 30B, a vibration device (or piezoelectric device) 511 of a second vibration device 500 may be implemented as a multi layer or a multilayer. The vibration device 511 may be implemented as a multimorph type. For example, referring to FIG. 30A, the vibration device 511 may be configured, for example, as sixteen to twenty layers and may be divided into respectively an upper group UG (or a first group) or a lower group BG (or a second group), each group comprising its respective layers. Each layer in the upper group UG and the lower group BG, as illustrated in FIG. 30A, may be the same or substantially the same. Alternatively, referring to FIG. 30B, the vibration device 511 of the second vibration device 500 may include respectively the upper group UG (or the first group) and the lower group BG (or the second group), each group comprising its respective layers and may also include a dummy group DG at a center thereof. The dummy group DG (or a third group) may not include a first electrode portion 511b and a second electrode portion 511c, and thus, the cost may be reduced. Each layer in the upper group UG and the lower group BG, as illustrated in FIG. 30B, may be the same or substantially the same.

The vibration device 511 of the second vibration device 500 may include the upper group UG (or the first group) and the lower group BG (or the second group) and may include the dummy group DG at a center thereof.

The second vibration device 500 according to an example embodiment of the present disclosure may include the vibration device 511, the vibration device 511 may include the first group and the second group, and each of the first group and the second group may include a vibration portion 511a including at least one layer having a piezoelectric characteristic, a first electrode portion 511b disposed at a first surface of the vibration portion 511a, and a second electrode portion 511c disposed at a second surface, which is opposite to the first surface, of the vibration portion 511a.

According to another example embodiment of the present disclosure, the second vibration device 500 may include the vibration device 511, the vibration device 511 may include first to third groups, and each of the first group UG and the second group BG may include a vibration portion 511a including at least one layer having a piezoelectric characteristic, a first electrode portion 511b disposed at a first surface of the vibration portion 511a, and a second electrode portion 511c disposed at a second surface, which is opposite to the first surface, of the vibration portion 511a. The third group DG may be configured with only vibration portion 511a including at least one layer having a piezoelectric characteristic and may be disposed between the first group and the second group.

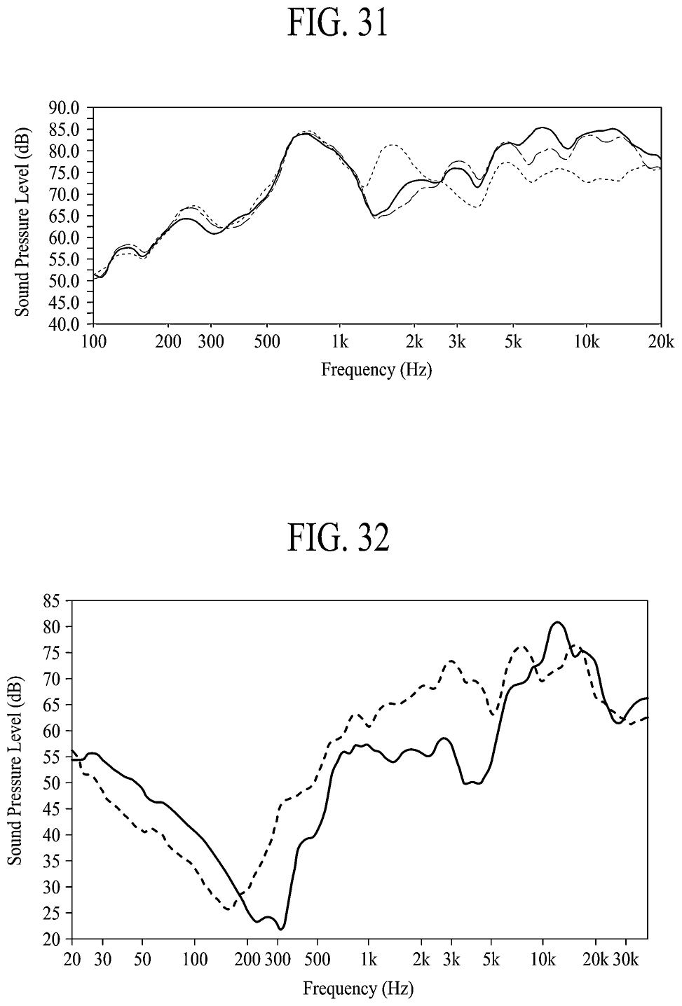

FIG. 31 is a graph showing a sound pressure level characteristic of a second vibration device according to an example embodiment of the present disclosure.

A measurement method for a sound output characteristic may be the same as details described above with reference to FIG. 21 except that the frequency measurement range is changed from 100 Hz to 20 kHz, and thus, its repeated description may be omitted for brevity. In FIG. 31, the horizontal axis represents a frequency (Hz), and the vertical axis represents a sound pressure level SPL (dB). FIG. 31 shows a sound pressure level characteristic of a second vibration device based on a plate 501, a thick solid line represents an example embodiment where a plate is provided as non-impregnated paper, a dash-single dotted line represents an example embodiment where a plate is provided as impregnated paper, and a dotted line represents an example embodiment where a plate is provided as aluminium (Al).

Referring to FIG. 31, it may be seen that non-impregnated paper (the thick solid line) and impregnated paper (the dash-single dotted line) are enhanced compared to an Al vibration plate (the dotted line) in a sound characteristic of a high pitched sound band of 2 kHz or more, and it may be seen that the non-impregnated paper (the thick solid line) and the impregnated paper (the dash-single dotted line) show similar sound characteristics.

FIG. 32 is an example of a graph showing a sound pressure level characteristic of the apparatus of FIG. 2A and the vibration device of FIG. 27B.

A measurement method for a sound output characteristic may be the same as details described above with reference to FIG. 21, and thus, may be omitted for brevity. In FIG. 32, the horizontal axis represents a frequency (Hz), and the vertical axis represents a sound pressure level (SPL) (dB). In the sound pressure level measurement of FIG. 32, the apparatus of FIG. 2A and the apparatus of FIG. 27B have been provided, a sound pressure level characteristic of the apparatus of FIG. 2A is represented by a dotted line in FIG. 32, and a sound pressure level characteristic of the apparatus of FIG. 27B is represented by a solid line in FIG. 32.

Referring to FIG. 32, when the second vibration device 500 is disposed the same as the apparatus 10 of FIG. 27B (for example, when the second vibration device 500 is disposed in the fifth region 5 of the rear cover 300), a sound pressure level may be reduced due to a deviation of a bending amount of the rear cover 300. For example, the second vibration device 500 of the apparatus 10 of FIG. 2A may be disposed near an intersection of a long-axis and short-axis outer corner such as the first region 1 or the thirteenth region 13. For example, the second vibration device 500 of the apparatus 10 of FIG. 27B may be disposed in a short-axis edge region of the rear cover 300, and for example, may be disposed in the fifth region 5. When the first vibration device 400 and/or the second vibration device 500 are/is vibrating, a bending amount deviation of the rear cover 300 near a short-axis outer corner may be greater than a bending amount deviation of the rear cover 300 at an intersection of a short-axis and long-axis outer corner, and thus, a difference in a sound pressure level may occur. For example, the second vibration device 500 of the apparatus 10 of FIG. 27B where a bending amount deviation of the rear cover 300 is large may be large in deviation of a sound pressure level. For example, the second vibration device 500 of the apparatus 10 of FIG. 2A where a bending amount deviation of the rear cover 300 is small may be small in deviation of a sound pressure level. Accordingly, the second vibration device 500 may be disposed at a position at which a bending amount deviation of a supporting member (for example, a rear cover) is small, and thus, an apparatus having an enhanced sound characteristic and/or sound pressure level characteristic may be provided. For example, a bending amount deviation may occur due to the rear cover 300, and thus, the second vibration device 500 may be disposed at a position at which a deviation of a bending amount caused by the rear cover 300 is small, thereby enhancing a production yield rate of an apparatus. As a hole size of a supporting member (for example, a rear cover) increases or a size of a vibration plate (for example, a size of a display panel) increases, the second vibration device 500 may be enhanced in sound pressure level of a total pitched sound band including a high pitched sound band in a structure of the apparatus 10 of FIG. 27B.

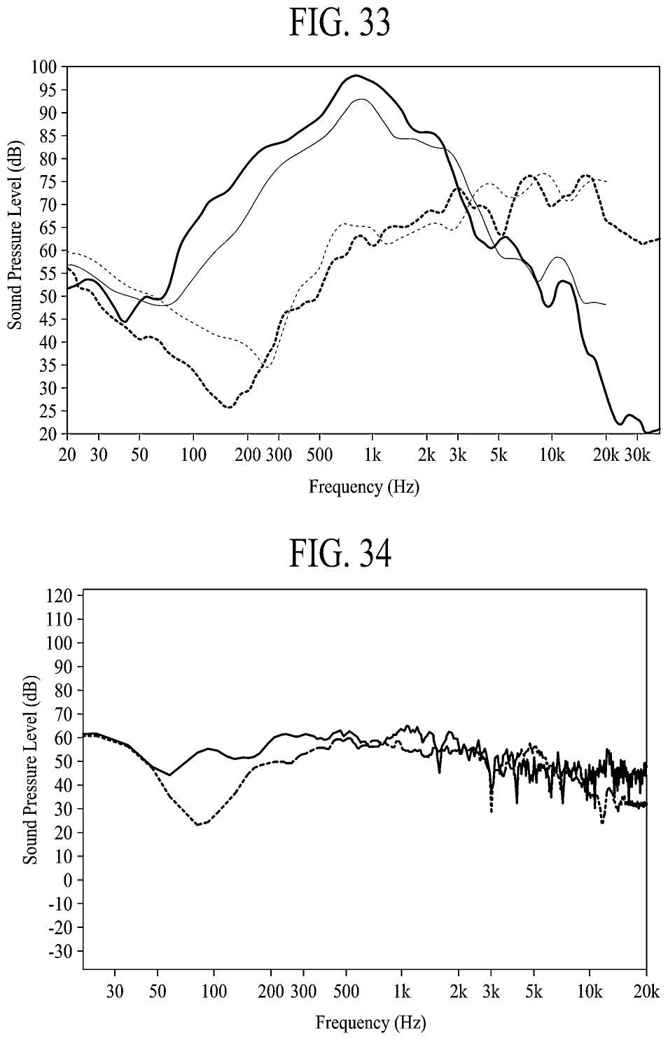

FIG. 33 is an example of a graph showing a sound pressure level characteristic of the apparatus of FIG. 2A and the vibration device of 27B.

A measurement method for a sound output characteristic may be the same as details described above with reference to FIG. 21, and thus, may be omitted for brevity. In FIG. 33, the horizontal axis represents a frequency (Hz), and the vertical axis represents a sound pressure level (SPL) (dB). In FIG. 33, a sound pressure level characteristic of the first vibration device of FIG. 2A is represented by a thin solid line, a sound pressure level characteristic of the second vibration device of FIG. 2A is represented by a dotted line, a sound pressure level characteristic of the first vibration device of FIG. 27B is represented by a thick solid line, and a sound pressure level characteristic of the second vibration device of FIG. 27B is represented by a thick dotted line. In addition, in the second vibration device of FIG. 2A, a piezoelectric device including a dummy group DG has been provided as illustrated in FIG. 30B.

Referring to FIG. 33, in the first vibration device (a thick solid line) of FIG. 2B, it may be seen that a sound pressure level characteristic of a (middle) pitched sound band of 2 kHz is enhanced compared to the first vibration device (a thin solid line) of FIG. 27B. In addition, in the second vibration device of FIG. 2B, it may be seen that the number of piezoelectric layers decreases by about 40% compared to the second vibration device (a dotted line) of FIG. 27B and an area decreases by about 50%, but a sound characteristic and/or a sound pressure level characteristic are/is similar due to the arrangement of the second vibration device 500.

FIG. 34 is an example of a graph showing a sound pressure level characteristic of a vibration device of an experimental example and the apparatus of FIG. 2B.

The volume of the PC was set to 100%, and only one of the two channels of the apparatus was driven. The playback was performed as a driving source Pink Noise Max of the media player, and the frequency of 20 Hz to 20 kHz was measured 200 times by the Fast Fourier Transform (FFT) analysis. A measurement method for a sound output characteristic may be the same as details described above with reference to FIG. 21 except that as described above, and thus, may be omitted for brevity. In FIG. 34, the horizontal axis represents a frequency (Hz), and the vertical axis represents a sound pressure level (SPL) (dB). The vibration device of the experimental example has been provided as an apparatus where two first vibration generating apparatuses with 5 W output power are installed at a lower end (or a lower portion) of the apparatus. In FIG. 34, a sound characteristic of the apparatus of FIG. 2A is represented by a solid line, and a sound characteristic of a general panel vibration device is represented by a dotted line.

Referring to FIG. 34, it may be seen that an apparatus provided based on FIG. 2B has a sound pressure level characteristic which is enhanced in a high sound of 7 kHz or more compared to the vibration device of the experimental example, and it may be seen that an apparatus provided based on FIG. 2B has a sound pressure level value which is totally enhanced in middle-low pitched sound of 2 kHz or less. For example, in a pitched sound band of 50 Hz to 300 Hz, it may be seen that the apparatus provided based on FIG. 2B has a sound pressure level characteristic which is enhanced compared to the vibration device of the experimental example.

An apparatus according to one or more example embodiments of the present disclosure is described below.

An apparatus according to an example embodiment of the present disclosure may include a vibration member, a rear cover at a rear surface of the vibration member, a first vibration device at a first rear region of the rear cover, and a second vibration device at a second rear region of the rear cover.

According to some example embodiments of the present disclosure, the first vibration device may overlap at least one of a horizontal region and a middle region of the rear cover.

According to some example embodiments of the present disclosure, the second vibration device may overlap a periphery region or a middle region of the rear cover.

According to some example embodiments of the present disclosure, the vibration member may include a display member configured to display an image, and the rear cover may include a rear cover part at a rear surface of the display member.

According to some example embodiments of the present disclosure, the rear cover part may be configured to support the first vibration device and the second vibration device.

According to some example embodiments of the present disclosure, the rear cover part may include a first hole overlapping the first vibration device.

According to some example embodiments of the present disclosure, the rear cover part may include a second hole overlapping the second vibration device.

According to some example embodiments of the present disclosure, the second vibration device may include a plate at a rear surface of the rear cover.

According to some example embodiments of the present disclosure, the plate may include one or more of aluminum, non-impregnated paper, and impregnated paper.

According to some example embodiments of the present disclosure, the second vibration device may include a piezoelectric device, and the piezoelectric device may include a vibration portion, a first electrode portion at a first surface of the vibration portion, and a second electrode portion at a second surface opposite to the first surface of the vibration portion.

According to some example embodiments of the present disclosure, the vibration portion may include a piezoelectric material.

According to some example embodiments of the present disclosure, the vibration portion may include a plurality of inorganic material portions having a piezoelectric characteristic, and an organic material portion between the plurality of inorganic material portions.

According to some example embodiments of the present disclosure, the second vibration device may include a plate at a rear surface of the vibration portion.

According to some example embodiments of the present disclosure, the second vibration device may include a piezoelectric device, the piezoelectric device including first to third groups, each of the first and second groups including a vibration portion including at least one layer, a first electrode portion at a first surface of the vibration portion, and a second electrode portion at a second surface opposite to the first surface of the vibration portion.

According to some example embodiments of the present disclosure, the third group may include a vibration portion including at least one layer, and the third group is between the first group and the second group.

According to some example embodiments of the present disclosure, the second vibration device may include two or more vibration generators, the two or more vibration generators being configured to vibrate in the same direction.

According to some example embodiments of the present disclosure, the vibration member may include a display member configured to display an image, the display member may include a display panel configured to display an image, a guide member supported by the rear cover and configured to support a periphery portion of a rear surface of the display panel, and a backlight part supported by the rear cover and disposed at the rear surface of the display panel.

According to some example embodiments of the present disclosure, the backlight part may include a reflective sheet at the rear cover, a light guide plate on the reflective sheet, and an optical sheet part on the light guide plate.

According to some example embodiments of the present disclosure, the rear cover may include a first hole at the first rear region, and a second hole at the second rear region, and the reflective sheet may be configured to cover or directly cover the first hole and the second hole.

An apparatus according to an example embodiment of the present disclosure may include a vibration member, a rear cover at a rear surface of the vibration member, a first vibration device at a first rear region of the rear cover, the first vibration device overlapping at least one of a horizontal region and a middle region of the rear cover, and a second vibration device at a second rear region of the rear cover, the second vibration device overlapping a periphery region or the middle region of the rear cover.

According to some example embodiments of the present disclosure, the first vibration device and the second vibration device may be arranged to be adjacent to each other horizontally or diagonally.

According to some example embodiments of the present disclosure, the vibration member may include a display member configured to display an image, the rear cover may include a rear cover part disposed on a rear surface of the display member.

According to some example embodiments of the present disclosure, the rear cover part may be configured to support the first vibration device and the second vibration device.

According to some example embodiments of the present disclosure, the rear cover part may include a first hole overlapping the first vibration device.

According to some example embodiments of the present disclosure, the rear cover part may include a second hole overlapping the second vibration device.

According to some example embodiments of the present disclosure, the second vibration device may include a plate disposed at a rear surface of the rear cover.

According to some example embodiments of the present disclosure, the plate may include one or more of aluminum, non-impregnated paper, and impregnated paper.

According to some example embodiments of the present disclosure, the second vibration device may include a piezoelectric device, and the piezoelectric device may include a vibration portion, a first electrode portion at a first surface of the vibration portion, and a second electrode portion at a second surface opposite to the first surface of the vibration portion.

According to some example embodiments of the present disclosure, the vibration portion may include a piezoelectric material.

According to some example embodiments of the present disclosure, the vibration portion may include a plurality of inorganic material portions having a piezoelectric characteristic, and an organic material portion between the plurality of inorganic material portions.

According to some example embodiments of the present disclosure, the second vibration device may include a piezoelectric device, and a plate at a rear surface of the piezoelectric device.

According to some example embodiments of the present disclosure, the second vibration device may include a piezoelectric device, the piezoelectric device including first to third groups, and each of the first and second groups may include a vibration portion including at least one layer, a first electrode portion at a first surface of the vibration portion, and a second electrode portion at a second surface opposite to the first surface of the vibration portion.

According to some example embodiments of the present disclosure, the third group may include a vibration portion including at least one layer, and the third group is between the first group and the second group.

According to some example embodiments of the present disclosure, the second vibration device may include two or more vibration generators, the two or more vibration generators being configured to vibrate in the same direction.

According to some example embodiments of the present disclosure, the vibration member may include a display member configured to display an image, the display member may include a display panel configured to display an image, a guide member supported by the rear cover and configured to support a periphery portion of a rear surface of the display panel, and a backlight part supported by the rear cover and disposed at the rear surface of the display panel.

According to some example embodiments of the present disclosure, the backlight part may include a reflective sheet at the rear cover, a light guide plate on the reflective sheet, and an optical sheet part on the light guide plate.

According to some example embodiments of the present disclosure, the rear cover may include a first hole at the first rear region, and a second hole at the second rear region, and the reflective sheet may be configured to cover or directly cover the first hole and the second hole.

According to some example embodiments of the present disclosure, the rear cover may include first to sixteenth regions.

An apparatus according to an example embodiment of the present disclosure may include a vibration member, and a rear cover at a rear surface of the vibration member, the rear cover comprising a left region and a right region, the left region comprises first to sixteenth regions from a left uppermost end to a right lowermost end divided in a matrix sequence, the right region includes first to sixteenth regions from a right uppermost end to a left lowermost end divided in a matrix sequence, and the apparatus may further comprise a first vibration device disposed at one or more regions in the first to sixteenth regions close to the center of the rear cover and a second vibration device disposed at one or more regions in the first to sixteenth regions close to outside of the rear cover.

According to some example embodiments of the present disclosure, the first vibration device may be disposed in at least one of the sixth to eighth regions, and the tenth to twelfth regions.

According to some example embodiments of the present disclosure, the first vibration device may be disposed in at least one of the sixth region, the seventh region, the tenth region, and the eleventh region.

According to some example embodiments of the present disclosure, the second vibration device may be disposed in at least one of the first region, the second region, the fifth region, the sixth region, the ninth region, the tenth region, the thirteenth region, and the fourteenth region.

According to some example embodiments of the present disclosure, the second vibration device may be disposed in at least one of the first region, the fifth region, the ninth region, and the thirteenth region.

According to some example embodiments of the present disclosure, a rear surface of the rear cover may include a left region and a right region including the first to sixteenth regions, the first rear region may include one or more of the first to sixteenth regions in the left region and the right region, and the second rear region may include one or more of the first to sixteenth regions in the left region and the right region.

According to some example embodiments of the present disclosure, the left region may include the first to sixteenth regions from a left uppermost end to a right lowermost end of the rear surface of the rear cover, and the right region may include the first to sixteenth regions from a right uppermost end to a left lowermost end of the rear surface of the rear cover.

A vibration device according to an example embodiment of the present disclosure may be applied to a device disposed at an apparatus. The apparatus according to an example embodiment of the present disclosure may be applied to mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theater apparatuses, theater display apparatuses, TVs, wall paper display apparatuses, signage apparatuses, game machines, notebook computers, monitors, cameras, camcorders, and home appliances, or the like. In addition, the vibration device according to some example embodiments of the present disclosure may be applied to organic light-emitting lighting apparatuses or inorganic light-emitting lighting apparatuses. When the vibration device of an example embodiment of the present disclosure is applied to lighting apparatuses, the vibration device may act as lighting and a speaker. Furthermore, when the vibration device according to some example embodiments of the present disclosure is applied to a mobile device, or the like, the vibration device may be one or more of a speaker, a receiver, and a haptic device, but embodiments of the present disclosure are not limited thereto.

It will be apparent to those skilled in the art that various modifications and variations can be made in the present disclosure without departing from the scope of the disclosures. Thus, it is intended that the present disclosure covers the modifications and variations of this disclosure provided they come within the scope of the appended claims and their equivalents.

What is claimed is:

1. An apparatus, comprising:
a vibration member;
a rear cover at a rear surface of the vibration member;
a first vibration device at a first rear region of the rear cover; and
a second vibration device at a second rear region of the rear cover.

2. The apparatus of claim 1, wherein the first vibration device overlaps at least one of a horizontal region and a middle region of the rear cover.

3. The apparatus of claim 1, wherein the second vibration device overlaps a periphery region or a middle region of the rear cover.

4. The apparatus of claim 1, wherein the vibration member comprises a display member configured to display an image, and
wherein the rear cover comprises a rear cover part at a rear surface of the display member.

5. The apparatus of claim 4, wherein the rear cover part is configured to support the first vibration device and the second vibration device.

6. The apparatus of claim 4, wherein the rear cover part comprises a first hole overlapping the first vibration device.

7. The apparatus of claim 4, wherein the rear cover part comprises a second hole overlapping the second vibration device.

8. The apparatus of claim 1, wherein the second vibration device comprises a plate at a rear surface of the rear cover.

9. The apparatus of claim 8, wherein the plate comprises one or more of aluminum, non-impregnated paper, and impregnated paper.

10. The apparatus of claim 1, wherein the second vibration device comprises a piezoelectric device, and
the piezoelectric device comprises:
a vibration portion;
a first electrode portion at a first surface of the vibration portion; and
a second electrode portion at a second surface opposite to the first surface of the vibration portion.

11. The apparatus of claim 10, wherein the vibration portion comprises a piezoelectric material.

12. The apparatus of claim 10, wherein the vibration portion comprises:
a plurality of inorganic material portions having a piezoelectric characteristic; and
an organic material portion between the plurality of inorganic material portions.

13. The apparatus of claim 10, wherein the second vibration device comprises a plate at a rear surface of the vibration portion.

14. The apparatus of claim 1, wherein the second vibration device comprises a piezoelectric device, the piezoelectric device comprising a first group, a second group, and a third group, and
wherein each of the first and second groups comprises:
a vibration portion including at least one layer;
a first electrode portion at a first surface of the vibration portion; and
a second electrode portion at a second surface opposite to the first surface of the vibration portion.

15. The apparatus of claim 14, wherein the third group comprises a vibration portion including at least one layer, and
wherein the third group is between the first group and the second group.

16. The apparatus of claim 1, wherein the second vibration device comprises two or more vibration generators, the two or more vibration generators being configured to vibrate in the same direction.

17. The apparatus of claim 1, wherein the vibration member comprises a display member configured to display an image, and
wherein the display member comprises:
a display panel configured to display an image;
a guide member supported by the rear cover and configured to support a periphery portion of a rear surface of the display panel; and
a backlight part supported by the rear cover and disposed at the rear surface of the display panel.

18. The apparatus of claim 17, wherein the backlight part comprises:
a reflective sheet at the rear cover;
a light guide plate on the reflective sheet; and
an optical sheet part on the light guide plate.

19. The apparatus of claim 18, wherein the rear cover comprises a first hole at the first rear region, and a second hole at the second rear region, and
wherein the reflective sheet is configured to cover or directly cover the first hole and the second hole.

20. An apparatus, comprising:
a vibration member;
a rear cover at a rear surface of the vibration member;
a first vibration device at a first rear region of the rear cover, the first vibration device overlapping at least one of a horizontal region and a middle region of the rear cover; and
a second vibration device at a second rear region of the rear cover, the second vibration device overlapping a periphery region or the middle region of the rear cover.

21. The apparatus of claim 20, wherein the first vibration device and the second vibration device are arranged to be adjacent to each other horizontally or diagonally.

22. The apparatus of claim 20, wherein the vibration member comprises a display member configured to display an image, and
wherein the rear cover comprises a rear cover part at a rear surface of the display member.

23. The apparatus of claim 22, wherein the rear cover part is configured to support the first vibration device and the second vibration device.

24. The apparatus of claim 22, wherein the rear cover part comprises a first hole overlapping the first vibration device.

25. The apparatus of claim 22, wherein the rear cover part comprises a second hole overlapping the second vibration device.

26. The apparatus of claim 25, wherein the second vibration device comprises:
a plate disposed at a rear surface of the rear cover.

27. The apparatus of claim 26, wherein the plate comprises one or more of aluminum, non-impregnated paper, and impregnated paper.

28. The apparatus of claim 20, wherein the second vibration device comprises a piezoelectric device, and
wherein the piezoelectric device comprises:
a vibration portion;
a first electrode portion at a first surface of the vibration portion; and
a second electrode portion at a second surface opposite to the first surface of the vibration portion.

29. The apparatus of claim 28, wherein the vibration portion comprises a piezoelectric material.

30. The apparatus of claim 28, wherein the vibration portion comprises:
a plurality of inorganic material portions having a piezoelectric characteristic; and
an organic material portion between the plurality of inorganic material portions.

31. The apparatus of claim 20, wherein the second vibration device comprises:
a piezoelectric device; and
a plate at a rear surface of the piezoelectric device.

32. The apparatus of claim 20, wherein the second vibration device comprises a piezoelectric device, the piezoelectric device comprising a first group and a second group, and
wherein each of the first and second groups comprises:
a vibration portion including at least one layer;
a first electrode portion at a first surface of the vibration portion; and
a second electrode portion at a second surface opposite to the first surface of the vibration portion.

33. The apparatus of claim 32,
wherein the piezoelectric device further comprises a third group,
wherein the third group comprises a vibration portion including at least one layer, and
wherein the third group is between the first group and the second group.

34. The apparatus of claim 20, wherein the second vibration device comprises two or more vibration generators, the two or more vibration generators being configured to vibrate in the same direction.

35. The apparatus of claim 20, wherein the vibration member comprises a display member configured to display an image, and
wherein the display member comprises:
a display panel configured to display an image;
a guide member supported by the rear cover and configured to support a periphery portion of a rear surface of the display panel; and
a backlight part supported by the rear cover and disposed at the rear surface of the display panel.

36. The apparatus of claim 35, wherein the backlight part comprises:
a reflective sheet at the rear cover;
a light guide plate on the reflective sheet; and
an optical sheet part on the light guide plate.

37. The apparatus of claim 36,
wherein the rear cover comprises a first hole at the first rear region, and a second hole at the second rear region, and
wherein the reflective sheet is configured to cover or directly cover the first hole and the second hole.

38. The apparatus of claim 20, wherein the rear cover comprises first to sixteenth regions.

39. The apparatus of claim 38, wherein the first vibration device is disposed in at least one of the sixth to eighth regions, and the tenth to twelfth regions.

40. The apparatus of claim 38, wherein the first vibration device is disposed in at least one of the sixth region, the seventh region, the tenth region, and the eleventh region.

41. The apparatus of claim 38, wherein the second vibration device is disposed in at least one of the first region, the second region, the fifth region, the sixth region, the ninth region, the tenth region, the thirteenth region, and the fourteenth region.

42. The apparatus of claim 38, wherein the second vibration device is disposed in at least one of the first region, the fifth region, the ninth region, and the thirteenth region.

43. The apparatus of claim 38, wherein:
a rear surface of the rear cover comprises a left region and a right region including the first to sixteenth regions;
the first rear region comprises one or more of the first to sixteenth regions in the left region and the right region; and
the second rear region comprises one or more of the first to sixteenth regions in the left region and the right region.

44. The apparatus of claim 43, wherein:
the left region includes the first to sixteenth regions from a left uppermost end to a right lowermost end of the rear surface of the rear cover; and
the right region includes the first to sixteenth regions from a right uppermost end to a left lowermost end of the rear surface of the rear cover.
